(19) United States
(12) Patent Application Publication
(10) Pub. No.: US 2026/0218455 A1
(43) Pub. Date: Jul. 30, 2026

(54) WATER SOLUBLE AMPHOTERIC EMULSION TERPOLYMERS, METHODS OF MAKING, AND METHODS OF USE AS RETENTION AND DEWATERING AIDS

(71) Applicant: KEMIRA OYJ, HELSINKI (FI)

(72) Inventors: Matti HIETANIEMI, Atlanta, GA (US); Yuping LUO, Atlanta, GA (US); Jennifer RISER, Atlanta, GA (US); Ronald ROBINSON, Atlanta, GA (US); Logan JACKSON, Atlanta, GA (US); Junhua CHEN, Atlanta, GA (US)

(21) Appl. No.: 19/143,940

(22) PCT Filed: Dec. 28, 2023
(86) PCT No.: PCT/US2023/086225

§ 371 Date: Jun. 27, 2025

Related U.S. Application Data
(60) Provisional application No. 63/435,607, filed on Dec. 28, 2022.

(30) Foreign Application Priority Data
Mar. 16, 2023 (FI) 20235310

(51) Int. Cl. D21H 17/45; C08F 220/56; D21F 3/10; D21F 11/02; D21H 21/02; D21H 21/10; D21H 21/16; D21H 21/18; D21H 23/04

(52) U.S. Cl. CPC D21H 17/455; C08F 220/56; D21F 3/10; D21F 11/02; D21H 21/02; D21H 21/10; D21H 21/16; D21H 21/18; D21H 23/04; C08F 2800/10

(57) ABSTRACT

The present invention provides novel amphoteric emulsion polymers, aqueous compositions containing these amphoteric emulsion polymers, methods for making, and applications thereof for improving retention and vacuum and press dewatering in the manufacturing of paper or board. In particular, the present invention relates to the use amphoteric emulsion polymers, with and without silica, in papermaking processes and other processes which may involve the use of hard water during polymer makedown and/or the treatment of compositions comprising recycled and unbleached high-yield fibers and/or the treatment of compositions comprising colloidal materials and hydrophobic agglomerates and particles. More particularly, the present disclosure relates to the use of these novel amphoteric emulsion polymers as drainage aids, broke fixatives, retention/drainage cationic boosters for colloidal silica retention and drainage programs, and flocculants in water quantity and quality management (WQQM) applications.

### FIELD OF THE INVENTION

The present invention generally relates to novel amphoteric emulsion polymers, aqueous compositions containing these amphoteric emulsion polymers, methods for making, and applications thereof for improving retention and vacuum and press dewatering in the manufacturing of paper or board. In particular, the present invention relates to the use amphoteric emulsion polymers, with and without silica, in papermaking processes and other processes which may involve the use of hard water during polymer makedown and/or the treatment of compositions comprising recycled and unbleached high-yield fibers and/or the treatment of compositions comprising colloidal materials and hydrophobic agglomerates and particles. More particularly, the present disclosure relates to the use of these novel amphoteric emulsion polymers as drainage aids, broke fixatives, retention/drainage cationic boosters for colloidal silica retention and drainage programs, and flocculants in water quantity and quality management (WQQM) applications, and the like.

### BACKGROUND OF THE INVENTION

In the production of paper or paperboard, a dilute aqueous composition known as “furnish” or “stock” is sprayed onto a moving mesh known as a “wire” or “wire screen”. Solid components of this composition, such as cellulosic fibers, fines, and inorganic particulate mineral fillers are drained or filtered by the wire to form a paper sheet. The percentage of solid material retained on the wire is known as the “first pass retention” of the papermaking process.

Paper and board manufacturers require chemical additives that will effectively provide enhanced on-machine retention while also improving drainage and wet pressability (“vacuum and press dewatering”). These requirements are especially challenging for papermaking operations in mills with high recycled content.

Retention is a function of different mechanisms, such as filtration by mechanical entrainment, electrostatic attraction, and bridging between the fibers and the fillers in the furnish. Because both the cellulosic fibers and many common filler materials are negatively charged, they are mutually repellent. Generally, the only factor tending to enhance retention is mechanical entrainment. Therefore, a retention aid is generally used to improve retention of the fibers and fillers on the wire.

Drainage relates to the rate of removal of water (“dewatering”) from the furnish as the paper sheet is formed. Drainage usually refers to only water removal which takes place in the “drainage zone” (gravity and vacuum sections) of the paper machine subsequent to formation of the web. Wet pressability relates to efficiency of water removal during pressing of the wet paper web. Thus, drainage aids and/or vacuum and press dewatering aids are used to improve the overall efficiency of dewatering in the production of paper or paperboard.

Improvements in retention and drainage of the final paper or paperboard sheet are particularly desirable for several reasons, the most significant of which is productivity. Good retention and good drainage enable a paper machine to run faster and to increase production.

These improvements are realized by the use of retention and drainage aids. These retention and drainage aids are generally added to the furnish as the furnish approaches the headbox of the paper machine and may comprise a coagulant/flocculant system used in conjunction with one or more shearing stages.

A coagulant is typically a low molecular weight cationic synthetic polymer that reduces the negative surface charges on the fiber, fines, and/or filler particles to accomplish agglomeration of such particles. The flocculant, which generally is a high molecular weight cationic, nonionic, or anionic synthetic polymer, bridges the particles and/or agglomerates, from one surface to another, thereby binding the particles into larger flocs. The larger flocs increase retention of the particles; however, as they are filtered out of the water onto the fiber web, the pores of the flocs are covered, thereby reducing the drainage efficiency of the fiber web. The larger flocs can be broken down by shearing which is provided by one or more of the cleaning, mixing and pumping stages of the papermaking process.

Greater retention of fines and fillers permits a reduction in the content of cellulosic fiber. As pulps of inferior quality are employed to reduce papermaking costs, the retention aspect of papermaking becomes even more important. This is due to the higher level of fines found in lower quality pulps, such as recycled fiber and coated broke. Greater retention of fines, fillers, and other slurry components also reduces the amount of such substances lost to the white water. This reduces the amount of material wastes, the cost of waste disposal, and the adverse environmental effects therefrom.

There is a need in the art to provide an improved additive system which replaces the cationic coagulant/high molecular weight anionic flocculant system of the prior art resulting in a substantial improvement of the retention and drainage properties of the paper furnish. This is particularly true for paper furnishes containing recycled deinked fiber, groundwood, bleached fiber linerboard and/or coated broke and either treated or untreated fillers, higher levels of stickies, calcium ions, and conductivity.

Amphoteric terpolymers including a dry amphoteric polymer comprised of acrylamide, acrylic acid and Q9 monomers are known in the art as is the use thereof in sticky control, as drainage aids in high conductivity wet end systems, and as productivity aids, e.g., on acid kraft liner paper machines. However, a disadvantage of such dry amphoteric polymers and other dry polymers currently used in papermaking is that they typically require an expensive makedown unit for usage, e.g., when used as an anti-sticky or drainage agent. Requiring expensive makedown processes limits their usage in many applications and particularly precludes their usage in North America as recycled mills in North America customarily use “ready to pump” emulsion products. Also, dry amphoteric polymers such as those comprised of acrylamide, acrylic acid and Q9 monomers generally cannot be used in areas with hard water supplies because of their poor hard water acceptance during the makedown process.

Liquid form amphoteric polyacrylamides in solution form also find known usage in the papermaking industry. These amphoteric polyacrylamides generally have a molecular weight less than 1 million Daltons. Some liquid form amphoteric polyacrylamides are reportedly useful in the high conductivity wet end as dry strength agents. By contrast, liquid-form amphoteric polyacrylamides are reportedly not effective as sticky control agents and as retention/drainage aids.

Recycled fiber material is commonly used as raw material for paper or board. The recycled fiber material comprises in addition to the fibers a number of other substances. Particulate foreign material is separated from the pulp in the pulper or at the screening. Some substances are naturally retained on the fibers and do not disturb the process. Other substances, such as stickies, may be separated from the pulp at the screening and at least partly removed from the process.

Use of recycled fiber material as raw material is the main source of hydrophobic substances, so called stickies, in paper and board making. While some or even most of these hydrophobic substances are removed during the pulping of recycled fiber raw materials, substantial amounts are still carried over during the paper or board making process. Hydrophobic substances, which have not been removed in de-inking or other recycled fiber processing stages, e.g., which are not trapped by the screens, enter the paper or board machine and circulate in the process waters. Due to the increased environmental awareness and regulations, papermaking processes have become more and more closed and use less fresh water. This results in heavy accumulation of interfering substances, including hydrophobic substances, in the fiber suspension and process waters. These substances may agglomerate into bigger hydrophobic particles, which are capable of forming deposits.

In addition to the recycled fiber material, recycle of coated broke can also cause similar problems as described above for the recycled fiber material. Coated broke contaminant deposition in papermaking systems can cause serious operational problems if left uncontrolled. Coated broke is repulped and used as a furnish source at most coated fine paper mills. The most difficult problem involved with recycling coated broke is derived from the binder materials, sometimes in combination with pigments or fillers, since these polymers and the materials to which they have been attached, are the origin of sticky deposits. These sticky deposits cause difficulties when recycled back to the paper machine operation. Formed deposits may cause web breakages, so as a precautionary measure the most affected surfaces, such as drying cylinders, calendars, wires and felts, are being regularly washed and cleaned, which leads to downtime and loss of production.

The circulating hydrophobic substances may be controlled by adding chemicals to the papermaking process in order to build a boundary layer of hydrophilic material around hydrophobic particles to decrease their tendency to deposit, i.e. to make them less tacky. The colloidal stability of small hydrophobic particles may be enhanced by surfactants and dispersants, which prevent their agglomeration and deposition on the surfaces. Cationic high-charged polymers such as homopolymers of diallyldimethyl-ammonium chloride (DADMAC) are conventionally used as fixatives to control hydrophobic substances, such as pitch and stickles, through fixation. Nonionic polymers, such as polyvinyl alcohol, and copolymers, such as polyacrylamide-vinyl acetate, have been used for stickie control through detackification. Alum, starches and low molecular weight cationic coagulants are used conventionally for deposit control, as they can neutralize anionic trash and detrimental substances including pitch and stickles at least partly by complex formation. However, it has been observed that these complexes may become concentrated in the process and can lead to further deposition problems.

Considerable effort has been directed toward developing improved retention and drainage aids. PCT/US99/29135 discloses a polyampholyte coagulant, which is used as a retention/drainage/formation aid in a papermaking process. However, commercially available retention and drainage aids remain inadequate for manufacture of paper and board with a high percentage of recycled fiber content.

Based on the foregoing there is a need for improved polymer additives for use in the manufacturing of paper, tissue, towel, and/or board from recycled materials, which provide retention and drainage enhancement, while also controlling hydrophobic particles and agglomerates (“stickies”) in the furnish. Therefore, it is an object of the present invention to provide methods and compositions for enhancing retention and drainage (i.e., retention and drainage aids) which provide improved retention, drainage time, paper strength, and improved hydrophobic particle control. Further there is a need for improved polymer additives for use in the manufacturing of paper and/or board, which provide retention enhancement without over-flocculating fiber stock and destruction of sheet formation and which also enhance or at least maintain strength of paper or board, and/or provide for better stickie control. Further, there is a need for new polymers, which possess good hard water acceptance, do not require an expensive makedown unit or process for usage, which are cost-effective to produce and use; and which possess improved effectiveness, e.g., when used e.g., as stickie control agents and retention/drainage aids e.g., in high conductivity wet end systems, and/or as productivity aids on acid kraft liner paper machines.

### SUMMARY OF THE INVENTION

The present invention generally relates to novel amphoteric emulsion polymers, aqueous compositions containing these amphoteric emulsion polymers, methods for making, and applications thereof for improving retention and vacuum and press dewatering in the manufacturing of paper or board. In particular, the present invention relates to the use amphoteric emulsion polymers, with and without silica, in papermaking processes and other processes which may involve the use of hard water during polymer makedown and/or the treatment of compositions comprising recycled and unbleached high-yield fibers and/or the treatment of compositions comprising colloidal materials and hydrophobic agglomerates and particles. More particularly, the present disclosure relates to the use of these novel amphoteric emulsion polymers as drainage aids, broke fixatives, retention/drainage cationic boosters for colloidal silica retention and drainage programs, and flocculants in water quantity and quality management (WQQM) applications, and the like.

Preparation of paper sheets under using the inventive amphoteric emulsion terpolymer provides improved retention, drainage under vacuum, and wet pressability, and improved hydrophobic particle control. Addition of silica to the inventive amphoteric emulsion terpolymer provides synergistic improvement in the retention, drainage under vacuum, and wet pressability

In one aspect, the present invention provides a water-soluble amphoteric emulsion terpolymer, which comprises:
(a) one or more acrylamide (AM) monomers, one or more anionic monomers comprising acrylic acid (AA), and one or more cationic monomers comprising 2-(acryloyloxy)ethyl]trimethylammonium chloride (Q9);
(b) an acrylamide (AM) or (meth)acrylamide monomer content ranging from 45-99 mol-%;
(c) an acrylic acid (AA) monomer content of ≤5 mol-%, ≤3 mol-%, or preferably ≤2 mol-%;
(d) a 09 monomer content ranging from ≤12 mol-%, ≤20 mol-%, or ≤50 mol-%;
(e) a polymer standard viscosity (SV) of ≤4.5 cPs, ≤3.5 cPs, or preferably 2.5-3.5 cPs; and
(f) a molecular weight ranging from 1.5-9 million Da, 5-8 million Da, or 3 to 5 million Da.

In some exemplary embodiments of the water-soluble amphoteric emulsion terpolymer:
(a) the acrylamide (AM) or (meth)acrylamide monomer content (i) ranges from 78-92.9 mol-% inclusive, 78-92.5 mol-% inclusive, or 78-92.1 mol-% inclusive, or (ii) ranges from 78-79 mol-%; 79-80 mol-%; −80-81 mol-%; 81-82 mol-%; 82-83 mol-%; 83-84 mol-%; 84-85 mol-%; 85-86 mol-%; 86-87 mol-%; 87-88 mol-%; 88-89 mol-%; 89-90 mol-%; 90-91 mol-%; 91-92 mol-%; or 92-92.9 mol-%;
(b) the acrylic acid (AA) monomer content ranges from 0.1-5 mol-%, 0.5-3 mol-%, 1.2-3 mol-%, 0.5-2.1 mol-%, or 0.5-1.0 mol-%;
(c) the Q9 monomer content ranges from (i) 7-20 mol-%, 7-18 mol-%, 7-16 mol-%, 7-13 mol-%, 7-12 mol-%, 7-10 mol-%, 7-9 mol-%, or (ii) 7-8 mol-%, 8-9 mol-%, 9-10 mol-%, 10-11 mol-%, 11-12 mol-%, 12-13 mol-%, 13-14 mol-%, 14-15 mol-%, 15-16 mol-%, 16-17 mol-%, 17-18 mol-%, 18-19 mol-%, 19-19.5 mol-%, or 19.5-20 mol-%; or
(d) any combination of the foregoing.

In some exemplary embodiments the water-soluble amphoteric emulsion terpolymer is formulated by inverting the water-soluble amphoteric emulsion terpolymer with water and/or a hard water comprising >200 ppm of calcium and/or magnesium ions, thereby forming an inverted aqueous dispersion or an inverted hard water aqueous dispersion, optionally wherein the inverted aqueous dispersion or the inverted hard water aqueous dispersion:
(a) further comprises a buffer which provides for the pH to be controlled within the range of about 2.5-5.0, or 2.5-3.5; or 2.80-3.5, or 2.7-3.5, or 2.5-3.2; or 2.5-3.0, or 2.7-3.0;
(b) further comprises a citric acid buffer or sodium acetate-acetic acid buffer;
(c) further comprises a sodium acetate-acetic acid buffer;
(d) comprises 1-8 wt % or more typically 3-5 wt % the water-soluble emulsion amphoteric terpolymer;
(e) is stable at least 3-6 months; or
(f) any combination of (a)-(f).

In some exemplary embodiments the water-soluble amphoteric emulsion terpolymer, the aqueous dispersion, or the hard water aqueous dispersion of any of the foregoing is:
(a) added to a fluid used in papermaking, wherein an amount of terpolymer is added to obtain a desired stock consistency, e.g., a terpolymer fluid comprising 0.2% terpolymer is dosed at =0.6 g/L to 3.75 g/L; or
(b) added to a composition or machine used in papermaking.

In another aspect, the present invention provides a method of making a water-soluble emulsion amphoteric terpolymer according to any of the foregoing by conducting an inverse emulsion polymerization process using acrylamide (AM), acrylic acid (AA), and acryloyloxy ethyl trimethylammonium chloride (Q9) monomers, wherein the method provides for a water-soluble emulsion amphoteric terpolymer comprising ≤3 mol-% acrylic acid (AA) monomers or ≤2 mol-% acrylic acid (AA) monomers, up to 20 mol-% Q9 monomers, and at least 78 mol-% acrylamide (AM) monomers.

In some exemplary embodiments of the method the inverse emulsion polymerization process comprises the following steps:
(a) a “monomer phase” which comprises combining acrylamide, acrylic acid and acryloyloxy ethyl trimethylammonium chloride (Q9) monomers and a chain transfer agent while maintaining the pH of this mixture between 2.5-5.0, 2.5-4.5, 2.5-4.0, 2.5-3.5, 2.5-3.0, 2.7-3.0 or 3-3.3; optionally wherein the “monomer phase” comprises any or all of the following steps: (i) adding to a container acrylamide monomers, cationic Q9 monomers, and citric acid solution or so as to obtain a composition wherein the pH is between 2.5-5.0, 2.5-4.5, 2.5-4.0, 2.5-3.5, 2.5-3.0, 2.7-3.0 or 3-3.3; (ii) mixing the resultant monomer blend, optionally for at least ≈1 minute; (iii) adding acrylic acid monomers, and a chain transfer agent, optionally sodium hypophosphite (NaHypo) further optionally at 50-70 ppm of total monomer content or isopropyl alcohol, further optionally at a dosage of 8500-12000 ppm of total monomer content, and a chelating agent, optionally diethylene triamine pentaacetic acid (DTPA) and water, (iv) mixing the resultant mixture, optionally for at least about 1-20 minutes or at least 1-10 minutes; (v) checking the pH of the monomer phase one or more times and maintaining the pH of the monomer mixture between 2.5-5.0, 2.5-4.5, 2.5-4.0, 2.5-3.5, 2.5-3.0, 2.7-3.0 or 3-3.3, optionally by the addition of ammonium hydroxide; (vi) maintaining the temperature of the reactants of the monomer phase below 30° C.; and (vii) determining the initial pH of the monomer phase (before the addition of NH₄OH) and optionally determining the final pH (after optionally adjusting with NH₄OH) and water to obtain the monomer phase;
(b) an “oil phase” which comprises producing a composition comprising an oil, optionally a petroleum solvent, and at least one emulsifying agent or surfactant; optionally wherein the “oil phase” comprises any or all of the following steps: (i) adding an oil or hydrophobic solvent, optionally a composition comprising an oil, optionally a petroleum solvent, 19-21% range; (ii) stirring the composition; (iii) adding a at least one emulsifying agent or surfactant, optionally an ethoxylated alcohol (C12-C16): 2-3% and sorbitan monooleate (SMO); and (iv) permitting the resultant mixture to mix, optionally for 10 minutes or more;
(c) a “combining phase” which comprises combining the monomer phase and the oil phase; optionally wherein the “combining phase” comprises any or all of the following steps: (i) adding the monomer phase to the oil phase; (ii) permitting the mixture to mix optionally for at least ~20 minutes; (iii) detecting the viscosity of the mixture during and/or after mixing; (iv) homogenizing the resultant mixture; (v) determining the viscosity after homogenizing; (vi) adding the resultant mixture to a polymerization reactor; and (vii) recording the initial temperature;
(d) a “sparging phase” which comprises sparging the combined phase with a gas, preferably nitrogen while mixing; optionally wherein the “sparging phase” comprises any or all of the following steps: (i) sparging the contents of the reactor with nitrogen, optionally for at least ~1 hour; and (ii) continuously stirring the mixture;
(e) a “polymerization phase” which comprises effecting polymerization by the addition of a polymerization initiator, and SO₂ gas while nitrogen is continuously sparged throughout the entire process; optionally wherein the “polymerization phase” comprises any or all of the following steps: (i) adding a polymerization initiator, optionally tert-butyl hydroperoxide, to the mixture optionally after 1 hour of sparging and allowing the admixture to mix for an adequate time; (ii) introducing SO₂ gas, optionally 0.4% at 18 Standard cubic centimeters per minute (SCCM); (iii) monitoring the temperature throughout the reaction; (iv) controlling the flow rate of SO₂ such that the raise in temperature is gradual, optionally ≈1.5° C./minute, more preferably ~1° C./minute; (v) maintaining the temperature below 50° C. throughout the reaction, optionally by using a water bath and/or by cutting the SO₂ gas flow; (vi) determining that polymerization is completed, e.g., when no raise in temperature is seen when SO₂ is continuously being fed; (vii) adjusting the SO₂ flow rate back after polymerization is completed to the initial value and adjusting the reactor temperature to 50° C.; (viii) maintaining the conditions of (vii) for a prolonged period, optionally for ~1.5 hours; and (ix) continuously sparging nitrogen throughout the entire polymerization process; and
(f) a “post-polymerization phase” wherein the polymer mixture is optionally treated to eliminate residual monomers and an inverting surfactant is added to the product of the polymerization phase; optionally wherein the “post-polymerization phase” comprises any or all of the following steps: (i) optionally treating the polymerizate in order to eliminate any residual acrylamide monomers; (ii) stopping the flow of the SO₂ and nitrogen gases; (iii) adding an inverting surfactant to the subsurface, optionally a seven-mole ethoxylate of linear, primary 12-14 carbon number alcohol; (iv) permitting the reactor to cool to <30° C., and (v) transferring the resultant emulsion polymer to an appropriate container.

In another aspect, the present invention provides a water-soluble amphoteric emulsion terpolymer according to any of the foregoing, produced by a method according to any of the foregoing.

In another aspect, the present invention provides an aqueous composition, optionally a hard water aqueous composition, comprising
(a) a water-soluble amphoteric emulsion terpolymer according to any of the foregoing, produced by a method according to any of the foregoing; and
(b) water or hard water; which optionally comprises a pH of 2.5-3.5 or 2.8-3.5 or 2.8-3.2, and/or comprises an acidic buffer, further optionally a citric acid buffer or a sodium acetate-acetic acid buffer.

In another aspect, the present invention provides a method of papermaking, which method comprises adding a water-soluble emulsion terpolymer or aqueous composition comprising the water-soluble amphoteric emulsion terpolymer according to any of the foregoing during any phase of a manufacturing process for paper or board, wherein the water-soluble emulsion terpolymer or aqueous composition functions as:
(a) a dry strength agent for paper or board;
(b) an anti-stickie agent;
(c) a fixation and retention/drainage boosting aid, wherein said water-soluble emulsion terpolymer or aqueous composition functions as a fixative for improving retention and/or fixation of dyes, hydrophobics, starch and/or fillers, and/or drainage in manufacture of paper and/or board, optionally wherein said aid does not damage sheet formations even at elevated polymer dosage levels; or
(d) any combination of the foregoing.

In some exemplary embodiments the method further comprises:
(a) adding the water-soluble emulsion terpolymer or aqueous composition to a fiber stock, wherein the fiber stock is used for manufacture of paper or board;
(b) draining the aqueous fiber stock on a wire to form a wet fibrous web; and
(c) further dewatering the wet fibrous web by using vacuum dewatering, wet pressing, and/or drying;
optionally wherein:
(i) the method uses hard water, and/or uses recycled fibers; and/or
(ii) the fiber stock comprises (1) a thin stock comprising recycled fibers; or (2) preferably a thick stock comprising recycled fibers; and/or
(iii) the water-soluble emulsion polymer or composition comprising is prepared on-site; and/or
(iv) the water-soluble emulsion terpolymer is added in an amount ranging from (1) 100-2000 g/ton of produced paper or board, or 300-1500 g/ton of produced paper or board, or 400-900 g/ton of produced paper or board; or (2) 500-5000 g/ton produced paper or board, preferably in the range of 1000-3000 g/ton produced paper or board, more preferably in the range of 1500-2500 g/ton produced paper or board.

In another aspect, the present invention provides a method of using a water-soluble amphoteric emulsion terpolymer or aqueous composition comprising the water-soluble amphoteric emulsion terpolymer according to any of the foregoing, wherein the water-soluble amphoteric emulsion terpolymer or aqueous composition functions:
(a) as an internal sizing booster and press aid in papermaking for paper or board;
(b) as a press aid in a papermaking process;
(c) for colloidal particle control, optionally in a papermaking process;
(d) as a drainage aid; optionally in a papermaking process;
(e) for eliminating or controlling deposit formation caused e.g., by hydrophobic substances in manufacture of paper or board;
(f) for improving drainage in manufacture of paper and/or board;
(g) as a pump and go composition for paper or board manufacturing, wherein the pump and go composition is added to a fiber stock, a thick stock, or a coated broke without use of conventional polymer aging tanks;
(h) for improving sizing efficiency in paper or board manufacturing; or
(i) as a flocculant, optionally in water purification or water quality management.

In another aspect, the present invention provides a method for manufacture of paper or board, wherein a fiber web is formed from an aqueous suspension of fibers, the method comprising:
(a) providing an aqueous fiber suspension, which comprises recycled fiber material and/or coated broke;
(b) optionally diluting the aqueous fiber suspension;
(c) delivering the aqueous fiber suspension to a headbox, draining the aqueous fiber suspension on a wire screen to form a wet fibrous web; and
(d) pressing and drying the wet fibrous web to obtain a web of paper or board,
wherein the method further comprises adding a water-soluble amphoteric emulsion terpolymer or an aqueous composition comprising the water-soluble amphoteric emulsion terpolymer according to any of the foregoing; and
wherein optionally:
(i) the aqueous fiber suspension comprises at least 50 weight-%, preferably at least 60 weight-%, more preferably at least 70 weight-%, or even more preferably at least 80 weight-% or 100 weight-%, of recycled fiber material and/or coated broke, based on dry paper or board;
(ii) the water-soluble amphoteric emulsion terpolymer or aqueous composition is added to the aqueous fiber suspension, wherein the aqueous fiber suspension comprises a consistency of (1) above 30 g/L, (2) above 20 g/L, or (3) below 20 g/L;
(iii) the water-soluble amphoteric emulsion terpolymer or aqueous composition is added to the aqueous fiber suspension before washing and/or cleaning and/or thickening of the aqueous fiber suspension;
(iv) the water-soluble emulsion polymer or aqueous composition is added to the aqueous fiber suspension in a dosage of 0.9-2.72 kg (as is)/ton or 1.36-2.72 kg (as is)/ton of produced paper or board; or
(v) any combination of (i) to (iv).

In another aspect, the present invention provides a method for improving vacuum and press dewatering in manufacturing of paper or board, which method comprises:
(a) providing an aqueous fiber suspension, which optionally comprises recycled fiber material;
(b) delivering the aqueous fiber suspension to a last shear stage and further to a headbox;
(c) draining the aqueous fiber suspension on a wire to form a wet fibrous web; and
(d) further dewatering the wet fibrous web by using vacuum and wet pressing and drying,
characterised in that an amphoteric polymer or a cationic crosslinked polymer is added to the fiber suspension having consistency of <20 g/L before the last shear stage prior to delivering the fiber suspension to a headbox of a paper or board machine,
wherein the amphoteric polymer or cationic crosslinked polymer are obtained by polymerizing at least acrylamide and over 11 mol-% of cationic monomers, and
wherein the amphoteric polymer or cationic crosslinked polymer comprise a standard viscosity of 1.5-4.5 mPas.

In some exemplary embodiments of the method:
(a) the amphoteric polymer comprises: (i) a ratio of anionically charged groups to cationically charged groups ranging from 1:20 to 1:5 (anionic:cationic); (ii) an anionic monomer content ranging from 0.5-5 mol-%, preferably 1-4 mol-%, more preferably 1.2-3 mol-%; and/or (iii) a cationic monomer content ranging from 11-38 mol % or 13-30 mol %; and/or (iv) a net cationic charge ranging from 1.1-3.5 meq/g, preferably 1.5-3 meq/g at pH 7; and/or
(b) the cationic crosslinked polymer: (i) is polymerized in a presence of 0.5-100 ppm, preferably 1.5-30 ppm, more preferably 2-20 ppm, of crosslinking agent; (ii) comprises a cationic monomer content ranging from over 20 mol-%, over 25 mol-%, 20-50 mol-%, or preferably 25-38 mol %; (iii) comprises a net cationic charge ranging from 2.5-5 meq/g, or preferably 3.1-4.5 meq/g, at pH 2.7; (iv) comprises a standard viscosity preferably in a range of 1.7-4.0 mPas, more preferably 2.5-3.5 mPas;
wherein the cationic monomer is selected from the group consisting of 2-(dimethylamino)ethyl acrylate (ADAM), [2-(acryloyloxy)ethyl]trimethylammonium chloride (ADAM-CI), 2-(dimethylamino)ethylacrylate benzylchloride, 2-(dimethylamino)ethyl acrylate dimethylsulphate, 2-dimethylaminoethyl methacrylate (MADAM), [2-(methacryloyloxy)ethyl]trimethylammonium chloride (MADAM-CI), 2-dimethylaminoethyl methacrylate dimethylsulphate, [3-(acryloylamino) propyl]trimethylammonium chloride (APTAC), [3-(methacryloylamino) propyl]trimethylammonium chloride (MAPTAC), diallyldimethylammonium chloride (DADMAC) and any mixture thereof; preferably cationic monomer being [2-(acryloyloxy)ethyl]trimethylammonium chloride (ADAM-CI),
and wherein the anionic monomer is selected from the group consisting of acrylic acid, methacrylic acid, and alkali metal, alkaline earth metal, or ammonium salts thereof.

In some exemplary embodiments of the method:
(a) the cationic crosslinked polymer or the amphoteric polymer is added to the fibre suspension: (i) in an amount of 50-1000 g/t, preferably 150-800 g/t; and/or (ii) in an amount providing a reduction in a cationic demand of the fibre suspension of 10-300 meq/g, measured with Mutek PCD, calculated from the cationic demand of the fibre suspension before and after the addition of the cationic crosslinked polymer or the amphoteric polymer and/or
(b) the method further comprises an addition of inorganic microparticles after the last shear stage prior to delivering the fibre suspension to the headbox of a paper or board machine.
(c) the method further comprises an addition of cationic polyacrylamide; or
(d) any combination of the foregoing.

In another aspect, the present invention provides a use of a method according to any one of the foregoing in manufacturing of (a) solid board, kraft paper, liner board, test liner, fluting, sack paper, white lined chipboard, core board, folding boxboard or gypsum board liner; or (b) solid board, kraft paper, liner board, test liner, fluting, sack paper, white lined chipboard, core board, folding boxboard or gypsum board liner having a grammage of at least 70 g/m², preferably at least 100 g/m² or at least 150 g/m².

In another aspect, the present invention provides a method for manufacture of paper or board, wherein a fiber web is formed from an aqueous suspension of fibers, the method comprising:
(a) providing an aqueous fiber suspension, which comprises recycled fiber material and/or coated broke;
(b) optionally diluting the aqueous fiber suspension;
(c) delivering the aqueous fiber suspension to a headbox, draining the aqueous fiber suspension on a wire screen to form a wet fibrous web; and
(d) further dewatering the wet fibrous web by vacuum dewatering, wet pressing, and/or drying the wet fibrous web to obtain a paper or board;
wherein the method further comprises adding to the aqueous fiber suspension a retention and drainage aid comprising (i) a water-soluble amphoteric emulsion terpolymer, and (ii) one or more inorganic colloids; and wherein (i) and (ii) are premixed prior to addition or added simultaneously or sequentially in any order.

In some exemplary embodiments of the method:
(a) the aqueous fiber suspension comprises: (i) at least 50 weight-%, preferably at least 60 weight-%, more preferably at least 70 weight-%, or even more preferably at least 80 weight-% or 100 weight-%, of recycled fiber material and/or coated broke, based on dry paper or board; (ii) water and/or hard water comprising calcium ions; (iii) a thick stock comprising recycled fibers or a thin stock comprising recycled fibers; (iv) a consistency of above 30 g/L or below 20 g/L; (v) a pH in the range of 6-10, 6-9, 6-8.5, or 6-7; or (vi) any combination of (I)-(v);
(b) the water-soluble amphoteric emulsion terpolymer: (i) comprises one or more acrylamide (AM) monomers, one or more anionic monomers comprising acrylic acid (AA), and one or more cationic monomers comprising 2-(acryloyloxy)ethyl]trimethylammonium chloride (Q9); (ii) comprises an acrylamide (AM) or monomer content ranging from 85.9-99 mol-%, 86-96 mol-%, or 86-92 mol-%; (iii) comprises an acrylic acid (AA) monomer content of ≤2.1 mol-%, 0.1-2.1 mol-%, or 0.5-2.1 mol-%; (iv) comprises a Q9 monomer content ranging from ≤12 mol-%, 7-12 mol-%, 8-12 mol-%, or 10-12 mol-%; (v) comprises a polymer standard viscosity (SV) of ≤4.5 cPs, ≤3.5 cPs, or preferably 2.5-3.5 cPs; (vi) comprises a molecular weight ranging from 1.5-9 million Da, 5-8 million Da, or 3 to 5 million Da; and/or (vii) optionally further comprises a buffer which maintains a pH in the range of 6-9, 6-8.5, or 6-7 after addition to the aqueous fiber suspension; (viii) is obtained by a method according to any of the foregoing; (ix) is obtained by polymerization of acrylamide (AM), acrylic acid (AA), and acryloyloxy ethyl trimethylammonium chloride (Q9) monomers; (x) is obtained by polymerization in a presence of 0.5-100 ppm, preferably 1.5-30 ppm, more preferably 2-20 ppm, of a crosslinking agent; (xi) is formulated as a dry polymer, a liquid polymer, or an inverse emulsion polymer; or (xii) any combination of (i)-(xi);
(c) the one or more inorganic colloids comprise colloidal silica; siliceous nano and/or microparticles; aluminum phyllosilicate mineral particles, including but not limited to bentonite, sodium bentonite, calcium bentonite, and montmorillonite; or combination of the following;
(d) the water-soluble amphoteric emulsion terpolymer is added to the aqueous fiber suspension at a dosage ranging from 0.1-1 kg/MT, 0.15-0.3 g/MT, or 0.4-0.8 kg/MT, wherein MT is metric ton of total fiber solids;
(e) the one or more inorganic colloids is added to the aqueous fiber suspension at a dosage ranging from 0.1-1 kg/MT, 0.15-0.3 g/MT, or 0.4-0.8 kg/MT, wherein MT is metric ton of total fiber solids;
(f) wherein the retention and drainage aid is added to the aqueous fiber suspension prior to or after dilution of the aqueous fiber suspension;
(g) adding the retention and drainage aid to the aqueous fiber suspension provides: (i) a synergistic improvement in drainage and dewatering of the fibrous web during gravity dewatering, vacuum drainage, and press dewatering; (ii) a synergistic improvement in water removal efficiency; (iii) a synergistic improvement in fixation and on-machine retention of starch, fines, fillers, and colloidal particles from the aqueous fiber suspension; (iv) a synergistic improvement in retention and drainage under alkaline conditions, wherein said water-soluble emulsion terpolymer and inorganic colloid functions as a fixative for improving retention and/or fixation of dyes, hydrophobics, starch and/or fillers, and/or drainage in manufacture of paper and/or board, optionally wherein said aid does not damage sheet formations; or (v) any combination of (i)-(iv); or
(h) any combination of (a)-(g).

In another aspect, the present invention provides an aqueous composition comprising:
(a) an aqueous fiber suspension according to any of the foregoing; and
(b) a retention and drainage aid comprising (i) a water-soluble amphoteric emulsion terpolymer, and (ii) one or more inorganic colloids according to any of the foregoing.

In another aspect, the present invention provides a paper or board obtained by a method according to any of the foregoing.

### BRIEF DESCRIPTION OF THE DRAWINGS

The invention will be described in more detail with reference to appended drawings, described in detail below.

FIG. 1 provides an exemplary schematic comparing amphoteric polymer characteristics in fresh water, low salinity and high salinity aqueous compositions according to Example 2. As shown amphoteric polymers include both anionic and cationic groups on the macromolecular chain; they exhibit both attraction and repulsion in their electrostatic intermolecular interactions (resulting in anti-polyelectrolyte association called “Amphoteric Effect”); they exhibit excellent salt tolerance, especially in high Ca+2 aqueous compositions; and they create 3D polymeric structures in saline water, and produce small flocs with a more open structure than linear polymers.

FIG. 2 compares charge effects of specific amphoteric polymers and non-amphoteric polymers according to Example 2. As shown a dry amphoteric polymer comprised of acrylamide, acrylic acid and Q9 monomers (Polymer A) and an amphoteric emulsion polymer according to the invention (Polymer B) show amphoteric association charge effects with the charge titration values dropping as the polymer solution pH values increase. By contrast, the conventional cationic polymer (equivalent emulsion polymer, non-amphoteric) is permanently charged with quaternary ammonium cations, and its charge titration values are independent of the acidity of the polymer solution.

FIG. 3 contains experimental results showing the effects of makedown pH solution on the final pH of different polymers, i.e., a dry amphoteric polymer comprised of acrylamide, acrylic acid and Q9 monomers (Polymer A) (and an amphoteric emulsion polymer according to the invention according to Example 3. The data indicate that the amphoteric polymer make-down solution pH preferably is <4.0 or 5.0 to avoid the interaction of anion side chains with cation side chains. Whereas the pH value of Polymer A makedown solution with hard water (>200 ppm hardness) is >5, (indicating a poor hard water acceptance), the amphoteric emulsion polymer according to the invention instead exhibits good hard water acceptance, as evidenced by the pH value of the emulsion polymer makedown solution with hard water being the same as with tap water (soft water) makedown solution.

FIG. 4 contains experiments comparing particle retention with different polymers using hardwood pulp high in pulp fines, conductivity (Ca++ content), alkaline and sulfite content (Stevenson NSSC hardwood pulp) according to Example 4. Whereas it is generally difficult for any cationic polymers to achieve a good fines/colloidal particle retention on such pulps, the experiments indicated that both amphoteric polymers (Polymer A and the inventive amphoteric emulsion polymer (Polymer B)) substantially improved fines retention, i.e., by 30% in relation to in relation to (Polymer C), a conventional cationic retention polymer.

FIGS. 5A and 5B contain experimental results comparing drainage effects and filtrate turbidity effects of different polymers, i.e., Polymer A, an amphoteric emulsion polymer according to the invention (Polymer B), and a conventional non-amphoteric cationic polymer (Polymer C) using a stock pH of low to mid 5, high conductivity levels which can be challenging using conventional emulsion polymers, i.e., furnish composition (SE Acid Kraft Liner furnish) comprising a pH of 5.2, a conductivity of 2.9 mS/cm3, a Ca hardness of 220 mg/L and an alkalinity of 60 mg/L. In the experiments the machine stock was diluted to 0.4% consistency for DDA testing (volume 500 ml, screen 0.25, vacuum 250 mBar), and the stock additives were 0.36 kg/metric ton cationic rosin and 6.8 kg/metric ton alum according to Example 5. As shown by the data in the FIG. 5A and FIG. 5B the inventive amphoteric emulsion polymer (Polymer B) performs better than dry amphoteric (Polymer A) and also better than a conventional non-amphoteric Q9 emulsion polymer (Polymer C) in both drainage (FIG. 5A) and retention (FIG. 5B) (as measured by turbidity).

FIGS. 6A and 6B contain experimental results comparing polymer performance of different doses of different polymers, i.e., (CPAM or Polymer D), Polymer A, a non-amphoteric cationic polymer (non-amphoteric Q9 polymer) (Polymer C) and the inventive amphoteric emulsion polymer (Polymer B) according to Example 6. In these experiments the stock pH was mid 6 (6.6) and the conductivity levels were high (3.2 mS/cm3, a Ca hardness of 120 mg/L (as CaCO3) and an alkalinity of 300 mg/L), which again can be challenging for traditional emulsion polymer performance. In the experiments the machine stock was diluted to 0.77% consistency for DDA testing (volume 700 ml, screen 0.25, vacuum 300 mBar), the stock ran very fast on DDA, leaving little room for drainage improvements, and the stock additives included polymer and alum at 4.53 kg/metric ton. As shown in FIG. 6 the inventive amphoteric emulsion polymer (Polymer B) performs better than dry amphoteric (Polymer A) and also better than the conventional non-amphoteric Q9 emulsion polymer (Polymer C) for drainage (see FIG. 6A) and retention (see FIG. 6B) (as measured by turbidity).

FIGS. 7A and 7B contain experimental results comparing polymer performance of different doses of different polymers, i.e., (Polymer D), (Polymer A), a non-amphoteric cationic polymer (non-amphoteric Q9 polymer) (Polymer C) and the inventive amphoteric emulsion polymer (Polymer B) according to Example 7. In these experiments the stock pH was mid-6 and had very high conductivity levels (furnish comprised pH 6.6, 3.2 mS/cm3, a Ca hardness of 120 mg/L (as CaCO3) and an alkalinity of 300 mg/L), which again can be challenging for traditional emulsion polymer performance. In the experiments the stock filtrate was high in colloidal material so Flyto was used to track polymer efficiency. As shown the inventive amphoteric emulsion polymer (Polymer B) provided excellent colloidal and hydrophobic particle retention, whereas Polymer A, (CPAM) (Polymer D) and the non-amphoteric Q9 equivalent (Polymer C) all gave similar results. Unexpectedly the inventive amphoteric emulsion polymer (Polymer B) gave 17.7% more colloidal retention than the non-amphoteric equivalent, 18.7% better than (Polymer D) and 22% better than (Polymer A). As shown in the bar graph (see FIG. 7A) and the data summarized in the Table (see FIG. 7B), the experiments revealed that the inventive emulsion polymer when tested at the same polymer doses as in the 2 previous examples provided excellent colloidal and hydrophobic particle retention.

FIGS. 8A and 8B contain the results of 2 case studies comparing the effects of different polymers (Polymer D, Polymer A, a non-amphoteric cationic polymer (non-amphoteric Q9 polymer (Polymer C) and the inventive amphoteric emulsion polymer (Polymer B)) on wet pressability evaluated using DDA according to Example 8. Higher press solids indicate more water is lost in the tested stage of pressing; therefore, conventional polymers used in papermaking tend to hold water in the paper machine forming section as better wet pressability provides for higher productivity. The case study in A used NA Recycle Liner Machine, a furnish of 0.66%, pH 5.36, conductivity of 4.02 mS/cm3, a Ca hardness of 880 mg/L (as CaCO3) and an alkalinity of 320 mg/L, and the DDA Pad detected % solids after the First Press. The case study in B again used NA Recycle Liner Machine, a furnish of 0.66%, pH 5.36, conductivity of 4.02 mS/cm3, a Ca hardness of 880 mg/L (as CaCO3) and an alkalinity of 320 mg/L, and the DDA Pad detected % solids after the Final Press. The results in the Figure show that the inventive amphoteric emulsion polymer yielded comparable or better water retention properties than conventional papermaking polymers (Polymer C and Polymer A) as evidenced by the detected solids percentages at different polymer doses after the first and the final press. As shown in Case study A (initial press) (see FIG. 8A) and Case study B (final press) (see FIG. 8B), there was a definite dose effect, i.e., the higher tested polymer doses of the inventive amphoteric emulsion polymer provided for greater % of detected solids.

FIGS. 9A and 9B compare the use of the inventive amphoteric emulsion polymer as a broke fixative in recycled furnish (Recycled commercial white towel furnish containing 30% post-consumer recycle content, contributing to high calcium levels) according to Example 9. In the experiments the inventive amphoteric emulsion polymer was compared for use as a broke additive to other conventional polymers, i.e., a polyamine polymer, amphoteric dry Polymer A, and non-amphoteric polymer (Polymer E). In Case Study A the turbidity of the tested furnish (obtained from recycled commercial white towels comprising 0.6% solids, pH 6.36, conductivity of 2.0 mS/cm3, a hardness of 600 mg/L as CaCO3 and an alkalinity of 360 mg/L was compared after treatment with different dosages (0.15, 0.3 and 0.45 kg/metric ton) of the inventive amphoteric emulsion polymer (Polymer B), a polyamine polymer (Polyamine F), dry amphoteric polymer (Polymer A), and non-amphoteric Polymer (Polymer E). In Case Study B the agglomerates count of the same furnish obtained from recycled commercial white towels (comprising 0.6% solids, pH 6.36, conductivity of 2.0 mS/cm3, a hardness of 600 mg/L as CaCO3 and an alkalinity of 360 mg/L) was similarly compared after treatment with the same dosages of the inventive amphoteric emulsion polymer, polyamine polymer, dry amphoteric polymer (Polymer A), and non-amphoteric polymer (Polymer E). The results of these case studies clearly demonstrate that thick stock treatment using the inventive amphoteric emulsion polymer provided for superior performance in both retention (as measured by reduced turbidity (ntu)) (see FIG. 9A), and based on the Flyto data, as evidenced by the significantly reduced hydrophobic (HP) agglomerate population (source of sheet deposits) (see FIG. 9B) when the inventive amphoteric emulsion polymer (Polymer B) was used as a broke additive as compared to the other tested polymers.

FIGS. 10A and 10B provide exemplary variability charts showing DDA drain time (sec) for recycled box boards prepared from low conductivity 100% OCC furnish treated with amphoteric emulsion polymer and conventional drainage aids without silica (see FIG. 10A) and with silica (see FIG. 10B), according to Example 14.

FIGS. 11A and 11B provide exemplary variability charts showing Filtrate Turbidity (NTU) from filtrates of recycled box boards prepared from low conductivity 100% OCC furnish treated with amphoteric emulsion polymer and conventional drainage aids without silica (see FIG. 11A) and with silica (see FIG. 11B), according to Example 14.

FIGS. 12A and 12B provide exemplary variability charts showing DDA fiber pad % solids by wt for recycled box boards prepared from low conductivity 100% OCC furnish treated with amphoteric emulsion polymer and conventional drainage aids without silica (see FIG. 12A) and with silica (see FIG. 12B), according to Example 14.

FIGS. 13A and 13B provide exemplary variability charts showing 1^{st} Press Dewatering % solids by wt for recycled box boards prepared from low conductivity 100% OCC furnish treated with amphoteric emulsion polymer and conventional drainage aids without silica (see FIG. 13A) and with silica (see FIG. 13B), according to Example 14.

FIGS. 14A and 14B provide exemplary variability charts showing 3^{rd} Press Dewatering % solids by wt for recycled box boards prepared from low conductivity 100% OCC furnish treated with amphoteric emulsion polymer and conventional drainage aids without silica (see FIG. 14A) and with silica (see FIG. 14B), according to Example 14.

FIGS. 15A and 15B provide exemplary variability charts showing DDA fiber pad Water Retention Value (WRV) (g/g) for recycled box boards prepared from low conductivity 100% OCC furnish treated with amphoteric emulsion polymer and conventional drainage aids without silica (see FIG. 15A) and with silica (see FIG. 15B), according to Example 14.

FIG. 16 provides an exemplary variability chart showing DDA drain time (sec) for recycled box boards prepared from high conductivity 100% OCC furnish treated with amphoteric emulsion polymer and conventional drainage aids with and without silica according to Example 15.

FIG. 17 provides an exemplary variability chart showing Filtrate Turbidity (NTU) from filtrates of recycled box boards prepared from high conductivity 100% OCC furnish treated with amphoteric emulsion polymer and conventional drainage aids with and without silica according to Example 15.

FIG. 18 provides an exemplary variability chart showing DDA fiber pad % solids by wt for recycled box boards prepared from high conductivity 100% OCC furnish treated with amphoteric emulsion polymer and conventional drainage aids with and without silica according to Example 15.

FIG. 19 provides an exemplary variability chart showing 1st Press Dewatering % solids by wt for recycled box boards prepared from high conductivity 100% OCC furnish treated with amphoteric emulsion polymer and conventional drainage aids with and without silica according to Example 15.

FIG. 20 provides an exemplary variability chart showing 3rd Press Dewatering % solids by wt for recycled box boards prepared from high conductivity 100% OCC furnish treated with amphoteric emulsion polymer and conventional drainage aids with and without silica according to Example 15.

### DETAILED DESCRIPTION OF THE INVENTION

### Definitions

Before describing the invention, the following definitions are provided. Unless stated otherwise all terms are to be construed as they would be by a person skilled in the art. All technical and scientific terms have the same meaning as commonly understood to one of ordinary skill in the art to which this invention belongs unless clearly indicated otherwise.

As used herein, the singular forms “a,” “an,” and “the” may mean “one” but also include plural referents such as “one or more” and “at least one” unless the context clearly dictates otherwise.

As used herein, the term “or” in the claims is used to mean “and/or” unless explicitly indicated to refer to alternatives only or the alternatives are mutually exclusive, although the disclosure supports a definition that refers to only alternatives and “and/or.”

As used herein the term “or combinations thereof” as used herein refers to all permutations and combinations of the listed items preceding the term unless stated otherwise.

### Papermaking

As used herein the term “breaking length” refers to a measure of the tensile strength of paper; in theory, the maximum length of a strip of paper that can support itself without tensile failure.

As used herein the term “break of the web” generally refers to breaks of the paper during papermaking. “Dry-End Breaks” can result from (a) weak points or holes in the paper, (b) insufficient ability to stretch, relative to the draw applied to the paper, (c) air-handling and fluttering issues, or (d) adhesion of the paper web to tacky surfaces. “Size-Press Breaks” can result from holes or weak areas in the sheet, but they also are often related to internal sizing issues. “Wet-End Breaks” are breaks of the wet web of paper after the couch roll or in the wet-press section of the papermaking machine. This may result from et-web mechanical properties such as wet-web tensile strength and stretch. The ability of a wet web to resist breakage is a function of both tensile strength and stretch, and both of these variables are affected by moisture content. A common way to increase wet-web tensile strength is to increase the softwood content of the furnish. Surfactants and other materials that tend to lubricate the contacts between fibers tend to weaken the wet web. Other factors that may cause wet-end breaks include deposition of tacky materials onto press felts and transfer rolls in the wet-press section which can result in excessive adhesion of the paper in these areas.

As used herein, the terms “broke” or “mill broke” refer to paper, which during the paper making process becomes suitable only for repulping e.g., trimmings or paper that is out of specification. Broke is re-used material which never left the mill is not regarded as recycled or recovered. Broke is a valuable source of fiber and is recycled internally at the mill.

As used herein a “closed water system” refers to a papermaking process in which the amount of liquid effluent has been decreased, sometimes to zero (totally closed).

As used herein, the term “coated broke” refers to broke that contains coatings that are applied to the base sheet of paper as it is being manufactured. When the broke contains these coatings, it presents special problems in recycling to recover fiber values because the coatings introduce materials which would not normally be present in the original stock of fiber used to manufacture the base paper sheet. The coated broke may also contain dyes and/or other additives. In the present application coated broke includes surface-sized, dyed, and/or creped broke.

As used herein the term “DCS” generally refers to dissolved and colloidal substances usually derived from wood and usually having a negative charge, tending to interfere with retention aids and other papermaking additives.

As used herein, the terms “dispersion” or “aqueous dispersion” generally refer to a heterogeneous mixture of a fluid (e.g., water) that contains solid particles, wherein the solid particles forms a phase separated mixture in which one substance of macroscopically or microscopically dispersed insoluble or soluble particles is suspended throughout another substance, typically a liquid substance. A dispersion has a dispersed phase (the suspended particles) and a continuous phase (the medium of suspension) that arise by phase separation. Macroscopic particles typically separate and settle quickly, while colloids typically do not completely settle or take a long time to settle completely into two separated layers.

As used herein the term “dry strength” generally refers to the force or energy required to break a paper sample, by one of various procedures, after equilibration in a standard atmosphere.

As used herein, the term “fiber” refers to the basic structural unit of paper or board.

As used herein, the term “fiber suspension” or “fiber stock” is understood as an aqueous suspension, which comprises fibers, preferably recycled fibers, and optionally fillers. For example, the fiber suspension may comprise at least 5%, preferably 10-30%, more preferably 11-19% of mineral filler. Mineral filler may be any filler conventionally used in paper and board manufacturing, such as ground calcium carbonate, precipitated calcium carbonate, clay, talc, gypsum, titanium dioxide, synthetic silicate, aluminum trihydrate, barium sulphate, magnesium oxide or their any of mixtures.

As used herein, the terms “fixation”, “fixing” and “fix” means that a substance is associated or attached onto the fibers at least temporarily or permanently.

As used herein the term “fixative” generally refers to an additive having the tendency to help retain dye material on fiber surfaces, usually because of a strong positive charge.

As used herein, the term “flocculation” generally refers to the tendency for fibers to collect together in bunches in the presence of flow, and especially in the presence of retention aids; the same word also refers to the action of high-mass polymers in forming bridges between suspended colloidal particles, causing strong, relatively irreversible agglomeration.

The term “flocculant” may generally refer to a reagent that may bridge neutralized or facilitate coagulation of particles into larger agglomerates, typically resulting in more efficient settling. Flocculation process generally involves addition of a flocculant followed by mixing to facilitate collisions between particles, allowing for the destabilized particles to agglomerate into larger particles that can be removed by gravity through sedimentation or by other means, e.g., centrifugation, filtration.

As used herein, the terms “furnish” or “papermaking furnish” generally refers to a mixture of cellulosic fibers, pulp, optional fillers, dyes, and water from which paper or board is made.

As used herein, the term “hard water” generally refers to water having a Ca2+ (typically as calcium carbonate) of greater than 120 mg/L, greater than 130 mg/L, greater than 140 mg/L or greater than 150 mg/L. In some embodiments water hardness may be classified by concentration of calcium carbonate, where below 75 mg/L calcium carbonate is considered soft, 76 to 150 mg/L calcium carbonate is moderately hard, and 151 to 300 mg/L calcium carbonate is hard. In other embodiments, the general guidelines for classification of waters are: 0 to 60 mg/L (milligrams per liter) as calcium carbonate is classified as soft; 61 to 120 mg/L as moderately hard; 121 to 180 mg/L as hard; and more than 180 mg/L as very hard. In some embodiments water hardness may be classified by conductivity, where 0-140 μmhos/cm is considered very soft, 140-300 μmhos/cm is soft, 300-500 μmhos/cm is slightly hard, 500-640 μmhos/cm is moderately hard, and 640-840 μmhos/cm is hard. Water with conductivity above 840 is considered very hard.

As used herein the term “headbox” refers a receptacle in a papermaking machine that holds suspended aqueous cellulosic solids and which regulates the flow thereof onto a wire or screen that provides for the draining of water therefrom.

As used herein the term “internal sizing” generally refers to treatment of the fiber slurry so that the paper will resist fluids.

As used herein the term “lignocellulosic substrate” or “fiber pad” or “fiber mat” refer to a paper and/or paperboard product formed from plant dry matter from any source, virgin or recycled, which may be coated, printed, and/or formed into a packaging product. For example, such substrates include paper products made from pulp, such as by methods comprising forming an aqueous cellulosic papermaking furnish, draining the furnish to form a sheet, and drying the sheet. The steps of forming the papermaking furnish, draining and drying may be carried out in any conventional manner generally known in the art. The substrates may contain polymeric strengthening agents, such as wet strength and dry strength agents.

As used herein, the term “OCC” refers to old corrugated cardboard and/or containerboard. Corrugated refers to those boxes where the materials are made from three separate layers of paper, two liners and a corrugated, or wavy, layer sandwiched between them. Brown paper bags are commonly accepted with OCC for recycling. The term OCC denotes recycled fiber material which have liners of test liner, jute or kraft, and may cover also double sorted corrugated containerboard (DS OCC).

As used herein, the term “paper” includes products comprising a cellulosic sheet material including paper sheet, paperboard, and the like.

As used herein, the terms “papermaking process” and “papermaking application” generally refers to any process in which any form of paper and/or paperboard product may be produced. For example, such processes include making paper products from pulp, such as methods comprising forming an aqueous cellulosic papermaking furnish, draining the furnish to form a sheet, and drying the sheet. The steps of forming the papermaking furnish, draining and drying may be carried out in any conventional manner generally known in the art. In some instances, papermaking processes and applications may comprise the use of one or more polymer solutions, wherein said polymer solutions may comprise one or more DPAMs, one or more CPAMs, one or more APAMs, and/or one or more PAE resins, for example as paper strengthening agents and/or wet-strength agents or drainage and retention aids.

As used herein, the terms “recycled fiber” and “recovered fiber”, refer postconsumer reclaimed material and pre-consumer reclaimed material. Post-consumer reclaimed material includes material that is reclaimed from a consumer or commercial product that has been used for its intended purpose by individuals, households or by commercial, industrial and institutional facilities in their role as end-users of the product. Pre-consumer reclaimed material includes material that is reclaimed from a process of secondary manufacture or further downstream industry, in which the material has not been intentionally produced, is unfit for end use and not capable of being re-used on-site in the same manufacturing process that generated it. Recycled fiber refers to paper, paperboard, and fibrous wastes from retail stores, office buildings, homes, manufacturing plants, and so forth, after they have passed through their end-usage as a consumer item. Manufacturing wastes include: dry paper and paperboard waste generated after completion of the papermaking process including by way of example: envelope cuttings, bindery trimmings, and other paper and paperboard waste resulting from printing, cutting, forming, and other converting operations; bag, box, and carton manufacturing wastes; mill wrappers, and rejected unused stock; and repulped finished paper and paperboard from obsolete inventories of paper and paperboard manufacturers, merchants, wholesalers, dealers, printers, converters, or others. In particular the term “recycled fibers” includes recycled fibers derived by processing of paper and other consumer cellulosic materials, e.g., paper, old corrugated containerboard (OCC), mixed office waste (MOW), old magazine (OMG), unbleached kraft pulp, neutral sulphite semi chemical (NCCS) pulp and/or mechanical pulp. Source materials for recycled fibers may be selected from old corrugated containerboard, mixed office waste, old newsprint, old magazines, double liner kraft, and any mixtures thereof. Mixed waste (MXW) denotes recycled mixture of recycled board, such as OCC, white lined chipboard and/or folding boxboard, and recycled paper, such as old newsprint, old magazines and/or office waste papers. Mixed office waste denotes recycled fiber material mainly containing copying papers, printer papers and offset papers. Double lined kraft denotes recycled fiber material comprising clean sorted unprinted corrugated cardboard cartons, boxes, sheet or trimmings, e.g., of kraft or jute liner. White lined chipboard (WLC) denotes multiply board comprising deinked fiber material and/or un-deinked recycled fiber material originating e.g., from OCC, mixed office waste or old newspapers (ONP) in or more of the layers. Presence of any of these recycled fiber materials in the fiber suspension usually decreases drainage and paper strength and provides a substantial load of starch, hydrophobic, and colloidal substances to the process. Also, the term “recycled fibers” includes the fiber fraction or broke of a paper machine, e.g., a paper machine which produces paper partially or entirely from recycled fibers, and the actual post-consumer wastepaper and board. In some instances, the recycled fibers may have recycled numerous times, e.g., 2, 3, 4, 5, 6, 7 or more times.

As used herein, the term “recycled fiber composition” generally refers to a composition comprising recycled cellulosic fibers, typically a composition wherein most or all are recycled fibers, e.g., at least 20, 40, 50, 60, 70, 80, 90 or 100%.

As used herein the term “rheology modifier” refer to any substance that can alter the rheological properties (e.g., resistance to deformation and flow) of a material. They are added to formulations to increase or decrease viscosity and to control a finished the properties and characteristics of a liquid composition in a desired manner.

As used herein, the term “slurry” generally refers to a mixture of water, dissolved paper pulp, and optionally other soluble or insoluble components produced or added during the stock preparation phase of papermaking.

As used herein the term “stickies” refers to sticky materials often comprised in recycled papermaking pulp, often involving pressure-sensitive labels. Because they are deformable, they cannot be completely excluded by pressure screens. The main culprit in stickies is the polyvinylacetate (PVA) and other binders in the “pressure-sensitive” labels that have become so common in mail and packages which can cling together and tend to build up into globs or strings, adhere to papermaking equipment, fill felts, and/or make spots in paper products.

As used herein the term “surfactant” refers to a surface active agent usually comprised of molecules with water-loving and water-hating groups, used for wetting, emulsifying, etc.

As used herein the term “surface sizing” generally refers to the application of a solution, often containing starch, to the surface of paper, usually in order to increase surface strength, and sometimes with addition of hydrophobic polymers or other material at the paper surface.

As used herein, the term “thick stock” generally refers to mixture of papermaking pulp and other materials, after having been diluted with whitewater at a fan pump, with a consistency (total suspended solids, TSS) of about 1-5% or 2-5% by wt.

As used herein, the term “thin stock” generally refers to a mixture of papermaking pulp and other materials, after having been diluted to a consistency (total suspended solids, TSS) below 2% or 1% by wt with whitewater or other process water at a fan pump.

As used herein, the terms “wet end of a paper machine” or “wet end” generally refer to the parts of a papermaking process between pulping (or bleaching) and wet-pressing of the paper.

As used herein the term “wet strength” generally refers to the strength of a sheet of paper after it has been exposed to a standard solution for a standard length of time, but often expressed as a ratio vs. the dry strength.

As used herein, the term “white water” generally refers to process water within a paper machine system, especially referring to water that is drained from paper as the sheet is being formed.

### Polymers

As used herein, the term “amphoteric polymer” refers to polymers containing both anionic and cationic groups on the macromolecular chain. These polymers exhibit both attraction and repulsion in their electrostatic intermolecular interactions (resulting in anti-polyelectrolyte association called “Amphoteric Effect”) and they exhibit excellent salt tolerance, especially in high Ca+2 aqueous compositions.

As used herein, “a chain transfer agent” is a compound used during polymerization which acts to control the molecular weight of the polymer. Examples of chain transfer agents which may be used in the production of an acrylic acid-based polymer include sodium phosphite, sodium hypophosphite, sodium bisulfite, mercaptoacetic acid, mercaptopropionic acid, 2-propanethiol, 2-mercaptoethanol, thiophenol, isopropyl alcohol, and the like, preferably sodium hypophosphite or isopropyl alcohol.

As used herein, the term “emulsion polymer” generally refers to inverse emulsions (water-in-oil) in which water droplets containing the polymer are suspended in an oil phase, also termed a hydrophobic phase.

As used herein, the term “inverse phase emulsion” refers to a liquid polymer composition of polymer dissolved in an aqueous solution which is dispersed into an oil phase (e.g., hydrophobic liquid) to form an oil-continuous phase, which is then mixed with an aqueous solution so that the dispersed polymer phase of the liquid polymer composition becomes a substantially aqueous-continuous phase, and the hydrophobic liquid phase becomes a dispersed, discontinuous phase. The inversion point can be characterized as the point at which the viscosity of the inverted polymer solution has substantially reached its maximum under a given set of conditions. In practice, this may be determined for example by measuring viscosity of the composition periodically over time and when three consecutive measurements are within the standard of error for the measurement, then the solution is considered inverted.

As used herein, the term “liquid polymer” refers to a combination of at least one polymer and a liquid, typically an aqueous liquid. The polymer in a may be thoroughly dissolved or may be a partially dissolved suspension, dispersion, or slurry. When a dry polymer is combined with an aqueous liquid, the polymer is initially partially hydrated at the polymer-water interface. Polymers do not dissolve instantaneously in aqueous or non-aqueous solvents. Dissolution is controlled by either the disentanglement of the polymer chains or by the diffusion of the chains through a boundary layer adjacent to the polymer-solvent interface. After thorough mixing, the polymer may become fully hydrated, at which point the wetting process is complete and the polymer may be either partially dissolved or fully dissolved, depending on the nature and composition of the polymer and solvent.

As used herein, the terms “polyacrylamide” or “PAM” generally refer to polymers and co-polymers comprising acrylamide moieties, and the terms encompass any polymers or copolymers, including terpolymers, comprising acrylamide moieties, e.g., one or more acrylamide (co) polymers of acrylamide and additional monomers capable of copolymerizing with acrylamide. The PAMs described herein may be produced in one of various forms, including, for example, dry (powder) polyacrylamide (DPAM), emulsion polyacrylamide (EPAM), or liquid polyacrylamide. Amphoteric polyacrylamides (AmPAM) may be formulated in dry (powder) form (AmDPAM), or emulsion form (AmEPAM). In some instances, PAMs may comprise anionic PAMs (APAMs), cationic PAMs (CPAMs), and/or sulfonated PAMs (SPAMs).

As used herein, the terms “polymer” or “polymeric” and similar terms are used in their ordinary sense as understood by one skilled in the art, and thus may be used herein to refer to or describe a large molecule (or group of such molecules) that may comprise recurring units. Polymers may be formed in various ways, including by polymerizing monomers and/or by chemically modifying one or more recurring units of a precursor polymer. Unless otherwise specified, a polymer may comprise a “homopolymer” that may comprise substantially identical recurring units that may be formed by, for example, polymerizing a particular monomer. Unless otherwise specified, a polymer may also comprise a “copolymer” that may comprise two or more different recurring units that may be formed by, for example, copolymerizing, two or more different monomers, and/or by chemically modifying one or more recurring units of a precursor polymer. Unless otherwise specified, a polymer or copolymer may also comprise a “terpolymer” or a “tetrapolymer” which generally refer to polymers that comprise three, four, or more different recurring monomer units. The term “polymer” as used herein is intended to include both the acid form of the polymer as well as its various salts. Polymers may be amphoteric in nature, that is, containing both anionic and cationic substituents, although not necessarily in the same proportions.

As used herein the term “polymerization initiator” includes compounds and compositions which promote polymerization, e.g., during acrylamide polymerization. Examples of polymerization initiator include 2,3-Dimethyl-2,3-diphenylbutane, tert-Butyl hydroperoxide, tert-Amyl hydroperoxide, Cumyl hydroperoxide, 1,1,3,3-Tetramethylbutyl hydroperoxide, Isopropylcumyl hydroperoxide, Isopropylcumyl hydroperoxide, 2,5-Dimethyl-2,5-di(tert-butylperoxy) hexyne-3,3,6,9-Triethyl-3,6,9-trimethyl-1,4,7-triperoxonane, Di(tert-butyl) peroxide, 2,5-Dimethyl-2,5-di(tert-butylperoxy) hexane, Di(tert-butylperoxy-isopropyl)benzene, tert-Butyl cumyl peroxide, Di-(tert-amyl)-peroxide, Dicumyl peroxide, Butyl 4,4-di(tert-butylperoxy) valerate, tert-Butylperoxybenzoate, 2,2-Di(tert-butylperoxy) butane, tert-Amyl peroxy-benzoate, tert-Butylperoxy-acetate, tert-Butylperoxy-(2-ethylhexyl) carbonate, tert-Butylperoxy isopropyl carbonate, tert-Butyl peroxy-3,5,5-trimethyl-hexanoate, 1,1-Di(tert-butylperoxy)cyclohexane, tert-Amyl peroxyacetate, tert-Amylperoxy-(2-ethylhexyl) carbonate, 1,1-Di(tert-butylperoxy)-3,5,5-trimethylcyclohexane, 1,1-Di(tert-amylperoxy)cyclohexane, tert-Butyl-monoperoxy-maleate, 1,1′-Azodi(hexahydrobenzonitrile), tert-Butyl peroxy-isobutyrate, tert-Butyl peroxydiethylacetate, tert-Butyl peroxy-2-ethylhexanoate, Dibenzoyl peroxide, tert-Amyl peroxy-2-ethylhexanoate, Di(4-methylbenzoyl) peroxide, 1,1,3,3-Tetramethylbutyl peroxy-2-ethylhexanoate, Ammoniumperoxodisulfate, 2,5-Dimethyl-2,5-di(2-ethylhexanoylperoxy) hexane, 2,2′-Azodi(2-methylbutyronitrile), 2,2′-Azodi(isobutyronitrile), Didecanoyl peroxide, Dilauroyl peroxide, Di(3,5,5-trimethylhexanoyl) peroxide, tert-Amyl peroxypivalate, tert-Butyl peroxyneoheptanoate, 1,1,3,3-Tetramethylbutyl peroxypivalate, tert-Butyl peroxypivalate, Dicetyl peroxydicarbonate, Dimyristyl peroxydicarbonate, Di(2-ethylhexyl) peroxydicarbonate, Di(4-tert-butylcyclohexyl) peroxydicarbonate, Diisopropyl peroxydicarbonate, tert-Butyl peroxyneodecanoate, Di-sec-butyl peroxydicarbonate, tert-Amyl peroxyneodecanoate, Cumyl peroxyneoheptanoate, Di(3-methoxybutyl) peroxydicarbonate, 1,1,3,3-Tetramethylbutyl peroxyneodecanoate, Cumyl peroxyneodecanoate, and Diisobutyryl peroxide. In the exemplified polymerization methods tert-butyl hydroperoxide is used as the initiator.

As used herein, “polymer molecular weight”, “molecular weight”, or “MW” may be measured by various methods known to persons of skill in the art. For example, “weight average molecular weight” may be measured using gel permeation chromatography (GPC). Additionally, polymer “molecular weights” may be measured by GPC/Light Scattering/Viscometry also known as Triple Detection GPC which employs Refractive Index Detector (with or without UV Detector), Dilute Solution Viscometry and Light Scattering all in series to determine molecular weights, distribution and related solution parameters.

As used herein, the term “monomer” generally refers to nonionic monomers, anionic monomers, cationic monomers, zwitterionic monomers, betaine monomers, and amphoteric ion pair monomers.

As used herein the term “nonionic monomer” generally refers to a monomer that possesses a neutral charge. Non-limiting examples of nonionic monomers include, acrylamide, N-alkylacrylamides, N,N-dialkylacrylamides, methacrylamide, N-vinylmethylacetamide or formamide, vinyl acetate, vinyl pyrrolidone, alkyl methacrylates, acrylonitrile, N-vinylpyrrolidone other acrylic (or other ethylenically unsaturated) ester or other water insoluble vinyl monomers such as styrene or acrylonitrile. Herein a nonionic monomer” generally refers to acrylamide (“AMD”).

As used herein, the term “cationic monomer” generally refers to a monomer that possesses a positive charge. In an exemplary embodiment, a nonionic monomer may comprise acryloyloxy ethyl trimethylammonium chloride (Q9). Other examples thereof include methacryloyloxyethyltrimethylammonium chloride (“MAETAC”), methacrylamidopropyltrimethylammonium chloride (“MAPTAC”), acrylamidopropyltrimethylammonium chloride (“APTAC”), methacryloyloxyethyldimethylammonium sulfate, and diallyldimethylammonium chloride (“DADMAC”).

As used herein, the term “anionic monomers” may refer to either anionic monomers that are substantially anionic in whole or (in equilibrium) in part, at a pH in the range of about 1.0 to about 10.0. The “anionic monomers” may be neutral at low pH (e.g., from a pH of about 0-1, 0-2, or 0-3) depending on the pKa values of acidic protons contained therein. Some anionic monomers are obtained in anionic form as alkali metal salts, alkaline earth metal salts, and ammonium salts, e.g., sodium acetate. Anionic monomers may be acrylic, methacrylic, maleic monomers and the like, sodium acrylate, calcium diacrylate, and/or any monomer substituted with a carboxylic acid group or salt thereof. In some embodiments, anionic monomers may be substituted with a carboxylic acid group and include, for example, acrylic acid, and methacrylic acid. In some embodiments, an anionic monomer which may be used herein may be an acrylamide monomer wherein the amide group has been hydrolyzed to a carboxyl group. Said monomer may be a derivative or salt of a monomer according to other embodiments, on-limiting representative anionic monomers include acrylic acid, sodium acrylate, ammonium acrylate, methacrylic acid, 2-acrylamido-2-methylpropanesulfonic acid (AMPS), vinyl sulfonic acid, styrene sulfonic acid, maleic acid, sulfopropyl acrylate or methacrylate or other water-soluble forms of these or other polymerizable carboxylic or sulphonic acids, sulfomethylated acrylamide, allyl sulfonate, itaconic acid, acrylamidomethylbutanoic acid, fumaric acid, vinylphosphonic acid, allylphosphonic acid, phosphonomethylated acrylamide, methacrylate, itaconate, 2-acrylamido 2-methyl propane sulphonate, sulfoalkyl (meth)acrylic acids, sulfonated styrenes, unsaturated dicarboxylic acids, sulfoalkyl (meth)acrylamides, vinyl acetate, n-vinylformamide, n-vinylacetamide, n-vinylcaprolactam, n-vinylimidazole, n-vinylpyridine, n-vinylpyrolidone, acrylamidopropyltrimonium chloride, salts of said acids and the like, or another anionic ethylenically unsaturated compounds or alkali metal salts, alkaline earth metal salts, and ammonium salts thereof.

As used here “Q9”, “AETAC”, and “ADAM-CI” refer to 2-(acryloyloxy)ethyl]trimethylammonium chloride (Q9) monomer, which has a molecular formula of C8H16ClNO2 and a molecular weight of 193.67 g/mol.

As used herein acrylamide or “AM” or “AMD” refers to a neutral monomer of molecular formula: C3H5NO and a molecular weight of 71.08 g/mol.

As used herein acrylic acid or “AA” refers to an anionic monomer of molecular formula: CH2CHCOOH and a molecular weight of 72.06 g/mol.

The term “water-soluble polymer” generally refers to any polymer that may dissolve and/or disperse in water.

### Retention And Drainage Aids

As used herein, the term “water-soluble amphoteric polymers” or “water-soluble amphoteric terpolymers” generally refers to polymers comprised of acrylamide (AM) monomers, one or more anionic monomers, and one or more cationic monomers. Such polymers may be utilized in the inventive retention and drainage aids as amphoteric emulsion polymers (AmEPAM).

As used herein, the terms “inorganic colloids” generally refers to anionic materials added to papermaking furnish as part of drainage-aid programs. Exemplary inorganic colloids are selected from the group of microparticles and nanoparticles consisting of silica microparticles; colloidal silica; aluminum phyllosilicate mineral particles, including but not limited to bentonite, sodium bentonite, calcium bentonite, and montmorillonite. Preferred inorganic colloids may include silica or colloidal silica. The function of the colloidal silica appears to involve (a) release of water from polyelectrolyte bridges, causing them to contract, and (b) acting as a link in bridges that involve macromolecules adsorbed on different fibers or fine particles. These effects create more streamlined paths for water to flow around the fibers. The tendency of inorganic colloids to boost first-pass retention also will tend to have a positive effect on dewatering rates.

### Terms And Units

As used herein, the term “aqueous solution” or “solution” generally refers to a mixture of water and a water-soluble solute or solutes which are completely dissolved with little to no residual undissolved polymer gel. The solution may be homogenous. An exemplary aqueous polymer solution comprises a polymer mixed with an excess of water so that the polymer is preferably fully dissolved and the obtained polymer solution is preferably free from discrete polymer particles or granules or residual gel.

As used herein, the term “aqueous suspension”, “aqueous slurry”, or “slurry” generally refer to a heterogeneous mixture of a fluid that contains insoluble or sparingly soluble solid particles sufficiently large for sedimentation. Suspensions and slurries of the present invention may also comprise some amount of solid particles, often termed colloidal particles, which do not completely settle or take a long time to settle completely.

As used herein, the term “consistency” generally refers to percent oven dry mass in the stock, slurry, or furnish (i.e., 100%*oven dry mass/total mass).

As used herein, the phrases “% by wt.” denotes pounds of dry mass of additive per dry mass of solids in the formulation, solution, or slurry, multiplied by 100%.

The terms, “total solids” or “total suspended solids” are used interchangeably herein and generally refer the total amount or weight of suspended solids contained in oil sands or other sands

As used herein, the term “ppm” refers to parts per million on the basis of milligrams of solute per liter of aqueous solution or slurry (e.g., mg/L).

As used herein the term “kg/T” or “kg/MT” means kilograms per metric ton.

### DESCRIPTION OF THE INVENTION

### Amphoteric Emulsion Terpolymers

The present invention relates to novel amphoteric polymers in emulsion form which possess good hard water acceptance, do not require an expensive makedown process or unit, possess improved effectiveness when used as sticky control agents and when used as retention/drainage aids e.g., in high conductivity wet end systems, and as a productivity aid on acid kraft liner paper machines; which when used as broke additives provide for improved retention of fiber, fines, colloidal, hydrophobic and particulate materials, improved wet pressability, improved drainage and filtrate turbidity. Further the inventive amphoteric emulsion polymers possess enhanced properties when used on Kraft liner machines, because e.g., they show superior ability to retain hydrophobic agglomerates which comprise a known source of sheet deposits.

In particular, the invention provides novel water-soluble amphoteric emulsion copolymers synthesized by inverse emulsion using three different monomers, i.e., acrylamide (AA) (nonionic), acrylic acid (AA) (anionic at higher pH levels), acryloyloxy ethyl trimethylammonium chloride (Q9) (cationic), which amphoteric emulsion terpolymers preferably possess the following properties:
a polymer standard viscosity (SV)<3.5 cPs and typically from about 2.5 to 3.5 cPs,
an acrylic acid anionic monomer content of <3 wt %, more preferably ≤2 wt %,
up to 20 wt % acryloyloxy ethyl trimethylammonium chloride (Q9) cationic monomer content,
a molecular weight ranging from 1.5 to 9 million Daltons or preferably 5 to 8 million Daltons, wherein at low pH range, the carboxylic groups of the acrylic acid are found in the protonated form.

The inventive amphoteric polymer emulsions are synthesized in emulsion form, i.e., by use of inverse emulsion methods, in exemplary embodiments as disclosed in the examples and as further described below.

### Inversion Emulsion Process

In general, the inverse emulsion polymerization comprises the following steps or “phases”:

### (1) Monomer Phase

The “Monomer Phase” generally comprises producing an admixture of the acrylamide, cationic monomer (Q9) and acrylic acid monomers and a chain transfer agent, e.g., sodium hypophosphite, or another chain transfer agent such as polyvinyl alcohol at low temperature (i.e., below 30° C., optionally by the use of an ice bath), and under acidic conditions, preferably at a pH between 2.5 and 5.0, 2.5 and 4.5, 2.5 and 3.5, 2.5-3.5 or 2.7-3.5 or 2.8-3.5 or 3.0-3.3.

During the preparation of the monomer phase the mole ratios of the 3 monomers are carefully selected so as to obtain a terpolymer that comprises the desired mole ratios, i.e., an acrylic acid (AA) anionic monomer content of <3 wt %, preferably <2 wt %, up to 20 wt % Q9 cationic monomers, and at least 78 wt % acrylamide (AM) monomers.

Also, during the monomer phase the amount of the chain transfer agent, e.g., sodium hypophosphite, or another chain transfer agent such as polyvinyl alcohol is added which provides for the desired low SV value (<3.5 cPs or more typically from 2.5 to 3.5 cPs).

Further, during the monomer phase the pH is maintained between 22.5 and 5.0, 2.5 and 4.5, 2.5 and 3.5, 2.5-3.5 or 2.7-3.5 or 2.8-3.5 or 3.0-3.3, e.g., by an acidic buffer such as a citric acid buffer or a sodium acetate-acetic acid buffer.

### Oil Phase:

The “Oil Phase” generally comprises preparing an oil phase comprising an oil or other hydrophobic liquid, e.g., a paraffin solvent which is mixed with a surfactant under conditions which result in a substantially homogeneous oil phase. In exemplary embodiments a paraffin solvent, e.g., a petroleum solvent, e.g., at about 19-21% wt, is added to the mixture, and the resultant mixture is stirred, e.g., using an overhead mixer. An ethoxylated alcohol (e.g., C12-C16 ethoxylated alcohol is then added at about 2-3% by weight to the steel jug and the resultant mixture is permitted to mix for a sufficient time, e.g., 10 minutes or more.

### Combining Phase:

This phase generally comprises the slow addition of the monomer phase to the oil phase, (e.g., over a period of at least 30 seconds), permitting the 2 phases to mix, optionally for at least ~20 minutes, detecting the viscosity during and/or after mixing, and homogenizing the resultant mixture, e.g., for at least ~20 seconds (using a Ross Homogenizer operating at 4500 RPM), optionally detecting the viscosity again after homogenizing, e.g., using a Brookfield viscometer equipped with No. 3 spindle spinning at 12 RPM), adding the resultant mixture to a polymerization reactor and determining the initial temperature prior to the start of polymerization.

### Sparging Phase:

This step comprises sparging the contents of the reactor comprising the monomer comprising reaction mixture with a gas, e.g., nitrogen for a prolonged period, e.g., ~1 hour while continuously stirring the mixture.

### Polymerization Phase:

The polymerization process generally comprises the addition of a suitable polymerization initiator, e.g., an oxidizing agent such as tert-butyl hydroperoxide, sodium bromate, or sodium chlorate, or a thermal AZO initiator, and typically tert-butyl hydroperoxide, e.g., at a dosage range of about 10 to 30 ppm, is added to the nitrogen sparged monomer containing monomer mixture, mixing, and permitting polymerization to proceed. In exemplary embodiments this is effected by introducing SO₂ gas, e.g., 0.4% at 18 Standard cubic centimeters per minute (SCCM) and the resultant rise in temperature is monitored as the exothermic polymerization reaction proceeds.

In exemplary embodiments the flow rate of SO₂ is controlled during the polymerization process such that the raise in temperature is gradual (~1° C./minute). In exemplary embodiments, so as to obtain an emulsion terpolymer of a desired molecular weight, the temperature is maintained below 50° C., e.g., by using a water bath and simultaneously cutting the SO₂ supply.

The completion of the polymerization reaction is indicated when no further increase in temperature is detected even when SO₂ is continuously being fed. At this point, the SO₂ flow rate is reduced to the initial value and the reactor temperature is adjusted to =50° C., and these conditions are maintained for a prolonged time period, e.g., for ~1.5 hours. Additionally, nitrogen is continuously sparged throughout the entire polymerization process.

### Post-Polymerization:

After the completion of the polymerization phase, the polymerizate is optionally treated in order to eliminate any residual acrylamide monomers using any method generally known in the field for eliminating residual acrylamide monomers. After polymerization is completed the flow of the SO₂ and nitrogen gases are then turned off, an inverting surfactant is added to the subsurface, optionally a seven-mole ethoxylate of linear, primary 12-14 carbon number alcohol, and the reactor is permitted to cool to <30° C., and the resultant emulsion amphoteric terpolymer is then transferred to a suitable container.

### Properties and Advantages of Inventive Emulsion Polymers and Compositions CONTAINING

Emulsion amphoteric polymers produced by the foregoing methods comprise the following properties and advantages:
comprise an acrylic acid anionic monomer content <2 wt % and up to 20 wt % Q9=>>78 wt % PA;
comprise a polymer standard viscosity (SV)<3.5 cPs or more typically from 2.5 to 3.5 cPs,
comprise an acrylic acid anionic monomer content ≤2 wt %,
possess a MW ranging from 1.5 to 9 million Daltons or more preferably 5 to 8 million Daltons;
and in an especially preferred exemplary embodiments comprise the following composition: AM: AA: Q9-89:2:9.

Emulsion amphoteric polymers produced by the foregoing methods further comprise the following properties:
at low pH range, the acrylic acid monomers are nonionic and the carboxylic groups remain protonated;
the 3 monomers when preblended in the monomer phase avoid the negative interactions of two oppositely charged monomers by reducing the monomer phase pH to the range of 2.5 and 5.0, 2.5 and 4.5, 2.5 and 3.5, 2.5-3.5 or 2.7-3.5 or 2.8-3.5 or 3.0-3.3;
amphoteric polymer emulsions comprising only ~2 wt % anionic monomer when tested yield strong amphoteric charge effects;
the addition of an acidic buffer, e.g., citric acid buffer solution promotes good hard water acceptance;
a low SV value (<3.5 cPs or more typically from 2.5 to 3.5 cPs) is achieved by the use of a suitable chain transfer agent, e.g., sodium hypophosphite or polyvinyl alcohol; and
a reduced molecular weight suitable for both fixation and retention/drainage boosting applications without damaging sheet formations at elevated polymer dosage levels.

In use emulsion amphoteric polymer dispersions obtained according to these methods:
provide for a higher dewatering rate and colloidal particle retention in acid kraft liner grades in relation to comparative dry amphoteric polymers and non-amphoteric polymers;
improve fines retention by 30% over a conventional cationic retention polymer in an unbleached high yield hardwood pulp which is difficult for any cationic polymers to achieve a rational fines/colloidal particle retention in relation to comparative dry amphoteric polymers and non-amphoteric cationic polymers.

In particular, the invention provides a liquid emulsion form amphoteric polyacrylamide wherein the low SV value range of terpolymer is achieved by judicious use of a chain transfer agent, e.g., sodium phosphite, sodium hypophosphite, sodium bisulfite, mercaptoacetic acid, mercaptopropionic acid, 2-propanethiol, 2-mercaptoethanol, thiophenol, isopropyl alcohol, and preferably sodium hypophosphite or isopropyl alcohol.

Also, the invention provides a liquid emulsion form amphoteric polyacrylamide wherein the use of specific chain transfer agents in specific amounts results in amphoteric emulsion terpolymers of reduced molecular weights which are suitable for both fixation and retention/drainage boosting applications without damaging sheet formations at elevated polymer dosage levels.

Based on these advantages the inventive water-soluble amphoteric emulsion polymers are well suited for use in papermaking and other methods, e.g., for treating fiber stock in manufacture of paper and/or board. Particularly the inventive emulsion polymers may be used in making paper and board from inexpensive fiber sources, e.g., old corrugated containerboard (OCC) and other recycled paper and board grades, which finds increased usage over the past decades. Also, the inventive emulsion polymers may be used in areas that comprise hard water.

Also given the beneficial properties of the inventive emulsion polymers they will be useful in processes other than papermaking, e.g., they may be used retention/drainage cationic booster for colloidal silica retention and drainage programs and as flocculants in water quantity and quality management (WQQM) applications.

Moreover given the beneficial properties of the inventive emulsion polymers including good hard water acceptance they will be more effective in various applications wherein hard water, i.e., water of high conductivity is used e.g., as a sticky control, drainage aid polymer in high conductivity wet end system, productivity aid on acid kraft liner paper machines.

Additionally, as disclosed in the examples field testing results have demonstrated that the inventive amphoteric emulsion system provides for much more effective dewatering at a higher rate than comparable polymers used in papermaking and further provides for enhanced colloidal particle retention in acid kraft liner grades; and also provides for enhanced fines retention, e.g., it provides for about a 30% improvement compared to a conventional cationic retention polymer when used under high conductivity conditions and when used in treating unbleached high yield hardwood pulps (which typically are difficult for any cationic polymers to achieve a rational fines/colloidal particle retention).

As is further shown, the inventive emulsion polymer comprises at least the following advantages compared to the dry amphoteric polymer (Polymer A):
1) the inventive emulsion polymer does not require an expensive make down process;
2) the inventive emulsion polymer possesses very good hard water acceptance which should facilitate its usage in geographic areas with hard water supplies; and
3) the inventive emulsion polymer achieves equal or better sticky control, colloidal particle fixation and retention performance than the dry amphoteric polymer (Polymer A) and other comparator polymers under the same conditions.

Based on these intrinsic advantages, the inventive emulsion polymer is well suited for use as sticky control agents, and as a retention/drainage aid e.g., in high conductivity wet end systems.

Also, they are well suited for use as a productivity aid on acid kraft liner paper machines, because e.g., they show superior ability to retain hydrophobic agglomerates which comprise a known source of sheet deposits.

Further, the inventive amphoteric emulsion polymers will function as superior broke additives as these emulsion polymers provide for improved retention of fiber, fines, colloidal, hydrophobic and particulate materials, and moreover provide for improved wet pressability, improved drainage and filtrate turbidity.

Yet further given the beneficial properties of the inventive emulsion polymers they will possess application in processes other than papermaking, e.g., they may be used retention/drainage cationic booster for colloidal silica retention and drainage programs and as flocculants in water quantity and quality management (WQQM) applications.

While the inventive amphoteric emulsion polymers, compositions containing, methods for making and methods of use thereof have been described in terms of preferred embodiments, it will be apparent to those of skill in the art that variations and substitutions may be applied to the compositions and/or methods and in the steps or in the sequence of steps of the methods described herein without departing from the concept, spirit and scope of the disclosure.

### Method for Improving Vacuum and Press Dewatering

Dewatering is an important aspect in manufacture of paper, board, or the like. In manufacture of fibrous webs, such as paper and board, the dewatering of a fibre web begins immediately after its formation on a wire in a forming section. The initial dewatering, i.e., drainage, occurs by centrifugal forces in roll forming, by gravitation or by pressure pulses generated by foils on other side of the wire. Dewatering on the forming section continues as vacuum dewatering with one or more vacuum boxes, such as flat suction boxes, which remove water from the formed web by suction. The vacuum boxes are located one after another in a machine direction, and the vacuum, i.e., pressure drop, created by the vacuum boxes increases in the machine direction, as the water removal becomes more difficult as the dryness of the web increases. After the forming section, the fibre web is subjected to press dewatering by mechanical pressing of the wet web in a press section. Press dewatering, i.e. wet pressing, may be performed by using a shoe press or pairs of cylinders. In general, shoe press allows more water removal due to the longer time in the nip. A wet pressing arrangement may comprise only two shoe presses, the fibre web being supported by a felt or a belt in the shoe nip. In one conventional wet pressing arrangement, the fibre web enters the first nip between two felts. The second and third nips may be between arranged between three stacked rolls. The arrangement may even comprise a separate fourth press with roll nip or shoe nip. Press dewatering has also an impact on the quality of the final fibre web, as it increases the density of the web and affects its surface structure. After the press section the water content of the fibre web may be around 30-60 weight-%. The fibre web is dried to the final dryness of about 93-95 weight-% in a drying section using e.g., heated cylinders, perforated vacuum rolls or impingement dryers.

Typically, one of the limiting steps in achieving faster production speeds in the paper or board manufacture is the dewatering efficiency of the fibre web. Dewatering efficiency, i.e., dewatering rate, of the fibre web may be improved by adding different chemicals, either alone or as various combinations, to the fibre suspension as dewatering or drainage aids before the web formation. Many dewatering aids can create flocculation of the fibre suspension, which improves initial dewatering in the beginning of the forming section. However, flocculation does not necessarily lead to good vacuum dewatering or press dewatering. Too big floc size may cause unevenness or formation issues, even pinholes, slow down the vacuum dewatering on the forming section and even lead higher water content of the web exiting the forming section.

The dewatering chemicals should thus provide an appropriate flocculation to assist not only the initial dewatering without destroying the web formation, but also provide suitable micro-flocculation to increase the dewatering at the vacuum dewatering, as well as provide a fibre charge neutralisation for effective press dewatering. The dewatering chemicals should also be able to resists the high shear forces of the dilution head-box and gap-former. An additional challenge nowadays in the use of dewatering chemicals is the high conductivity of the fibre suspensions, caused by increasing water loop closures of paper and board machines. The high conductivity of the water phase of the fibre suspension may disturb the interactions between the dewatering chemicals and the fibres that is traditionally based on opposite charges.

It is an object of the present invention to reduce or even eliminate the above-mentioned problems appearing in prior art.

It is an object of the present invention to provide a method for especially improving vacuum dewatering and press dewatering in manufacture of paper, board or the like. Simultaneously, the method improves short span compression test (SCT) strength of the final paper, board or the like.

To achieve the objects presented above, the invention is characterized by what is presented in the characterizing parts of the enclosed independent claims. Some preferable embodiments of the invention will be described in the dependent claims. The embodiments and advantages mentioned in this text relate, where applicable, both to the method and to the uses according to the invention, even though it is not always specifically mentioned.

A typical method according to the present invention for improving vacuum and press dewatering in manufacturing of paper, board or the like, comprises:
providing an aqueous fibre suspension, which comprises recycled fibre material, and
delivering the aqueous fibre suspension to a last shear stage and further to a headbox, draining the aqueous fibre suspension on a wire to form a wet fibrous web and further dewatering the wet fibrous web by using vacuum and wet pressing and drying,
wherein a cationic crosslinked polymer or an amphoteric polymer is added to the fibre suspension having consistency of <20 g/l before and/or after the last shear stage prior to delivering the fibre suspension to a headbox of a paper or board machine, which cationic crosslinked polymer or amphoteric polymer is a copolymer obtained by polymerising at least acrylamide or (meth)acrylamide and over 11 mol-%, over 18 mol-%, or up to 38 mol-% of cationic monomers, and the polymer having a standard viscosity of 1.5-4.5 mPas.

A typical use according to the invention of the method of the invention is for manufacturing of kraft paper, liner board, test liner, fluting, sack paper, white lined chipboard, core board, folding boxboard or gypsum board liner.

Now it has been surprisingly found that when a cationic crosslinked copolymer or an amphoteric copolymer of acrylamide or (meth)acrylamide and over 18 mol-% of cationic monomers, having a standard viscosity of 1.5-4.5 mPas, is added to the fibre suspension before and/or after the last shear stage preceding the headbox, an unexpected improvement in vacuum dewatering and/or press dewatering is observed. Without wishing to be bound by a theory, it is assumed that the copolymer has a three-dimensional structure that limits the flocculation effect to a desired level, and enables optimal dewatering, while the cationicity of the copolymer provides effective interaction with the fibres, even in fibre suspensions with high conductivity. For example, it has been observed that the method according to the present invention may provide a dewatering improvement by 20%, compared to fibre suspension, where no crosslinked polymer or amphoteric copolymer is added, and/or improvement in production speed by 5-10%, compared to process where no crosslinked polymer or amphoteric copolymer is added. At the same time, the method using the cationic crosslinked polymer or the amphoteric polymer is able to provide the desired strength properties, especially SCT strength to the final paper, board or the like, where an improvement up to 20%, compared to paper or board manufactured without addition of crosslinked polymer or amphoteric copolymer, may be observed. Even an improvement in yield can be achieved, as the cationic crosslinked polymer or the amphoteric polymer may be able to interact with low molecular weight starch, present in fibre suspension comprising recycled fibre material, such as recycled fibres and/or repulped broke.

It is assumed that the cationic crosslinked polymer has an advantageous three-dimensional structure, caused by the crosslinks between the polymer chains of sufficient length. The molecular weight of the polymer, as indicated by its standard viscosity, gives a measure for the length of polymer chains. The amphoteric polymer is able to provide similar three-dimensional structure due to the interaction between the cationic and anionic groups present in its structure. It is speculated that the three-dimensional structure and the size of the crosslinked polymer and the amphoteric polymer, together with the cationicity, achieves flocculation which is highly advantageous for vacuum dewatering and/or press dewatering in the fibre suspension comprising recycled fibre material. The cationic crosslinked polymer and the amphoteric polymer according to the present invention are able to provide moderate floc size, thereby achieving an improved vacuum dewatering and/or press dewatering. The method according to the present invention providing a controlled floc size can improve the solids content after pressing.

In the present context, the term “dewatering” denotes removal of water from a wet fibrous web by using vacuum, i.e. suction, such as vacuum boxes, or by wet pressing with mechanical dewatering means, such as felted nip press between two rolls, centre roll press, shoe press or any series of these. Dewatering also encompasses any combinations, where water is removed from the wet web by using both suction and pressing. The cationic crosslinked polymer or the amphoteric polymer improve the dewatering, i.e. the removal of water by using suction and/or by pressing from the wet fibrous web, when added to the fibre suspension. Dewatering differs from drainage, which occurs immediately at the beginning of the forming section. In drainage the removal of water from a wet fibrous web occurs by gravitation, centrifugal forces in roll forming or mild pressure pulses achieved by foils. Fibre suspension having good drainage properties does not necessarily perform well during vacuum dewatering and wet pressing. In the present text, the terms “press dewatering” and “wet pressing” are used synonymously, and they are fully interchangeable. Wet pressing enhances also strength properties as it brings fibre surfaces so close to each other that the hydrogen bonds can form between the fibres, fibrils and fines.

In the present invention the fibre suspension is treated either with the high cationic crosslinked polymer or the amphoteric polymer having a high cationicity. The cationic crosslinked polymer or the amphoteric polymer is added to the fibre suspension before the last shearing stage before the headbox. The polymer is able to interact with the fibres and form flocs before the last shear stage, where the formed flocs are at least partially broken, and the floc size is reduced. The structure and the cationicity of the crosslinked polymer and the amphoteric polymer make it possible to obtain optimal initial floc size and floc strength, leading advantageous floc size after the last shear stage. The structure or amphoteric character of the polymers, optionally with the use of microparticles, will help in reflocculation after the last shear stage. This is especially relevant in forming processes with high shear, such as for gap formers or hybrid formers, or for forming sections with dilution headboxes.

The cationic crosslinked polymer or the amphoteric polymer may be a copolymer obtained by polymerisation of acrylamide or (meth)acrylamide and at least or over 20 mol-% of cationic monomers, preferably at least or over 25 mol-% of cationic monomers, more preferably at least or over 30 mol-% or at least or over 35 mol-% of cationic monomers. For example, the cationic crosslinked polymer or the amphoteric polymer may be obtained by polymerisation of acrylamide or (meth)acrylamide and 18-50 mol %, preferably 20-50 mol-%, more preferably 25-45 mol-% or 30-40 mol-%, of cationic monomer. According to one embodiment of the invention the cationic crosslinked polymer or amphoteric polymer may be obtained by polymerisation of acrylamide or acrylamide or (meth)acrylamide and 18-80 mol %, preferably 26-80 mol-%, more preferably 30-49 mol-% or 31-41 mol-%, of cationic monomers.

The cationic monomer used for polymerisation of the cationic crosslinked polymer or the amphoteric polymer may be selected from 2-(dimethylamino)ethyl acrylate (ADAM), [2-(acryloyloxy)ethyl]trimethylammonium chloride (ADAM-CI), 2-(dimethylamino)ethylacrylate benzyl-chloride, 2-(dimethylamino)ethyl acrylate dimethylsulphate, 2-dimethylaminoethyl methacrylate (MADAM), [2-(methacryloyloxy)ethyl]trimethylammonium chloride (MADAM-CI), 2-dimethylamino-ethyl methacrylate dimethylsulphate, [3-(acryloylamino) propyl]trimethylammonium chloride (APTAC), [3-(methacryloylamino) propyl]trimethylammonium chloride (MAPTAC), diallyldimethyl-ammonium chloride (DADMAC) and any mixtures thereof. Preferably the cationic monomer may be selected from [2-(acryloyloxy)ethyl]trimethylammonium chloride (ADAM-CI), [3-(acryloylamino) propyl]trimethylammonium chloride (APTAC), and [3-(methacryloylamino) propyl]trimethylammonium chloride (MAPTAC). More preferably the cationic monomer may be [2-(acryloyloxy)ethyl]trimethylammonium chloride (ADAM-CI).

The cationic crosslinked polymer or the amphoteric polymer has a cationic net charge in a range of 2.5-5 meq/g, preferably 3.1-4.5 meq/g, at pH 2.7, measured by Mütek PCD. This means that the net charge of the amphoteric polymer is cationic, i.e. positive, even if the amphoteric polymer comprises anionic groups.

According to one embodiment of the invention the amphoteric polymer may be a copolymer obtained by polymerising acrylamide or (meth)acrylamide, cationic monomers (type and amount as defined above) and anionic monomers. Preferably, the amphoteric polymer may comprise 0.5-5 mol-%, preferably 1-4 mol-%, more preferably 1.2-3 mol-%, of anionic monomers. The anionic monomers may be selected from unsaturated mono- or dicarboxylic acids, such as acrylic acid, maleic acid, fumaric acid, itaconic acid, aconitic acid, mesaconic acid, citraconic acid, crotonic acid, isocrotonic acid, angelic acid or tiglic acid. Preferably the anionic groups originate from acrylic acid.

According to one embodiment of the invention, the amphoteric polymer may comprise anionically charged groups and cationically charged groups in a ratio from 1:20 to 1:5 (anionic:cationic).

The cationic crosslinked polymer or the amphoteric polymer has the standard viscosity in a range of 1.5-4.5 mPas, measured as defined below. According to one preferable embodiment the standard viscosity may be in a range of 2.0-4.0 mPas, more preferably 2.5-3.5 mPas. Standard viscosity (SV) is measured at 0.1 weight-% polymer content in an aqueous 1 M NaCl solution, using Brookfield LV viscometer equipped with UL adapter, at 25° C., using UL Adapter Spindle and rotational speed 60 rpm.

The cationic crosslinked polymer may be obtained by polymerisation of acrylamide or (meth)acrylamide and cationic monomers in a presence of 0.5-100 ppm, preferably 1.5-30 ppm, more preferably 2-20 ppm, of a crosslinking agent. According to one embodiment of the invention the amphoteric polyacrylamide may also be a crosslinked polymer, obtained by polymerisation of acrylamide or (meth)acrylamide, cationic monomers and anionic monomers in a presence of 0.5-100 ppm of a crosslinking agent. The amount of used crosslinking agent is calculated based on initial monomer content. The crosslinking agent may be selected from compounds containing at least two double bonds, such as methylenebisacrylamide; polyethylene glycol diacrylate; polyethylene glycol dimethacrylate; N-vinyl acrylamide; divinylbenzene; triallylammonium salts; N-methylallylacrylamide; and the like. The crosslinking agent may further be selected from polyfunctional crosslinking agents containing at least one double bond and at least one reactive group, such as glycidyl acrylate; acrolein; methylolacrylamide; and the like. The crosslinking agent may further be selected from polyfunctional crosslinking agents containing at least two reactive groups, for example aldehydes, such as glyoxal, diepoxy compounds and epichlorohydrin and the like. According to one preferable embodiment the crosslinking agent is methylenebisacrylamide.

According to one embodiment the amphoteric polymer may be substantially linear and non-crosslinked. In this case, the amphoteric polymer is polymerised substantially in the absence of branching agent(s) or crosslinking agent(s). According to one embodiment, the amphoteric polymer comprises <0.01 mol-%, preferably <0.005 mol-%, and more preferably <0.001 mol-% of branching agent or crosslinking agent. The substantially linear and non-crosslinked amphoteric polymer is still able to achieve an improved vacuum and/or press dewatering effect, due to the internal interactions of its cationic and anionic groups, which provide the polymer with advantageous three-dimensional structure.

The cationic crosslinked polymer or the amphoteric polymer may be obtained by emulsion polymerisation (oil-in-water), inverse emulsion polymerisation (water-in-oil) or by gel polymerisation.

According to one embodiment, the cationic crosslinked polymer or the amphoteric polymer may be obtained by emulsion polymerisation or by inverse emulsion polymerisation. Preferably the cationic crosslinked or amphoteric polymer is in form of an inverse emulsion, i.e. water-in-oil emulsion. The cationic crosslinked or the amphoteric polymer may be prepared by reverse phase emulsion polymerisation and the obtained reverse phase emulsion of cationic polymer is inverted into an aqueous solution. Emulsion polymerization techniques are widely known to persons skilled in the art. In general, emulsion polymerisation procedures involve a preparation of two phases, namely an aqueous phase and an oil phase. The aqueous phase comprises the monomer(s), possible crosslinking agent(s) and possible chain-transfer agent(s) dissolved in water. The aqueous phase may comprise other additives well known to those skilled in this art, such as stabilizers and pH adjusting agents. The oil phase comprises a water-insoluble hydrocarbon solution of surfactant(s). The aqueous phase and oil phase are then mixed and homogenized in a conventional apparatus until particle size of the discontinuous phase is in the 1.0 micron range and a suitable bulk viscosity is obtained. A polymerisation initiator, such as sodium metabisulfite solution, is added to the emulsion to begin polymerization.

According to other alternative, the cationic crosslinked or the amphoteric polymer may be in form of particles, granules and/or powder. The cationic crosslinked or the amphoteric polymer may be obtained by gel polymerisation. The gel polymerisation is performed by providing a reaction mixture comprising the desired monomers, which are polymerised in presence of initiator(s) by using free radical polymerisation. The temperature in the beginning of the polymerisation may be less than 40° C., sometimes less than 30° C. Sometimes the temperature in the beginning of the polymerisation may be even less than 5° C. The free radical polymerisation of the reaction mixture produces a polymer, which is in gel form or highly viscous liquid. After the gel polymerisation, the obtained polymer in gel form is comminuted, such as shredded or chopped, as well as dried, whereby a particulate polymer product is obtained. Depending on the used reaction apparatus, shredding or chopping may be performed in the same reaction apparatus where the polymerisation takes place. For example, polymerisation may be performed in a first zone of a screw mixer, and the shredding of the obtained polymer is performed in a second zone of the said screw mixer. It is also possible that the shredding, chopping or other particle size adjustment is performed in a treatment apparatus, which is separate from the reaction apparatus. After shredding or chopping, the comminuted polymer is dried, milled to a desired particle size and packed for storage and/or transport.

In the present invention the aqueous fibre suspension is subjected at least to one last shear stage before a headbox of a paper or board machine. The fibre suspension has a consistency of <20 g/l, preferably below 15 g/l, i.e., the fibre suspension is in form of a so-called thin stock when the cationic crosslinked polymer or the amphoteric polymer is added to it. Typically, the fibre suspension may have a consistency in a range of 5-19 g/l, preferably 5-15 g/l at the time of addition of the cationic crosslinked polymer or the amphoteric polymer.

The method may comprise several consecutive shear stages, such as pumping, mixing or screening, before the headbox. The cationic crosslinked polymer or the amphoteric polymer is added to the fibre suspension before the last shear stage preceding the headbox. The closer the headbox the cationic crosslinked polymer or the amphoteric polymer is added, the better the flocculation effect achieved. After the last shear stage, the fibre suspension is delivered to the headbox of the paper or board machine. From the headbox the fibre suspension is supplied onto a wire, where the aqueous fibre suspension is subjected to draining and vacuum dewatering under formation of a wet fibrous web. From the wire of the forming section the wet fibrous wet is transferred to press dewatering in the press section and then further to the drying section.

According to one embodiment the cationic crosslinked polymer or the amphoteric polymer may be added to the fibre suspension having consistency of <20 g/l both before and after the last shear stage, or after the last shear stage, preceding the headbox of the paper or board machine.

The cationic crosslinked polymer or the amphoteric polymer may be added to the fibre suspension in an amount of 50-1000 g/t, preferably 150-800 g/t, given as active polymer per ton dry fibre suspension. According to one preferable embodiment of the invention the cationic crosslinked polymer or the amphoteric polymer is added in an amount providing a reduction of 10-300 meq/g, measured with Mutek PCD 03, in a cationic demand of the fibre suspension, calculated from the cationic demand of the fibre suspension before and after the addition of the cationic crosslinked polymer or amphoteric polymer. This reduction in cationic demand enables optimal combination of the polymer properties and the dosage with which it is possible to achieve charge neutralization beneficial for press dewatering. The cationic demand for the fibre suspension is determined by filtering 50 ml of fibre suspension with black ribbon filter paper funnel. 10 ml of the filtrate is used for measurement with Mütek PCD 03, at room temperature (about 25° C.).

According to one embodiment of the invention the method may further comprise an addition of inorganic microparticles after the last shear stage prior to delivering the fibre suspension to the headbox of the paper or board machine. The microparticles are preferably selected from inorganic siliceous microparticles, such as colloidal silica or bentonite. The inorganic siliceous microparticles may be selected from silica-based particles, silica microgels, colloidal silica, silica sols, silica gels, polysilicates, aluminosilicates, polyaluminosilicates, borosilicates, polyborosilicates, zeolites and swellable clays, such as bentonite. Preferably, inorganic siliceous microparticles are selected from colloidal silica or bentonite. The addition of microparticles after the last shear stage provides at least partial reflocculation and improves the size of flocs and/or microflocs for the following dewatering stages, especially for the vacuum dewatering and press dewatering.

The method of the present invention does not require any addition of a high-charged coagulant after the cationic crosslinked polymer or the amphoteric polymer. Preferably the method is free of use or addition of high-charged cationic coagulant, having a charge density e.g., over 5 meq/g, such aluminium based coagulants, organic polymers, and mixtures thereof. The absence of high-charged coagulant addition makes it easier to avoid overcationization of the fibre suspension and the associated problems, such as excess foaming of the fibre suspension.

In some embodiments it is possible to add polyaluminium chloride to the fibre suspension after the addition of the cationic crosslinked polymer or the amphoteric polymer. Use of polyaluminium chloride is especially advantageous for fibre suspensions which contain high amount of anionic trash.

According to one embodiment the method further comprises an addition of cationic polyacrylamide for retention and initial drainage. The cationic polyacrylamide is preferably a linear polymer, having cationicity of 5-15 mol-% and standard viscosity SV in a range of 3-6 mPas, measured as describe above.

The present invention is intended for manufacturing of paper, board or the like from an aqueous fibre suspension, which comprises recycled fibre material. The recycled fibre material may originate from recycled paper and/or old corrugated containerboard (OCC). The fibre suspension may comprise >20 weight-%, preferably >50 weight-%, more preferably >70 weight-%, even more preferably >80 weight-% of recycled fibre material, calculated from the total dry fibre weight of the suspension. The fibre suspension may even comprise 100 weight-% of recycled fibre material.

According to one preferable embodiment, the amount of recycled fibre material in the fibre suspension is 50-100 weight-%, preferably 80-100 weight-%, more preferably 90-100 weight-%.

The aqueous fibre suspension may have a conductivity of at least 2 mS/cm, preferably at least 3 mS/cm, more preferably at least 3.5 mS/cm. The conductivity may be in a range of 2-10 mS/cm, preferably 3-9 mS/cm, more preferably 3.5-8 mS/cm. The cationic crosslinked polymer or the amphoteric polymer is able to provide improvement in vacuum dewatering and/or press dewatering even for these fibre suspensions with high conductivity.

The aqueous fibre suspension may even have a starch content of at least 1 weight-%, preferably at least weight-3%, more preferably at least 4 weight-%, based on dry total solids of the suspension. The starch content of the fibre suspension may be 1-20 weight-%, preferably 2-10 weight-% and more preferably 4-8 weight-%. The cationic crosslinked polymer or the amphoteric polymer forms a three-dimensional structure that may capture low molecular starch present in recycled fibre material.

The present method is especially suitable for manufacturing of kraft paper, liner board, test liner, fluting, sack paper, white lined chipboard, core board, folding boxboard or gypsum board liner. The kraft paper, liner board, test liner, fluting, sack paper, white lined chipboard, core board, folding boxboard or gypsum board liner may have a grammage of at least 70 g/m², preferably at least 100 g/m².

Use of Amphoteric Emulsion Polymers with Silica as Retention and Dewatering Aids

The present invention provides a method for manufacture of paper or board, wherein a fiber web is formed from an aqueous suspension of fibers, the method comprising:
(a) providing an aqueous fiber suspension, which comprises recycled fiber material and/or coated broke; (b) optionally diluting the aqueous fiber suspension; (c) delivering the aqueous fiber suspension to a headbox, draining the aqueous fiber suspension on a wire screen to form a wet fibrous web; and (d) further dewatering the wet fibrous web by vacuum dewatering, wet pressing, and/or drying the wet fibrous web to obtain a paper or board; wherein the method further comprises adding to the aqueous fiber suspension a retention and drainage aid comprising (i) a water-soluble amphoteric emulsion terpolymer, and (ii) one or more inorganic colloids; and wherein (i) and (ii) are premixed prior to addition or added simultaneously or sequentially in any order.

In some exemplary embodiments of the method: (a) the aqueous fiber suspension comprises: (i) at least 50 weight-%, preferably at least 60 weight-%, more preferably at least 70 weight-%, or even more preferably at least 80 weight-% or 100 weight-%, of recycled fiber material and/or coated broke, based on dry paper or board; (ii) water and/or hard water comprising calcium ions; (iii) a thick stock comprising recycled fibers or a thin stock comprising recycled fibers; (iv) a consistency of above 30 g/L or below 20 g/L; (v) a pH in the range of 6-10, 6-9, 6-8.5, or 6-7; or (vi) any combination of (i)-(v);
(b) the water-soluble amphoteric emulsion terpolymer: (i) comprises one or more acrylamide (AM) monomers, one or more anionic monomers comprising acrylic acid (AA), and one or more cationic monomers comprising 2-(acryloyloxy)ethyl]trimethylammonium chloride (Q9); (ii) comprises an acrylamide (AM) or monomer content ranging from 85.9-99 mol-%, 86-96 mol-%, or 86-92 mol-%; (iii) comprises an acrylic acid (AA) monomer content of ≤2.1 mol-%, 0.1-2.1 mol-%, or 0.5-2.1 mol-%; (iv) comprises a Q9 monomer content ranging from ≤12 mol-%, 7-12 mol-%, 8-12 mol-%, or 10-12 mol-%; (v) comprises a polymer standard viscosity (SV) of ≤4.5 cPs, ≤3.5 cPs, or preferably 2.5-3.5 cPs; (vi) comprises a molecular weight ranging from 1.5-9 million Da, 5-8 million Da, or 3 to 5 million Da; and/or (vii) optionally further comprises a buffer which maintains a pH in the range of 6-9, 6-8.5, or 6-7 after addition to the aqueous fiber suspension; (viii) is obtained by a method according to any of the foregoing; (ix) is obtained by polymerization of acrylamide (AM), acrylic acid (AA), and acryloyloxy ethyl trimethylammonium chloride (Q9) monomers; (x) is obtained by polymerization in a presence of 0.5-100 ppm, preferably 1.5-30 ppm, more preferably 2-20 ppm, of a crosslinking agent; (xi) is formulated as a dry polymer, a liquid polymer, or an inverse emulsion polymer; or (xii) any combination of (i)-(xi);
(c) the one or more inorganic colloids comprise colloidal silica; siliceous nano and/or microparticles; aluminum phyllosilicate mineral particles, including but not limited to bentonite, sodium bentonite, calcium bentonite, and montmorillonite; or combination of the following;
(d) the water-soluble amphoteric emulsion terpolymer is added to the aqueous fiber suspension at a dosage ranging from 0.1-1 kg/MT, 0.15-0.3 g/MT, or 0.4-0.8 kg/MT, wherein MT is metric ton of total fiber solids;
(e) the one or more inorganic colloids is added to the aqueous fiber suspension at a dosage ranging from 0.1-1 kg/MT, 0.15-0.3 g/MT, or 0.4-0.8 kg/MT, wherein MT is metric ton of total fiber solids;
(f) wherein the retention and drainage aid is added to the aqueous fiber suspension prior to or after dilution of the aqueous fiber suspension;
(g) adding the retention and drainage aid to the aqueous fiber suspension provides: (i) a synergistic improvement in drainage and dewatering of the fibrous web during gravity dewatering, vacuum drainage, and press dewatering; (ii) a synergistic improvement in water removal efficiency; (iii) a synergistic improvement in fixation and on-machine retention of starch, fines, fillers, and colloidal particles from the aqueous fiber suspension; (iv) a synergistic improvement in retention and drainage under alkaline conditions, wherein said water-soluble emulsion terpolymer and inorganic colloid functions as a fixative for improving retention and/or fixation of dyes, hydrophobics, starch and/or fillers, and/or drainage in manufacture of paper and/or board, optionally wherein said aid does not damage sheet formations; or (v) any combination of (i)-(iv); or
(h) any combination of (a)-(g).

The present invention also provides an aqueous composition comprising: (a) an aqueous fiber suspension according to any of the foregoing; and (b) a retention and drainage aid comprising (i) a water-soluble amphoteric emulsion terpolymer, and (ii) one or more inorganic colloids according to any of the foregoing.

The methods and compositions illustratively disclosed herein suitably may be practiced in the absence of any element which is not specifically disclosed herein and/or any element specifically disclosed herein. Exemplary embodiments of the invention and its advantages are further disclosed in the following examples.

### EXAMPLES

Certain embodiments of the invention are described in the following non-limiting examples. The examples provided herein are for illustrative purposes so that the invention may be more fully understood. These examples should not be construed as limiting the invention in any way.

### Example 1: Synthesis of Amphoteric Emulsion Terpolymer

The inventive amphoteric emulsion terpolymer was prepared using proprietary inverse emulsion polymerization technology in usage by Kemira. Particularly, three monomers of acrylamide, Q9 and acrylic acid are charged into the same monomer preparation tank. In order to achieve good hard water acceptance and securely handle the three monomers in the same monomer tank, the monomer phase pH target was reduced to a range of 2.5 and 5.0, or more typically between 2.5 and 4.5 or between 2.5 and 4.0. Additionally, the polymerization rates were intentionally not decreased by lowering the monomer phase pH target.

### Exemplary Synthesis Method for Polymers

The particular steps used in the synthesis method of 800 grams of an exemplary inventive amphoteric emulsion terpolymer, which was used in Examples 1-9, are as follows:

### Preparation of Monomer Phase:

Acrylamide (is added to a tared 1000 ml beaker (containing a magnetic stir bar), and stirring is commenced. Cationic monomer Q9 and citric acid solution are then added to the acrylamide containing beaker and the resultant mixture is blended. Afterward, acrylic acid, NaHypo dry powder, diethylene triamine pentaacetic acid and water are added to the monomer composition in the beaker and mixing is effected for 10 minutes. The pH of the resultant mixture is checked during this step and the pH is adjusted to between 2.5-5.0, more typically between 2.5 and 4.5 or 2.5 and 3.5 using ammonium hydroxide if needed. Also, during all of these steps the temperature of the reactants is continually maintained below 30° C. (optionally by use of an ice bath). During this synthesis procedure the initial pH (before the optional addition of NH₄OH) and final pH (after adjusting if needed with NH₄OH and final water) of the monomer phase are recorded.

### Preparation of Oil Phase:

A petroleum solvent, generally 19-21% range is weighed out and added to a tared 1000 mL steel jug, and stirred using an overhead mixer (at ~450 RPM). An ethoxylated alcohols (C12-C16), generally at 2-3% by weight and a surfactant, optionally SURFONIC® L24-7, is then added to the steel jug and the resultant mixture is permitted to mix for at least 10 minutes.

### Addition of Monomer Phase to the Oil Phase:

The monomer phase solution is then slowly added to the oil phase (over a period of 30 seconds) and permitted to mix for ~20 minutes. The viscosity is detected during or after mixing and the mixture is the homogenized for ~20 seconds. The viscosity is the determined again after homogenizing (and the resultant mixture is the poured into the polymerization reactor and the initial temperature is determined and recorded.

### Sparging:

The contents of the reactor are then sparged with nitrogen for ~1 hour while continuously stirring.

### Polymerization:

The polymerization initiator, optionally tert-butyl hydroperoxide is then added to the mixture after 1 hour of sparging and allowed to mix, and the temperature is monitored as the reaction proceeds. An exotherm is observed (indicated by raise in temperature) signaling polymerization. Control the flow rate of SO₂ such that the raise in temperature is gradual (1° C./minute). To obtain polymer of desired molecular weight, maintain the temperature below 50° C. This can be achieved by using a water bath and simultaneously cutting the SO₂ supply. Completion of polymerization is indicated when no raise in temperature is seen even when SO₂ is continuously being fed. At this point, set the SO₂ flow rate back to the initial value and reactor temperature to 50° C. and hold for ~1.5 hours. Note that nitrogen should be continuously sparged throughout the entire process.

### Post-Polymerization:

After polymerization the polymer mixture is optionally treated in order to eliminate residual acrylamide monomers and is permitted to mix. Afterward the SO₂ and nitrogen streams are turned off and an inverting surfactant, optionally SURFONIC® L-24-7 (seven-mole ethoxylate of linear, primary 12-14 carbon number alcohol) is then added to the subsurface, optionally at a rate of 2.0 wt %, and allowed to mix. The reactor is then allowed to cool to <30° C. before transferring the polymer to an appropriate container).

### Example 2: Comparison of the Charge Effects of the Inventive Amphoteric Emulsion Terpolymer to Other Polymers

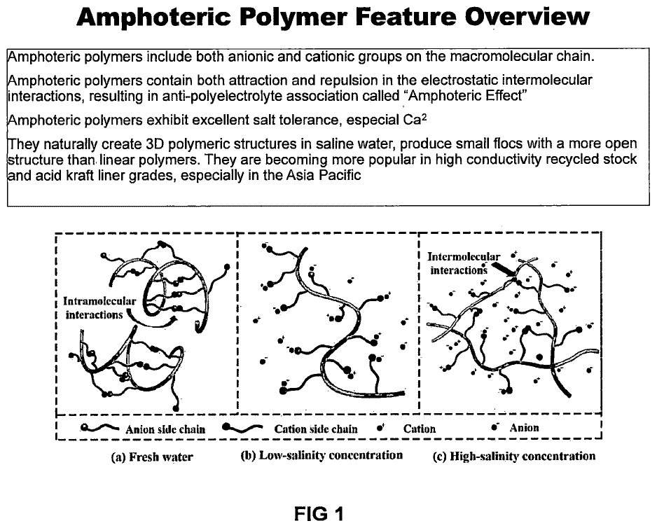

As shown schematically in FIG. 1 both non-emulsion and emulsion amphoteric polymers include both anionic and cationic groups on the macromolecular chain resulting in both attraction and repulsion in the electrostatic intermolecular interactions, thereby producing an anti-polyelectrolyte association commonly referred to as the “Amphoteric Effect”. These polymers exhibit excellent salt tolerance, and are especially tolerant to fluid compositions comprising high Ca+2 concentrations. Also, these polymers naturally create 3D polymeric structures in saline water, and produce small flocs with a more open structure than linear polymers.

More particularly, as shown in FIG. 1, amphoteric emulsion polymers according to the invention comprise acrylic acid monomers which contain carboxyl groups when making down the polymer solution at pH 4 or less and at this pH all of the carboxyl groups of acrylic acid remain protonated. By contrast, as shown in FIG. 1, when the pH of the inventive amphoteric emulsion polymer solution is raised to 8, the carboxyl groups generate anionic acrylate groups which interact with the quaternary ammonium group of Q9 and result in a reduction of the net cationic charge.

### Charge Titration Method:

The amphoteric emulsion polymer (active polymer content of 33%) (prepared as in the previous example) is inverted with DI water to produce a solution comprising 0.5% active polymer, and the solution is then further diluted from a 0.5% solution to 0.1%. After polymer dilution, wait 30 minutes for use in titration. Dilute HCl acid solution (about 0.1N) is used to adjust the 0.1% polymer solution to pH 3.5 before the Mutek titration. A 10.00 gram of the 0.1% polymer solution at pH 3.5 is placed into a Mutek PCD and titrated to a 0 mV endpoint with 0.001N PVSK standard solution. Record PVSK titer in gram for the charge titration at pH 3.5. Dilute NaOH solution (about 0.1-0.5N) is used to adjust the 0.1% polymer solution to pH 8.0, then conduct the same titration with 0.001N PVSK standard solution. Record PVSK titer in gram for the charge titration at pH 8. The charge titration result is expressed as meq/dry gram of polymer.

### Equation to Calculate the Charge Density:

Polymer charge density (meq/dry gram) of the inventive amphoteric emulsion terpolymer and the comparison polymers are determined at different pH levels by the following equation:

Polymer charge density (meq/dry gram)=0.001*PVSK titer amount/(10*diluted polymer solution concentration)

### Results

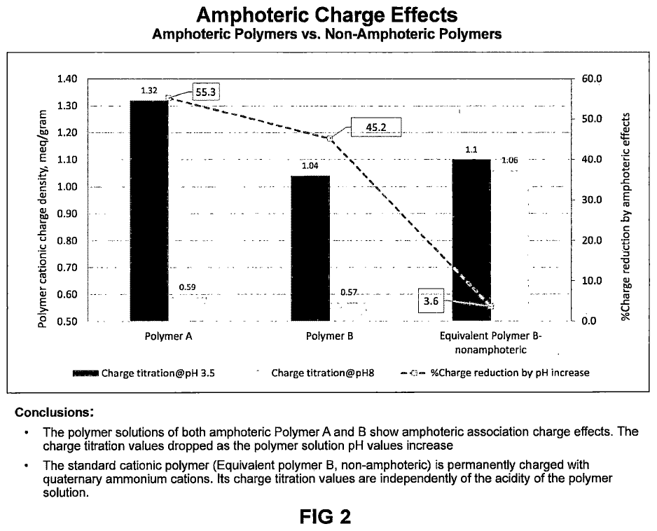

As shown in FIG. 2, polymer solutions comprising either the (dry, non-emulsion) amphoteric FSSSD and the inventive amphoteric emulsion polymer exhibit amphoteric association charge effects. Specifically, it can be seen that the charge titration values for these polymer solutions drop as the polymer solution pH values increase.

By contrast, it can be seen from the polymer charge density values in FIG. 2 for the conventional cationic polymer (equivalent emulsion polymer, non-amphoteric, which is permanently charged with quaternary ammonium cations), that its charge titration values are independent of the acidity of the polymer solution.

### Conclusions

The polymer charge density values in FIG. 2 demonstrate that both amphoteric FS55D and the inventive amphoteric emulsion polymer solutions show amphoteric association charge effects. Particularly, based on the amphoteric association charge effects the charge titration values drop as the polymer solution pH values increase. By contrast the conventional cationic polymer (equivalent emulsion polymer, non-amphoteric) which is permanently charged with quaternary ammonium cations does not show amphoteric association charge effects as its charge titration values are independent of the pH of the polymer solution.

### Example 3: Hard Water Acceptance of Inventive Amphoteric Emulsion Polymer Compared to Other Polymers

In this example experiments were conducted to assess the hard water acceptance of the inventive amphoteric emulsion polymer and other comparator polymers.

As shown in FIG. 2 the pH of amphoteric polymer make-down solutions must be <4.0 or 5.0 to avoid the interaction of anion side chains with cation side chains and reduce or preclude amphoteric association effects. Related thereto, hard water acceptance tests indicate which polymer has greater buffering ability and which polymer make-down solution pH should be less than 4.0. Hard water essentially is water high in dissolved minerals, largely calcium. Water in the range of 200 ppm of hardness and pH 8.5 is conventionally considered to be “hard” water. Accordingly, if the amphoteric polymer has a poor hard water acceptance, the pH value of polymer makedown solution with standard hard water or tap water would be >4.0.

For amphoteric emulsion polymers, the inventive emulsion polymers (active polymer content at 33%) (prepared as in Example 1) are inverted with DI water or standard hard water to 0.5% active polymer, and then further diluted DI water or standard hard water to obtain a 0.5% polymer solution and then further diluted with DI water or standard hard water to obtain a 0.2% polymer solution. After making the 0.2% polymer solution, the pH value of the makedown polymer solutions is measured. By analogous methods a make-down solution comprising 0.2% dry amphoteric polymer (Polymer A) polymer is obtained by the addition of DI water or standard hard water, and the ph value of the makedown polymer solutions is then measured.

### Results

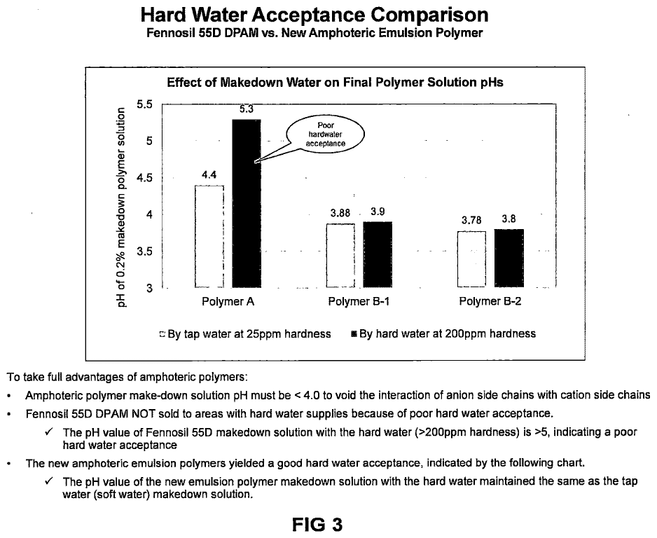

As can be seen from the data in FIG. 3, the pH value of the 0.2% dry amphoteric polymer (Polymer A) makedown solution comprising hard water (>200 ppm hardness) is >5 (~5.3), indicating a poor hard water acceptance. By contrast the pH value of the 0.2% dry amphoteric polymer (Polymer A) makedown solution in non-hard water (tap water comprising 25 ppm hardness is (~4.4). By contrast, when 2 solutions comprising 0.2% of the inventive amphoteric emulsion terpolymer (Polymer B) were tested under the same conditions the pH was substantially the same in both the hard and soft water. Specifically, for the 1st tested solution comprising 0.2% of the inventive amphoteric emulsion terpolymer the pH of the makedown solution was 3.88 in hard water and 3.9 in the soft tap water. Similarly, for the 2nd tested solution comprising 0.2% of the inventive amphoteric emulsion terpolymer the pH of the makedown solution was 3.78 in hard water and 3.8 in the soft tap water.

### Conclusions

The results of the experiments shown in FIG. 3 demonstrate that the inventive amphoteric emulsion polymers exhibit very good hard water acceptance as the pH value of the inventive emulsion polymer makedown solution in hard water was essentially the same as the tap water (soft water) makedown solution.

### Example 4: Southeastern Mill NSSC Medium Grade Case Study

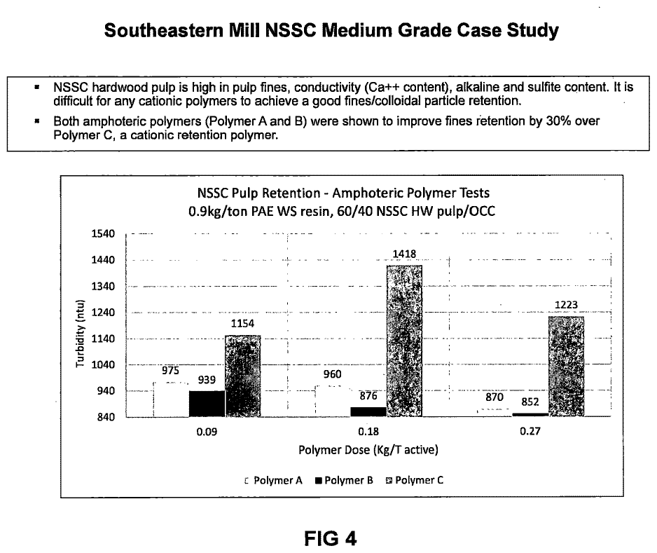

This example relates to experiments for which the data is contained in FIG. 4. These experiments compared particle retention with different polymers using hardwood pulp high in pulp fines, conductivity (Ca++ content), alkaline and sulfite content (Southeastern Mill NSSC hardwood pulp). The effects of the inventive emulsion polymer and other comparator polymers on particle retention were compared in experiments using this pulp as it is generally difficult for any cationic polymers to achieve a good fines/colloidal particle retention on such pulps.

### Experimental Methods

Stock and machine water were obtained from the Southeastern Mill and were diluted to machine's headbox consistency. The pH, conductivity, alkalinity and calcium hardness were measured on the diluted stock.

A dynamic drainage analyzer (DDA) was used to evaluate the polymer effect on drainage. An additive timing sequence was used to mimic the timing of additives on the machine. Polymers were a prepared according to standard makedown procedures.

For each measurement, an aliquot of stock was poured into the DDA stirring jar where additives were dosed in accordance with machine conditions. After mixing, the stock is drained through a paper machine wire and the filtrate is collected in a vessel. The drain time is recorded and used as a measure of drainage performance.

The filtrate is then measured for turbidity using a Hach 2100Q turbidimeter. Lower turbidity values indicate better retention of fiber, fines, and colloidal and particulate materials.

### Results

FIG. 4 contains the results of these experiments. The results in FIG. 4 demonstrate that both of the tested amphoteric polymers (Polymer A and the inventive amphoteric emulsion polymer (Polymer B)) substantially improved fines retention, i.e., it was increased by 30% in relation to Polymer C, a conventional cationic retention polymer.

### Conclusions

Whereas it is generally difficult for any cationic polymer to achieve a good fines/colloidal particle retention on pulps such as the Southeastern Mill NSSC hardwood pulp which are high in pulp fines, conductivity (Ca++ content), and alkaline and sulfite content, the inventive amphoteric emulsion polymer provides for substantially improved fines retention, i.e., by 30% in relation to Polymer C, a conventional cationic retention polymer.

### Example 5: Drainage and Filtrate Turbidity Effects of Inventive Amphoteric Emulsion Polymer and Other Polymers Using Pulp Having pH of Low to Mid 5, and High Conductivity Levels

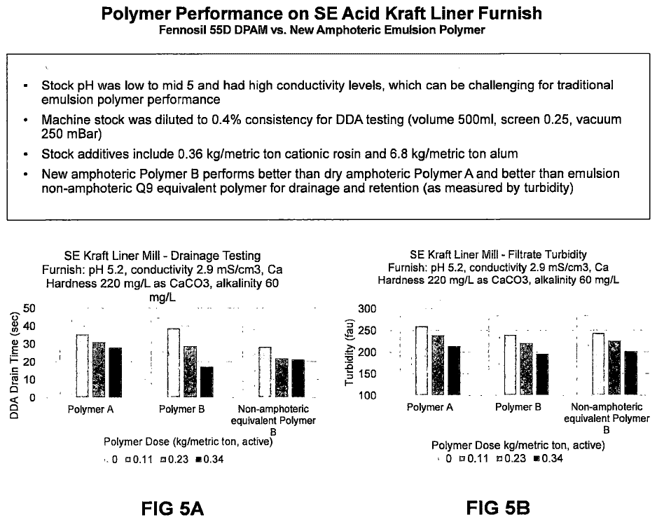

This example relates to experiments for which the data is contained in FIGS. 5A and 5B. The Figure contains experimental results comparing the drainage effects and filtrate turbidity effects of different polymers, i.e., the amphoteric emulsion polymer to that of amphoteric dry polymer (Polymer A), and a conventional non-amphoteric cationic polymer (Polymer C) using a stock pH of low to mid 5, and having high conductivity levels.

### Experimental Methods

Stock and machine water were obtained from the mill and were diluted to machine's headbox consistency. The pH, conductivity, alkalinity and calcium hardness were measured on the diluted stock.

A dynamic drainage analyzer (DDA) was used to evaluate the polymer effect on drainage. An additive timing sequence was used to mimic the timing of additives on the machine. Polymers were a prepared according to standard makedown procedures.

For each measurement, an aliquot of stock was poured into the DDA stirring jar where additives were dosed in accordance with machine conditions. After mixing, the stock is drained through a paper machine wire and the filtrate is collected in a vessel. The drain time is recorded and used as a measure of drainage performance.

The filtrate is then measured for turbidity using a Hach 2100Q turbidimeter. Lower turbidity values indicate better retention of fiber, fines, and colloidal and particulate materials.

### Results

FIGS. 5A and 5B contain the results of experiments conducted as described above which compared the drainage effects and filtrate turbidity effects of the inventive amphoteric emulsion polymer to other polymers, i.e., amphoteric dry polymer (Polymer A), and a conventional non-amphoteric cationic polymer (Polymer C). These experiments were conducted using a stock having a pH of low to mid 5, and high conductivity levels which is typically challenging when using available conventional emulsion polymers. More particularly, the furnish composition (SE Acid Kraft Liner furnish) used in these experiments comprised a pH of 5.2, a conductivity of 2.9 mS/cm3, a Ca+ hardness of 220 mg/L and an alkalinity of 60 mg/L.

As noted above, in these In the experiments the machine stock was diluted to 0.4% consistency for DDA testing (volume 500 ml, screen 0.25, vacuum 250 mBar). The additives added to the stock comprised 0.36 kg/metric ton of cationic rosin and 6.8 kg/metric ton alum. The data for the different polymers from these experiments are in FIGS. 5A and B. The data in Figure SA indicates that the inventive amphoteric emulsion polymer performs better in the drainage tests than both the dry amphoteric (polymer (Polymer A)) and a conventional non-amphoteric Q9 emulsion polymer (Polymer C) at the same tested doses of active polymer (tested doses 0 (no active polymer), 0.11, 0.23 and 0.34 kg polymer/metric ton). Also, the data in FIG. 5B indicates that the inventive amphoteric emulsion polymer (Polymer B) performs better in fines retention (FIG. 5B) (as measured by turbidity) at the same tested doses of active polymer (tested doses 0 (no active polymer), 0.11, 0.23 and 0.34 kg polymer/metric ton).

### Conclusions

The results of the experiments of FIGS. 5A and 5B indicate that the inventive amphoteric emulsion polymer provides superior drainage effects and filtrate turbidity effects under unfavorable pulp conditions, i.e., a stock pH comprising low to mid 5, and having high conductivity levels. Based thereon the inventive amphoteric emulsion polymer should be well suited for use as a drainage/retention aid under unfavorable pulp conditions, e.g., those comprising pH levels high conductivity levels and/or high amounts of recycled or unbleached fibers.

### Example 6: Drainage and Filtrate Turbidity Effects of Inventive Amphoteric Emulsion Polymer and Other Polymers Using Pulp Having pH of Mid-6 Range, and High Conductivity Levels

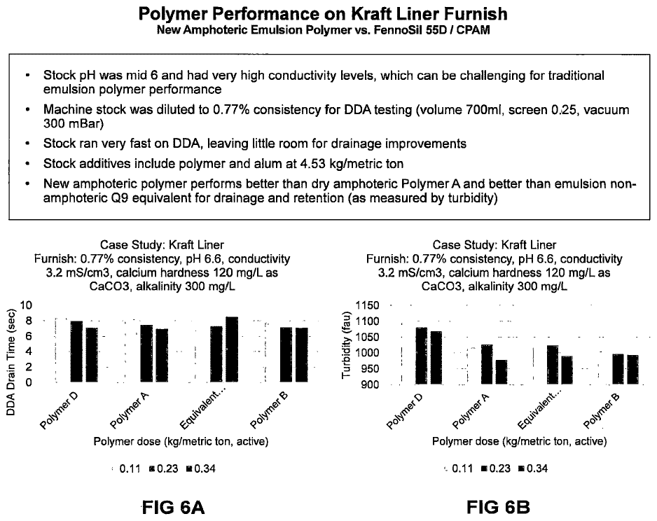

This example relates to experiments for which the data is contained in FIGS. 6A and 6B. As with the previous example the experiments in FIGS. 6A and 6B compared the drainage effects and filtrate turbidity effects of the inventive amphoteric emulsion polymer to that of other polymers, i.e., amphoteric dry polymer (Polymer A), and a conventional non-amphoteric cationic polymer (Polymer C). Unlike the experiments of the previous example a different stock furnish was used i.e., one comprising a pH in the mid-6 range also having high conductivity levels. Particularly, the furnish use in the experiments comprised a 0.77% consistency, a pH of 6.6, a conductivity of 3.2 mS/cm3, a calcium hardness of 120 mg/L and an alkalinity of 300 mg/L.

As with the stock used in the previous example, stocks possessing the pH and conductivity properties of the stock used in these experiments are typically challenging when using traditional emulsion polymers.

### Experimental Methods

The same experimental methods were used as in the previous example except that the stock comprised a 0.77% consistency, a pH of 6.6, a conductivity of 3.2 mS/cm3, a calcium hardness of 120 mg/L and an alkalinity of 300 mg/L, i.e., particularly the machine stock was diluted to 0.77% consistency for DDA testing (volume 700 ml, screen 0.25, vacuum 300 mBar), and the additives added to the stock comprised the same polymers (at doses of 0.11, 0.23 and 0.34 kg polymer/metric ton) and alum at 4.53 kg/metric ton.

In these experiments the stock ran very fast on DDA, leaving little room for improvements in drainage.

### Results

As shown in FIGS. 6A and 6B these experiments similarly showed that the inventive amphoteric emulsion polymer performs better than the dry amphoteric polymer (Polymer A) and also better than the conventional emulsion non-amphoteric Q9 equivalent (Polymer C) in both drainage and retention (as measured by turbidity) properties.

### Conclusions

The results of the experiments of FIGS. 6A and 6B further demonstrate that the inventive amphoteric emulsion polymer provides superior drainage effects and filtrate turbidity effects under unfavorable pulp conditions, i.e., a stock pH comprising low to mid 5, and having high conductivity levels. Based thereon the inventive amphoteric emulsion polymer should be well suited for use as a drainage/retention aid under unfavorable pulp conditions, e.g., those comprising pH levels high conductivity levels and/or high amounts of recycled or unbleached fibers.

### Example 7: Comparison of the Colloidal Retention Ability of the Inventive Amphoteric Emulsion Polymer to Other Polymers

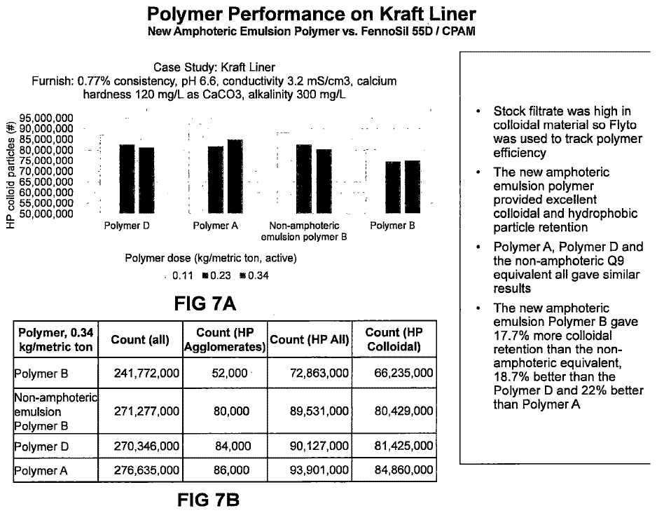

This example relates to experiments for which the data is contained in FIGS. 7A and 7B. These experiments compared the effects of the inventive amphoteric emulsion polymer to that of other polymers, i.e., amphoteric dry polymer (Polymer A), a conventional drainage polymer (CPAM or Polymer D)) and another conventional drainage polymer, i.e., non-amphoteric cationic Q9 polymer (Polymer C) on colloidal retention using a stock high in colloidal materials. As described below in the experimental methods because the stock was high in colloidal materials Flyto was used to compare the efficiencies of the different polymers.

### Experimental Methods

Stock and machine water were obtained from the mill and were diluted to machine's headbox consistency. The pH, conductivity, alkalinity and calcium hardness were measured on the diluted stock.

A dynamic drainage analyzer (DDA) was used to evaluate the polymer effect on drainage. An additive timing sequence was used to mimic the timing of additives on the machine. Polymers were a prepared according to standard makedown procedures.

For each measurement, an aliquot of stock was poured into the DDA stirring jar where additives were dosed in accordance with machine conditions. After mixing, the stock is drained through a paper machine wire and the filtrate is collected in a vessel. The drain time is recorded and used as a measure of drainage performance.

Filtrate was collected from the mixing stock using a screened tube assembly that filters out long fiber. This filtrate was then filtered through a 150 micron filter and then analyzed for particle count and size using Kemira's Flyto technique. Flow cytometry is used to identify particle types (hydrophobic, colloidal, fines), population counts and mean particle size. This data is used to assess the polymer's efficiency for colloidal retention.

### Results

As shown in FIG. 7A and the data summarized in the Table in FIG. 7B, the experiments revealed that the inventive emulsion polymer when tested at the same polymer doses as in the 2 previous examples provided excellent colloidal and hydrophobic particle retention in relation to Polymer A, (CPAM or Polymer D) and the non-amphoteric Q9 equivalent (Polymer C) which all gave similar results. In particular, the inventive amphoteric emulsion polymer gave 17.7% more colloidal retention than the non-amphoteric equivalent, 18.7% better than Polymer D and 22% better than the Polymer A.

### Conclusions

The results of the experiments in FIG. 7A and summarized in the Table in FIG. 7B, convincingly demonstrate that the inventive emulsion polymer yields substantially better colloidal and hydrophobic particle retention in relation to conventional polymers used as drainage aids. These results further indicate that the inventive amphoteric emulsion polymer should be well suited for use as a drainage/retention aid under unfavorable pulp conditions, e.g., pulps comprising pH levels, high conductivity levels, high amounts of recycled or unbleached fibers and/or high amounts of colloidal materials and/or hydrophobic particles.

### Example 8: Comparison of the Effects of the Inventive Amphoteric Emulsion Polymer to Other Polymers on Wet Pressability Using DDA Detection

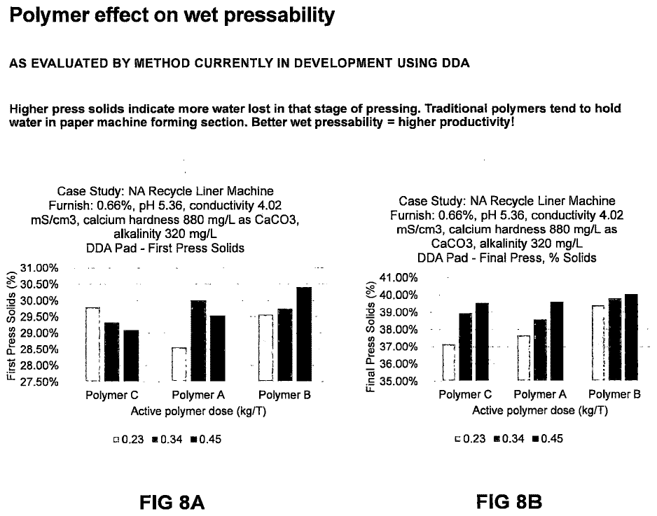

This example relates to experiments for which the data is contained in FIG. 8A and FIG. 8B. In these experiments the effects of the inventive amphoteric emulsion polymer and other polymers on wet pressability using DDA detection was compared.

### Experimental Methods

Stock and machine water were obtained from the mill and were diluted to machine's headbox consistency. The pH, conductivity, alkalinity and calcium hardness were measured on the diluted stock.

A dynamic drainage analyzer (DDA) was used to evaluate the polymer effect on drainage. An additive timing sequence was used to mimic the timing of additives on the machine. Polymers were a prepared according to standard makedown procedures. A modification to the DDA test procedure was made to allow for removal of the DDA fiber pad after controlled vacuum conditions.

For each measurement, an aliquot of stock was poured into the DDA stirring jar where additives were dosed in accordance with machine conditions. After mixing, the stock is drained through a paper machine wire and the filtrate is collected in a vessel. The drain time is recorded and used as a measure of drainage performance.

The filtrate is then measured for turbidity using a Hach 2100Q turbidimeter. Lower turbidity values indicate better retention of fiber, fines, and colloidal and particulate materials.

The DDA fiber pad was collected from the top of the wire and the wet pad weight was recorded. This is an indication of free water drainage. The pad was then subjected to pressing conditions using a Mattis SP size press with variable speed and nip pressure. This allowed for a closer approximation of the pressing conditions found on the paper machine. Pad weight was recorded after one pass in the press and then a second pass. The fiber pad is then dried and the dry weight is used to calculate the press solids at three locations: 1) forming section (DDA pad); 2) 1st press; 3) 2nd press. Wet pressability performance can be gauged by increasing press solids content with increasing polymer dose.

### Results

FIGS. 8A and 8B contain the results of 2 case studies using the above-described experimental methods which compared the effects of different polymers (Polymer D, Polymer A, a non-amphoteric cationic polymer (non-amphoteric Q9 polymer) (Polymer C) and the inventive amphoteric emulsion polymer (Polymer B)) on wet pressability using DDA. As noted previously, higher press solids indicate more water is lost in the tested stage of pressing; therefore, conventional polymers used in papermaking tend to hold water in the paper machine forming section as better wet pressability provides for higher productivity.

The case study in A used NA Recycle Liner Machine, a furnish of 0.66%, pH 5.36, conductivity of 4.02 mS/cm3, a Ca hardness of 880 mg/L (as CaCO3) and an alkalinity of 320 mg/L), wherein the DDA Pad detected % solids after the First Press. The case study in B again used NA Recycle Liner Machine, a furnish of 0.66%, pH 5.36, conductivity of 4.02 mS/cm3, a Ca hardness of 880 mg/L (as CaCO3) and an alkalinity of 320 mg/L), and the DDA Pad detected % solids after the Final Press. In both case studies the amounts of polymer which was added comprised 0.23 kg/metric ton, 0.34 kg/metric ton, and 0.45 kg/metric ton.

### Conclusions

The results in FIGS. 8A and 8B clearly show that the inventive amphoteric emulsion polymer yielded comparable or better water retention properties than conventional papermaking polymers (Polymer C and Polymer A) as evidenced by the detected solids percentages at different polymer doses after the first and the final press. As shown in the Figure in both Case study A (initial press) and Case study B (final press) there was a definite dose effect, i.e., the higher tested polymer doses of the inventive amphoteric emulsion polymer provided for greater % of detected solids.

### Example 9: Comparison of Inventive Emulsion Terpolymer to Other Polymers as Broke Fixative in Recycled Furnish

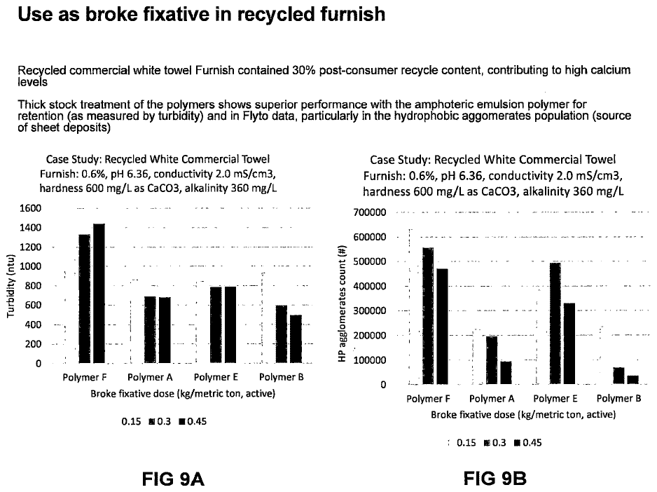

This example discloses experiments comparing the inventive emulsion terpolymer to other conventional polymers when used as a broke fixative in treating recycled furnish for which the experimental results are contained in FIG. 9A and FIG. 9B.

In these experiments stock and machine water were obtained from the mill and were diluted to machine's headbox consistency. The pH, conductivity, alkalinity and calcium hardness were measured on the diluted stock.

A dynamic drainage analyzer (DDA) was used to evaluate the polymer effect on drainage. An additive timing sequence was used to mimic the timing of additives on the machine. Polymers were a prepared according to standard makedown procedures.

For each measurement, an aliquot of stock was poured into the DDA stirring jar where additives were dosed in accordance with machine conditions. After mixing, the stock is drained through a paper machine wire and the filtrate is collected in a vessel. The drain time is recorded and used as a measure of drainage performance.

Filtrate was collected from the mixing stock using a screened tube assembly that filters out long fiber. This filtrate was then filtered through a 150 micron filter and then analyzed for particle count and size using Kemira's Flyto technique. Flow cytometry was used to identify particle types (hydrophobic, colloidal, fines), population counts and mean particle size. This data is used to assess the polymer's efficiency for colloidal retention.

### Results

The data in FIGS. 9A and 9B further demonstrate the efficacy and superiority of the inventive amphoteric emulsion polymer for usage as a broke fixative in recycled furnish compared to conventional broke fixatives. In particular, FIGS. 9A and 9B contain the results of 2 case studies comparing the inventive amphoteric emulsion polymer as a broke fixative in recycled furnish (Recycled commercial white towel furnish containing 30% post-consumer recycle content, contributing to high calcium levels) to other polymers. In the experiments the inventive amphoteric emulsion polymer was compared for use as a broke additive to other conventional polymers, i.e., a polyamine polymer (Polymer F), dry amphoteric polymer (Polymer A), and non-amphoteric retention polymer (Polymer E).

In Case Study A the turbidity of the tested furnish (obtained from recycled commercial white towels comprising 0.6% solids, pH 6.36, conductivity of 2.0 mS/cm3, a hardness of 600 mg/L as CaCO3 and an alkalinity of 360 mg/L) was compared after treatment with different polymer dosages (0.15, 0.3 and 0.45 kg/metric ton) of the inventive amphoteric emulsion polymer, a polyamine polymer, amphoteric polymer (Polymer A), and non-amphoteric polymer (Polymer E).

In Case Study B the agglomerates count of the same furnish obtained from recycled commercial white towels (comprising 0.6% solids, pH 6.36, conductivity of 2.0 mS/cm3, a hardness of 600 mg/L as CaCO3 and an alkalinity of 360 mg/L) was compared after treatment with the same dosages of the inventive amphoteric emulsion polymer, polyamine polymer (Polymer F), amphoteric polymer (Polymer A), and non-amphoteric polymer (Polymer E).

### Conclusions

The results of these 2 case studies clearly demonstrate that thick stock treatment using the inventive amphoteric emulsion polymer provided for superior performance in both retention (as measured by reduced turbidity (NTU)) (see FIG. 9A), and based on the Flyto data, as evidenced by the significantly reduced hydrophobic (HP) agglomerate population (source of sheet deposits) (see FIG. 9B) when the inventive amphoteric emulsion polymer (Polymer B) was used as a broke additive as compared to the other tested polymers.

### Example 10: Manufacturing and Characterization of the Polymers

Polymers evaluated in Example 11 were prepared according to the following.

### Manufacturing of Polymers

### Preparation of the Monomer Phase for Emulsion Polymerisation:

Poly-1: Acrylamide and [2-(acryloyloxy)ethyl]trimethylammonium chloride (Q9) was used in mole ratio of 80/20. 2-10 ppm of methylene bis-acrylamide was used as a crosslinker, 50-80 ppm of sodium hypophosphite was used as a chain transfer agent. Then 4-5% citric acid solution and 0.08% diethylene triamine pentaacetic acid is added to the aqueous monomer phase, and the pH of the monomer phase is adjusted between pH 3.5-4.0 with sodium hydroxide. During these processes, the temperature of the reactants is maintained below 30° C. (use an ice bath if necessary).

Poly-2: Acrylamide and [2-(acryloyloxy)ethyl]trimethylammonium chloride (Q9) was used in mole ratio of 65/35. 2-10 ppm of methylene bis-acrylamide was used as a crosslinker, 50-80 ppm of sodium hypophosphite was used as a chain transfer agent. Then 4-5% citric acid solution and 0.08% diethylene triamine pentaacetic acid is added to the aqueous monomer phase, and the pH of the monomer phase is adjusted between pH 3.5-4.0 with sodium hydroxide. During these processes, the temperature of the reactants is maintained below 30° C. (use an ice bath if necessary).

Poly-3: Acrylamide/[2-(acryloyloxy)ethyl]trimethylammonium chloride (Q9)/acrylic acid was used in mole ratio of 70/27/3. No crosslinker was used. 300-400 ppm of sodium hypophosphite was used as a chain transfer agent. Then 4-5% citric acid solution and 0.08% diethylene triamine pentaacetic acid is added to the aqueous monomer phase, and the pH of the monomer phase is adjusted between 2.5-3.0 with sodium hydroxide. During these processes, the temperature of the reactants is maintained below 30° C. (use an ice bath if necessary).

### Preparation of Oil Phase for the Emulsion Polymerisation:

To a tared 1000 ml steel jug, 20-22 weight-% of petroleum solvent was added and stirred using an overhead mixer, ~450 rpm. To this, 2-3 weight-% of ethoxylated alcohols (C10-C16, C12-C16, C12-C14) was added. Mixing was continued for at least 10 minutes.

The same oil phase was used in all polymerizations.

### Addition of Monomer Phase to Oil Phase:

a) The monomer phase was slowly added to the oil phase over a period of 30 seconds, and allowed to mix for ~20 minutes. The viscosity was recorded and the mixture was homogenized for 20 seconds by using a Ross Homogenizer operating at 4500 rpm. The viscosity was recorded again after homogenizing. Viscosity measurements were made by using a Brookfield viscometer equipped with No. 3 spindle spinning at 12 rpm. The mixture was poured into the polymerisation reactor and the initial temperature was recorded.
b) The contents of the polymerisation reactor were sparged with nitrogen for ~1 hour, continuously stirring at 450 rpm.

### Polymerization:

After 1 hour of nitrogen sparging the initiator tert-butyl hydroperoxide was added in amount of 20-40 ppm to the mixture and allowed to mix for 10 minutes. SO₂ gas (0.4%) at 18 SCCM was introduced and the temperature monitoring throughout the reaction was begun. The exotherm was observed (indicated by the increase in temperature), signaling polymerization. The flow rate of SO₂ was controlled such that the increase in temperature is gradual, 1° C./minute. To obtain the polymer of desired molecular weight, the temperature was maintained below 50° C. This was achieved by using a water bath and simultaneously cutting the SO₂ supply. Completion of polymerization was indicated when no further increase in temperature was seen even when SO₂ was continuously being fed. At this point, the SO₂ flow rate was set back to the initial value and reactor temperature to 50° C. and held for ~1.5 hours. Nitrogen was continuously sparged throughout the entire process.

### Post Additives:

Add to the beaker an ethoxylated alcohol at the addition rate of 2.0 wt % and allow to mix for ~20 minutes.

Characteristic of the prepared polymers Poly-1, Poly-2 and Poly-3 are given in Table 1. Characteristics of amphoteric dry polyacrylamides Poly-4 and Poly-R2, prepared by gel polymerisation, are also given in Table 1.

TABLE 1
Characteristics of the prepared polymers used in Examples 11.

| | | Active | AMD/Q9/ | |
|---|---|---|---|---|
| | | Polymer | AA* | SV*, |
| Polymer | Polymer Type | solids, % | ratio, mol−% | mPas |
| Poly-1 | Cationic quick | 38.3 | 80/20/0 | 3.2 |
| | inversion | | | |
| Poly-2 | Cationic quick | 39.1 | 65/35/0 | 3 |
| | inversion | | | |
| Poly-3 | Amphoteric | 33 | 70/27/3 | 1.72 |
| | Emulsion | | | |
| Poly-4 | Amphoteric dry | 95 | 78/20/2 | 3.2 |
| | polymer | | | |
| Poly-R1 | Polyvinylamine | — | — | — |
| (reference) | | | | |
| Poly-R2 | Amphoteric dry | 95 | 91/7/2 | — |
| (reference) | polymer | | | |

*AA = Acrylic Acid
Q9 = [2-(acryloyloxy)ethyl] trimethylammonium chloride (ADAM-CI, AETAC)
AMD = Acrylamide
SV = Specific viscosity

### Example 11: Evaluation of Polymers as Dewatering Agents

High cationic crosslinked polyacrylamides and high cationic amphoteric polyacrylamides, prepared according to Example 10, were compared to polyvinylamine (Poly-R1) and to conventional amphoteric polyacrylamide (Poly-R2). Polyvinylamine Poly-R1 used comprised 35 mol-% of vinylamine and 65 mol-% n-vinylformamide, MW 500 000 g/mol, commonly used as a press dewatering agent.

The aqueous fiber suspension was prepared as follows. Old corrugated containerboard (OCC) from a Central European board mill was soaked for 5 minutes at 2.5 weight-% consistency, at 85° C. in chemical water having conductivity of 3 mS/cm and pH 6.8. The chemical water was prepared by dissolving a salt mixture containing 70 weight-% calcium acetate, 20 weight-% sodium sulphate and 10 weight-t % sodium bicarbonate into deionized water until the conductivity was 3 mS/cm. After soaking, the OCC was hot-disintegrated at 30 000 rotations with a laboratory disintegrator. The obtained furnish was cooled to room temperature (about 23° C.).

Solids content of the fiber web after wire section and press section as well as the initial drainage were studied with dynamic drainage analyzer (DDA). Used DDA parameters: wire with 0.25 mm openings; vacuum 200 mbar; follow-up time 20 s.

Drainage was studied with dynamic drainage analyzer (DDA) as follows. 125 ml of aqueous fiber suspension was added to 375 ml of white water. First, white water was chemical water, and filtrate from previous pass in the following circulation tests. Diluted consistency was about 0.625%. Five circulations were made for each test point, and the samples and results were taken from 5th pass. 500 ml of the prepared fiber suspension was placed in the DDA vessel, mixing with 1000 rpm. Dewatering aid to be tested was added at 20 s before start of the drainage. Tested addition levels, given as active chemical, are given in Table 2. The retention system used was cationic polyacrylamide (dosage given in Table 2) and 0.15 kg/t dry of aluminated silica in each experiment, addition times 10 s and 7 s before drainage, respectively.

Drainage time was measured. Wet sheet was removed after drainage from the DDA, weighed and then wet pressed at for 1 minute at 4 bar. After the wet pressing, the sheet was weighed, dried at rapid dryer and weighed anew after drying. Wire and press solids values were calculated.

The results for drainage time, wire solids and press solids are given in Table 2. The results indicate that high cationic amphoteric polyacrylamides give faster drainage, improved vacuum dewatering on wire and improved wet pressing dry solids compared to low charge amphoteric polyacrylamide. Results in drainage, wire solids and press solids for crosslinked high cationic polyacrylamide is better than results for linear high cationic polymer used as reference (polyvinylamine Poly-R1). Both amphoteric and crosslinked high cationic polymers have an effect to retention polymer consumption. Optimum dewatering is achieved with lower retention polymer dosage. Retention polymer is used mainly for initial drainage control and polymers according to invention for increasing dryness after wire and press to increase board machine speed. 3.8 percentage-unit improvement in press solids means production speed increase potential of about 15%, if the drying capacity is the limiting factor of the machine. Compared to reference polymer Poly-R2 the improvement achieved with Poly-4 in press solids was 1.7 percentage-units corresponding speed increase potential of 7%.

TABLE 2
Results for drainage time, wire solids and press solids.

| | | Retention | | | |
|---|---|---|---|---|---|
| | Polymer | Polymer | Drainage | Wire | Press |
| | dosage | dosage | time | solids | solids |
| Polymer | [kg/t dry] | [kg/t] | [s] | [%] | [%] |
| 0-test 1 | 0 | 0.2 | 13.21 | 22.2 | 47.3 |
| (reference) | | | | | |
| Poly-4 | 0.35 | 0.2 | 12.09 | 25.2 | 51.1 |
| Poly-R2 | 0.35 | 0.2 | 11.81 | 23.8 | 49.4 |
| (reference) | | | | | |
| 0-test 2 | 0 | 0.1 | 10.53 | 22.8 | 45.9 |
| (reference) | | | | | |
| Poly-3 | 0.5 | 0.1 | 9.8 | 23.8 | 49.5 |
| Poly-2 | 0.5 | 0.1 | 7.13 | 23.7 | 47.4 |
| Poly-4 | 0.5 | 0.1 | 8.59 | 23.3 | 47.6 |
| Poly-R2 | 0.5 | 0.1 | 9.18 | 22.6 | 46.4 |
| (reference) | | | | | |
| Poly-R1 | 0.5 | 0.2 | 10.66 | 22.2 | 46.3 |
| (poly-R1) | | | | | |
| Poly-1 | 0.5 | 0.2 | 6.7 | 24.1 | 49.1 |
| Poly-2 | 0.5 | 0.2 | 7.45 | 24.4 | 49.3 |
| 0-test 3 | 0 | 0.3 | 10.58 | 20.9 | 42.7 |
| (reference) | | | | | |

### Example 12: Evaluation of Linear and Cross-Linked Cationic Polyacrylamides

Linear cationic polyacrylamides LIN-10, LIN-33 and LIN-49, and cross-linked cationic polyacrylamides CR-35, CR-58 and CR-80 were compared for their effects on drainage properties, charge neutralization, filtrate turbidity and SCT strength after wet pressing and drying.

Used polymers were polymerized from acrylamide and Q9. Mol-% of cationic Q9 monomer is indicated by number in the abbreviated name of the polymer. CR-named polymers are crosslinked with methacryl-bis-acrylamide, MBS, which is used in amount of 17 ppm (CR-35), 11 ppm (CR-58) and 12 ppm (CR-80), calculated from dry monomer weight. Specific viscosities (SV), given as mPas, for the polymers are indicated in Table 3. The SV value indicates the molecular size of the polymer. It is estimated that SV 2.7 mPas corresponds about 3-5 MDa molecular weight, depending on the charge and crosslinking level of the polymer.

Polymers were dissolved in water at 0.5 weight-% concentration with magnetic stirrer agitation for 45 min. Polymers were further diluted to 0.05 weight-% concentration prior to experiments.

The aqueous fiber suspension was prepared as follows. Old corrugated containerboard (OCC) from a Central European board mill was soaked for 5 minutes at 2.5 weight-% consistency, at 85° C., in chemical water having conductivity of 4 mS/cm and pH 6.8 The chemical water contained 520 mg/l Ca²⁺ from CaCl₂). Conductivity was adjusted to 4 mS/cm with NaCl. After soaking, the OCC was hot-disintegrated at 30 000 rotations with a laboratory disintegrator. The obtained furnish was cooled to room temperature (about 23° C.) and diluted to 1.0 weight-% consistency before the experiments by using the same chemical water.

Drainage was studied with dynamic drainage analyzer (DDA) as follows. 250 ml of aqueous fiber suspension was added to 500 ml of white water. First white water was chemical water, and in the following circulation tests filtrate from the previous pass was used. Five circulations were made for each test point and the samples and results were taken from 5th pass. DDA parameters: wire with 0.25 mm openings; vacuum 300 mbar; follow-up time 15 s.

750 ml of the prepared fiber suspension was placed in the DDA vessel, mixing with 1000 rpm. Dewatering aid to be tested was added at 10 s before start of the drainage. Tested addition levels, given as active chemical, are given in Table 3.

Drainage time was measured. Wet sheet was removed after drainage from the DDA, weighed and then wet pressed at for 1 minute at 4 bar. After the wet pressing, the sheet was weighed, dried at Lorenz & Wettre hot plate dryer and weighed anew after drying. Sheets were air conditioned at 23° C. and 50% RH for 4 hours. SCT strength was measured from the sheets according to standard ISO 9895. SCT index was calculated dividing SCT strength by bone dry basis weight of the sheet. Cationic demand was measured with Mütek PCD-03 from the 10 ml sample of DDA filtrate according to manufacturer's instructions. Turbidity was measured from DDA filtrate with Knick Portamess 911 device according to manufacturer's instructions.

TABLE 3
Results of DDA drainage tests.

| | Polymer | | | | | | | | | |
|---|---|---|---|---|---|---|---|---|---|---|
| | LIN-10 | LIN-33 | LIN-49 | CR-35 | CR-58 | CR-80 | | | | |
| | SV* [mPas] | | | | | | Drainage | Cationic | | SCT |
| | 3.5 | 2.7 | 2.7 | 2.7 | 2.7 | 2.5 | time, | demand, | Turbidity, | index, |
| Test # | Added Amount [kg] | | | | | | [s] | [μeqv/L] | [NTU] | [Nm/g] |
| 1 | 0 | | | | | | 11.4 | 48 | 256 | 14.9 |
| 2 | 0.3 | | | | | | 11.1 | 39 | 108 | 13.4 |
| 3 | 0.5 | | | | | | 10.3 | 37 | 64 | 14.0 |
| 5 | | 0.5 | | | | | 13.0 | 37 | 87 | 14.3 |
| 6 | | | 0.3 | | | | 10.3 | 25 | 114 | 14.5 |
| 7 | | | 0.5 | | | | 13.9 | 33 | 77 | 14.8 |
| 8 | | | | 0.4 | | | 8.3 | 41 | 86 | 15.7 |
| 9 | | | | | 0.4 | | 7.1 | 32 | 87 | 15.8 |
| 10 | | | | | | 0.4 | 8.2 | 38 | 85 | 16.1 |

*SV = Specific viscosity

It is seen from Table 3 that Test #8, 9 and 10, which are according to the invention, provide significant increase in SCT index. Test #2 shows results for a linear cationic polyacrylamide with a typical retention aid dosage, which leads to a weaker SCT strength. Increase in dosage does not provide noteworthy improvement in SCT index (Test #3). High cationic linear polymers (Test #5, 6 and 7) may improve turbidity and reduce cationic demand for pressability, but SCT strength is not as good as with cross-linked polymers. Drainage speed is significantly faster with cross-linked polymers according to invention.

### Example 13: Evaluation of High Cationic Amphoteric Polyacrylamides as Press Dewatering Agents

High cationic amphoteric polyacrylamides (Amph.PAM) were compared to polyvinylamine Poly-R1. Polyvinylamine Poly-R1 used comprised 35 mol-% of vinylamine and 65 mol-% n-vinylformamine, MW 500 000 g/mol, commonly used as a press dewatering agent. Polymer molar ratios of cationic monomer (Q9) and anionic monomer (acrylic acid) and standard viscosities (SV) are presented in Table 4.

The aqueous fiber suspension was prepared as follows. Old corrugated containerboard (OCC) from a Central European board mill was soaked for 5 minutes at 2.5 weight-% consistency, at 85° C. in chemical water having conductivity of 3 mS/cm and pH 6.8. The chemical water was prepared by dissolving a salt mixture containing 70 weight-% calcium acetate, 20 weight-% sodium sulphate and 10 weight-t % sodium bicarbonate into deionized water until the conductivity was 3 mS/cm. After soaking, the OCC was hot-disintegrated at 30 000 rotations with a laboratory disintegrator. The obtained furnish was cooled to room temperature (about 23° C.).

Solids content of the fiber web after wire section and press section as well as the initial drainage were studied with dynamic drainage analyzer (DDA). DDA parameters: wire with 0.25 mm openings; vacuum 300 mbar; follow-up time 20 s.

Drainage was studied with dynamic drainage analyzer (DDA) as follows. 500 ml of the prepared 0.5% consistency fiber suspension was placed in the DDA vessel, mixing with 1000 rpm. Dewatering aid to be tested was added at 10 s before start of the drainage. Tested addition levels, given as active chemical, are given in Table 2. The retention system used was cationic polyacrylamide (dosage given in Table 4), addition time was 10 s before drainage.

Drainage time was measured. Wet sheet was removed after drainage from the DDA, and then wet pressed at for 1 minute at 4 bar. After the wet pressing, the sheet was weighed, dried at rapid dryer and weighed anew after drying. Press solids values were calculated. Ash content was measured by weighting oven dried (110 C 4 h) pads and burning them at 525 C oven for 4 h and weighting the remaining ash.

The results for drainage time, wire solids and press solids are given in Table 4. The results indicate that high cationic amphoteric polyacrylamides give faster drainage and improved wet pressing dry solids compared to PVAM. Results in turbidity indicate that use of high cationic amphoteric polyacrylamide makes white water cleaner, which may help to keep longer running time for the press felts before need for washing shut-down or felt change shut-down. It also indicates lower risk for deposits that can cause web breaks or hole in paper. In recycled fiber turbidity reduction may indicate that micro-stickies are fixed to fibers without forming sticky deposits. Increased ash content of the sheet indicates improved retention, which is beneficial for production increase, for reduction of web breaks and for wire fabric running time.

TABLE 4
Polymers tested as dewatering aids and results of DDA drainage tests

| | | | | | | | | Press | |
|---|---|---|---|---|---|---|---|---|---|
| | Dosage | SV* | Cationic* | Anionic* | CPAM | Drain | Turbidity | dryness | Ash |
| Polymer* | [kg/t dry] | [mPas] | [mol-%] | [mol-%] | [kg/t] | time [s] | [NTU] | [%] | [%] |
| None | | | | | 0.15 | 7.4 | 341 | 45.5 | 12.2 |
| None | | | | | 0 | 8.4 | 790 | 45.2 | 10.8 |
| None | | | | | 0.3 | 6.9 | 200 | 47.6 | 13.1 |
| Poly-R1 | 0.3 | 1.4 | 35 | 0 | 0.15 | 7.6 | 256 | 45.6 | 12.8 |
| Poly-R1 | 0.5 | 1.4 | 35 | 0 | 0.15 | 7.4 | 219 | 48.1 | 12.9 |
| Amph. PAM | 0.3 | 3.1 | 13 | 2 | 0.15 | 7.1 | 150 | 49.0 | 13.3 |
| Amph. PAM | 0.3 | 3.4 | 13 | 2 | 0.15 | 6.9 | 143 | 47.4 | 13.5 |
| Amph. PAM | 0.3 | 2.6 | 20 | 2 | 0.15 | 7.0 | 142 | 46.8 | 13.3 |
| Amph. PAM | 0.3 | 3.0 | 20 | 2 | 0.15 | 6.9 | 139 | 47.0 | 13.4 |
| Amph. PAM | 0.3 | 2.6 | 27 | 2 | 0.15 | 7.2 | 150 | 46.2 | 13.2 |
| Amph. PAM | 0.3 | 3.2 | 27 | 2 | 0.15 | 6.8 | 131 | 47.5 | 13.4 |
| Amph. PAM | 0.4 | 3.0 | 20 | 2 | 0.15 | 6.9 | 111 | 47.6 | 13.3 |
| Amph. PAM | 0.5 | 3.1 | 13 | 2 | 0.15 | 7.3 | 119 | 49.3 | 13.3 |
| Amph. PAM | 0.5 | 3.4 | 13 | 2 | 0.15 | 6.7 | 112 | 48.5 | 13.4 |
| Amph. PAM | 0.5 | 2.6 | 20 | 2 | 0.15 | 7.1 | 113 | 48.1 | 13.2 |
| Amph. PAM | 0.5 | 3.0 | 20 | 2 | 0.15 | 6.8 | 99 | 48.0 | 13.3 |
| Amph. PAM | 0.5 | 2.6 | 27 | 2 | 0.15 | 7.4 | 116 | 48.2 | 13.3 |
| Amph. PAM | 0.5 | 3.2 | 27 | 2 | 0.15 | 6.9 | 90 | 48.6 | 13.5 |

*Amph. PAM = High cationic amphoteric polyacrylamide
Cationic = [2-(acryloyloxy)ethyl] trimethylammonium chloride (Q9)
Anionic = Acrylic Acid (AA)
SV = Specific viscosity

### Example 14: Evaluation of Amphoteric Emulsion Polymers with Silica as Retention and Drainage Aids in Low Conductivity Recycled OCC Furnish

### Polymers Evaluated as Retention and Drainage Aids

For Examples 14-15, amphoteric emulsion terpolymers (AmEPAM) prepared according to Example 1 were evaluated against conventional polymers (e.g., APAM, AmDPAM, CPAMs, and PEI) as retention and drainage aids for treating 100% recycled old corrugated cardboard (OCC) stock. Polymer additives tested as retention and drainage aids are shown in Table 5. The polymers were tested with and without colloidal silica.

TABLE 5
Polymer additives tested as retention
and drainage aids in Examples 14-15.

| | | | Charged |
|---|---|---|---|
| | | | Monomer, |
| Polymer | Description | SV, cPs | mol% |
| Anionic | Anionic | 6.8-11.0 | 30% AA* |
| PAM | Polyacrylamide (APAM) | | |
| High MW | High MW Cationic | 4.8-5.6 | 10% Q9* |
| CPAM | Polyacrylamide | | |
| Low MW | Low MW Cationic | 3.3 | 20% Q9 |
| CPAM | Polyacrylamide | | |
| Dry | Amphoteric Dry | 3.2 | 7% Q9, |
| Amphoteric | Polyacrylamide | | 2% AA |
| Polymer | (AmDPAM) | | |
| PEI | Polyethylenimine | — | — |
| Invention | Amphoteric Emulsion | 3.3-3.4 | 7-12% Q9, |
| Polymer | Polyacrylamide | | 2.1-2.26% |
| | AmEPAM) | | AA |

*AA = Acrylic Acid
Q9 = [2-(acryloyloxy)ethyl] trimethylammonium chloride (ADAM-CI, AETAC)
SV = Specific viscosity

### Test Procedures

Test procedures for Examples 14-15 were performed according to the following:

### Preparation of Fiber Pads and Determination of Drainage Time by DDA Screening

Cellulosic fibrous webs (fiber pads) were prepared and drainage times were analyzed by dynamic drainage analyzer (DDA) testing according to the following. An aliquot of cellulosic fiber stock (500 ml) with a consistency of 0.4 to 0.7% by wt (Total Suspended solids, TSS) was mixed with chemical additives (polymer or polymer+silica) for 45 seconds while agitating. After mixing, the flocculated stock was subjected to vacuum dewatering by draining through a 60 mesh screen under vacuum (250 mBar). DDA drainage time was determined by measuring the time needed to show a vacuum break (i.e., a rapid increase in vacuum pressure). The percent solids (% by weight) in the DDA fiber pads from the DDA screen were determined. Fiber pads and filtrates were used for additional testing.

### Determination of Filtrate Turbidity

Turbidity testing was performed on the filtrates from DDA screening as an indication of retention. Turbidity of treated filtrates was performed using a Hach 2100Q turbidimeter. The Model 2100Q Portable Turbidimeter operates on the nephelometric principle of turbidity measurement. The optical system includes a tungsten-filament lamp, a 90° detector to monitor scattered light and a transmitted light detector. The instrument's microprocessor calculates the ratio of the signals from the 90° and transmitted light detectors, which corrects for interferences from color and/or light-absorbing materials. The instrument range is 0 to 1000 NTU. A lower turbidity level generally correlates with an increase in retention of filler, fines, and/or contaminants in the furnish in the fiber pads.

### Determination of % Solids After Press Dewatering

The fiber pads left on the DDA screen was carefully removed from the wire screen and placed between four blotter papers. The blotters were then fed through a silicone roller press under 400 kPa at speed of 4 m/min for three passes. The wet fiber wet weight was recorded after each press. After three presses, the fiber pads were placed on a speed dryer at 110° C. for at least 90 minutes. The pad solids after 1st press and 3rd press were calculated by dividing the dry pad weight by the wet pad weight after each press.

### Determination of Water Retention Value (WRV)

For selected conditions, the fiber pads left from the DDA screen was retained for the water retention value measurement. The test was carried out according to TAPPI Useful Method UM256. The centrifuge was set at 2600 rpm to provide 900 g-force. And the 2.5 cm diameter of the filter screen in the specimen folder was used and thus the oven dry pad was around 0.687 g.

Preparation of Boards from Low Conductivity Recycled Furnish

For the present Example 14, the inventive amphoteric emulsion polyacrylamide (AmEPAM) was evaluated in low conductivity fiber stock against polymers that are known for their performance on wet pulp pressability.

A NA Tissue machine was used for formation of recycled box board fiber pads from low conductivity recycled 100% OCC cellulosic fiber stock according to the section entitled Determination of Drainage Time By DDA Screening.

The low conductivity recycled 100% OCC cellulosic fiber stock was relatively clean, compared to typical recycled OCC furnish. The conductivity of the white water was 2.4 mS/cm. The total hardness of white water was 900 ppm as CaCO3. The pH of headbox furnish was 6.67 and consistency was 0.56%, measured as % total suspended solids (TSS).

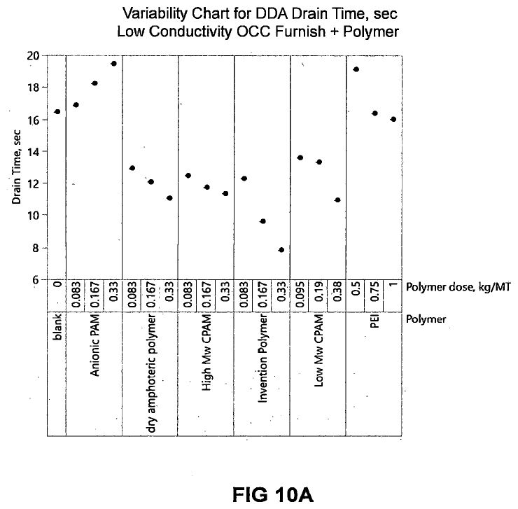

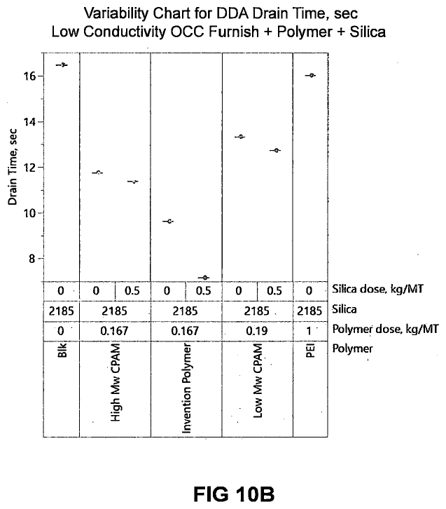

The low conductivity fiber stock was treated with polymers from Table 5 with and without colloidal silica. DDA drainage time, filtrate turbidity, % solids of DDA fiber pads, % solids after 1st and 3rd press dewatering, and DDA fiber pad water retention value (WRV) were determined according to TEST PROCEDURES. Additives, dosages, and results are shown in FIGS. 10-15.

### Results and Discussion

Results for DDA drainage time (sec) are shown in FIGS. 10A and 10B. Results for testing without silica (see FIG. 10A) and with silica (see FIG. 10B) are shown.

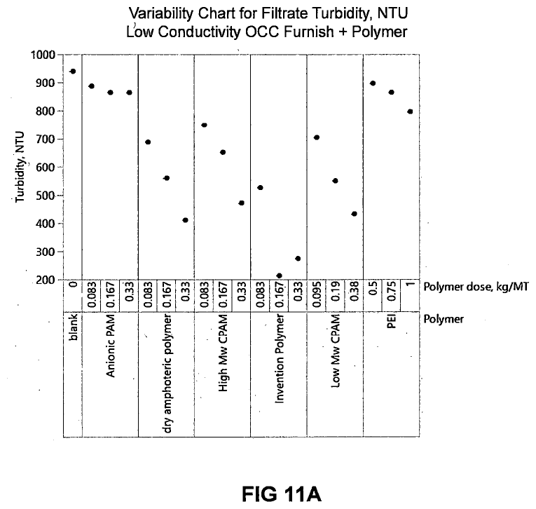

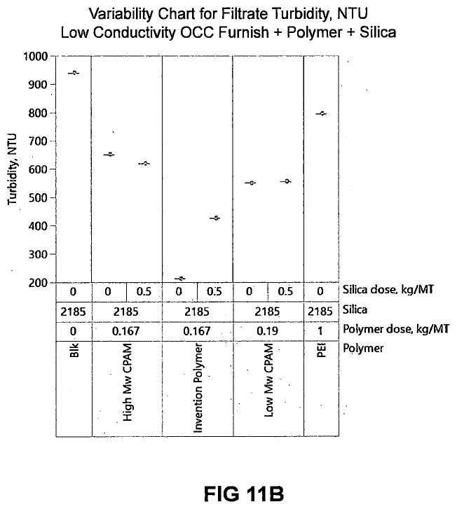

Results for filtrate turbidity (NTU) are shown in FIGS. 11A and 11B. Results for testing without silica (see FIG. 11A) and with silica (see FIG. 11B) are shown.

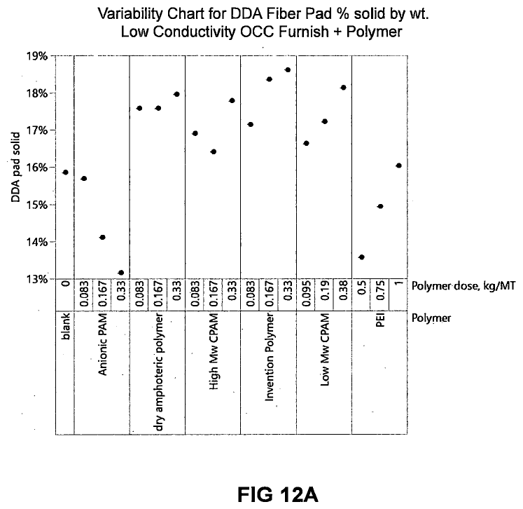

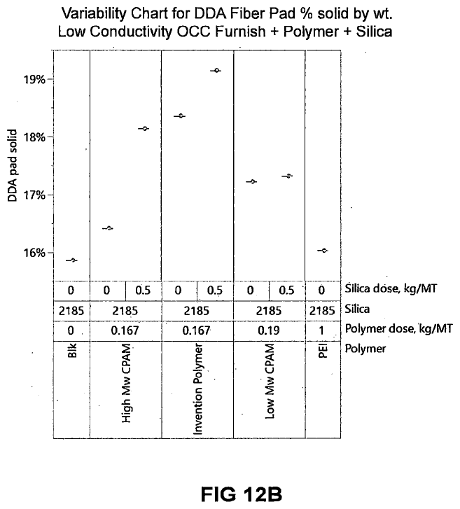

Results for % solids of DDA fiber pads are shown in FIGS. 12A and 12B. Results for testing without silica (see FIG. 12A) and with silica (see FIG. 12B) are shown.

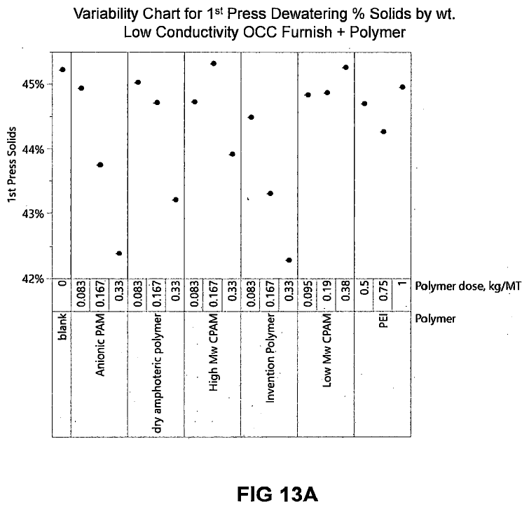

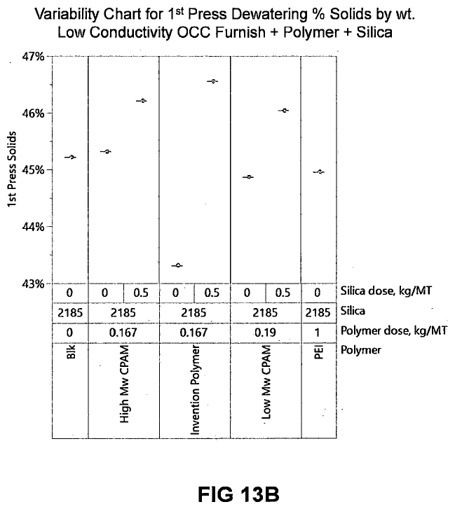

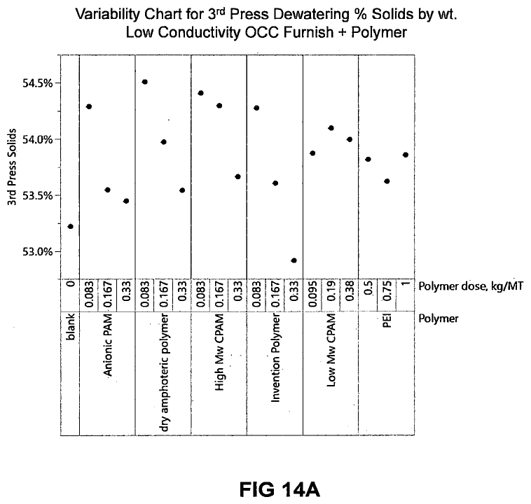

Results for 1st Press Dewatering % solids by wt are shown in FIGS. 13A and 13B. Results for testing without silica (see FIG. 13A) and with silica (see FIG. 13B) are shown.

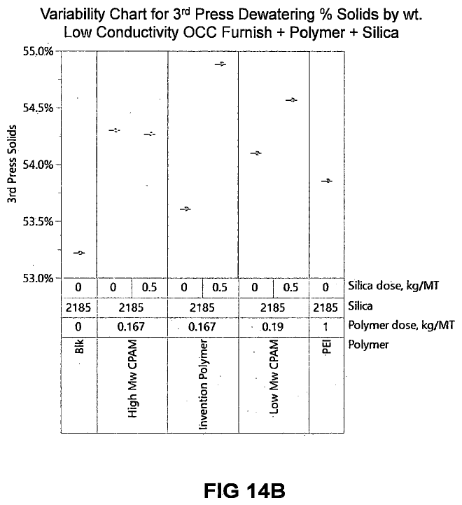

Results for 3rd Press Dewatering % solids by wt are shown in FIGS. 14A and 14B. Results for testing without silica (see FIG. 14A) and with silica (see FIG. 14B) are shown.

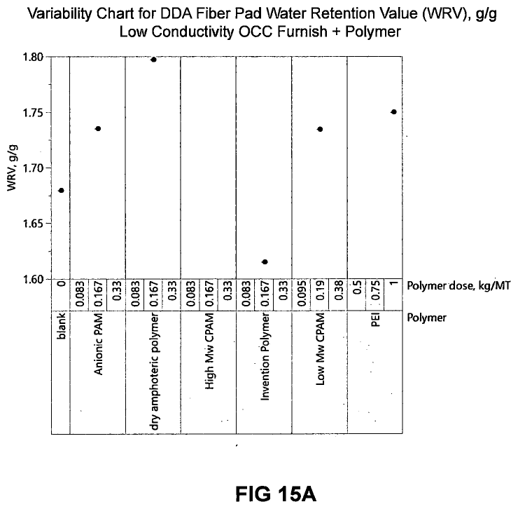

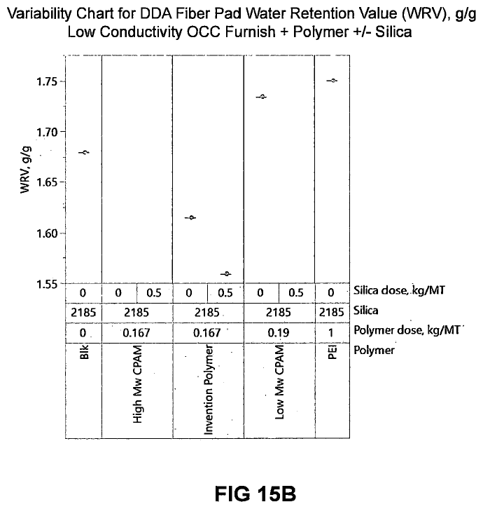

Results for DDA fiber pad water retention value (WRV) (g/g) are shown in FIGS. 15A and 15B. Results for testing without silica (see FIG. 15A) and with silica (see FIG. 15B) are shown.

The results of FIGS. 10A, 11A, 12A, and 15A indicate that addition of the inventive retention and drainage aid (e.g., amphoteric emulsion polyacrylamide (AmEPAM)) significantly, and in some cases dramatically, improves (i) DDA drainage time (sec) indicating better drainage under vacuum; (ii) filtrate turbidity (NTU) indicating increased retention of fibers, starch fines, and mineral fines; (iii) % solids of DDA fiber pads indicating more efficient dewatering under vacuum; and (iv) DDA fiber pad water retention value (WRV) (g/g) indicating more efficient solid retention and dewatering under vacuum of box board fiber pads from low conductivity recycled 100% OCC cellulosic fiber stock. These improved results were observed in comparison to conventional retention and drainage aids (e.g., Anionic PAM, CPAMs, and PEI).

It was surprisingly found that the inventive amphoteric emulsion polyacrylamide (AmEPAM) outperformed the conventional press dewatering aids, including amphoteric dry polyacrylamide (AmDPAM) and PEI.

Addition of silica alone to a cellulosic fiber suspension is known to have no effect or detrimental effects on both retention and drainage. However, FIGS. 10B, 118, 12B, and 15B surprisingly indicate that addition of silica to the inventive amphoteric emulsion polyacrylamide (AmEPAM) provided a synergistic improvement in retention and drainage, with the best results (e.g., shortest DDA drainage time (sec), lowest filtrate turbidity (NTU), highest % solids of DDA fiber pads, and lowest WRV) obtained by addition of the inventive AmEPAM in the presence of 0.5 kg/T silica (i.e., AmEPAM+silica).

The results of FIGS. 13A and 14A indicate that the inventive amphoteric emulsion polyacrylamide (AmEPAM) provided the worst results (lowest % solids) for 1st press and 3rd press dewatering. However, FIGS. 13B and 14B surprisingly indicate that addition of silica to the inventive AmEPAM provided a synergistic improvement in 1st press and 3rd press dewatering, with the highest % solids observed for AmEPAM+silica.

Without being bound to theory, it can be rationalized that the AmEPAM emulsion polymers create 3D polymeric structures with ionic cross links and repulsions (i.e., the amphoteric effect, see FIG. 1) when added as an emulsion to fiber stock. This phenomenon produces a AmEPAM flocculant with optimal surface charge and pore size to bind and flocculate the anionic cellulosic fibers, starch fines, and mineral that would otherwise be lost, thereby providing better retention and better drainage than the conventional polymers, including the AmDPAM dry polymer.

Without being bound to theory, it can be rationalized that the observed synergism of AmEPAM+silica may result from a mechanism wherein (i) the AmEPAM forms flocs by efficiently binding and flocculating the anionic cellulosic fibers, starch fines, and mineral that would otherwise be lost, and then (ii) the addition of silica causes the flocs to shrink by disrupting the ionic cross links of the AmEPAM polymer and collapsing the 3D polymeric structures, thereby forming a higher density floc structure which allows for synergistic increase in retention, drainage under vacuum, and wet pressability.

These results provide proof of concept that the inventive amphoteric emulsion polyacrylamide (AmEPAM) provide enhancements in retention and drainage in low conductivity fiber stock. The addition of AmEPAM+silica provided a for synergistic increase in retention, drainage under vacuum, and wet pressability.

### Example 15: Evaluation of Amphoteric Emulsion Polymers with Silica as Retention and Drainage Aids in High Conductivity Recycled OCC Furnish

For the present Example 15, amphoteric emulsion terpolymers (AmEPAM) prepared according to Example 1 were evaluated with and without silica against conventional polymers (e.g., CPAMs and PEI) as retention and drainage aids for treating low conductivity 100% recycled old corrugated cardboard (OCC) stock.

Preparation of Boards from High Conductivity Recycled Furnish

A NA Tissue machine was used for formation of recycled box board fiber pads from high conductivity recycled 100% OCC cellulosic fiber stock according to the section entitled Determination of Drainage Time By DDA Screening (see Example 14).

The high conductivity recycled 100% OCC cellulosic fiber stock was less clean than the system of Example 14. The conductivity of white water was 4.7 mS/cm, which is typical for recycled OCC board production. The total hardness of white water was higher than typically encountered, about 1540 ppm as CaCO3, in which 1400 ppm was calcium hardness. The pH of headbox furnish was 6.76 and consistency was 0.63%, measured as % total suspended solids (TSS).

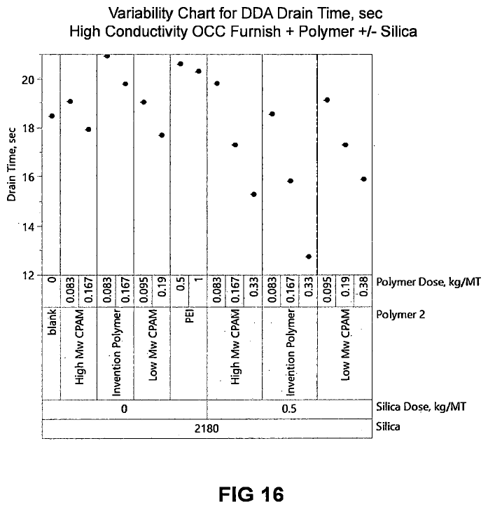

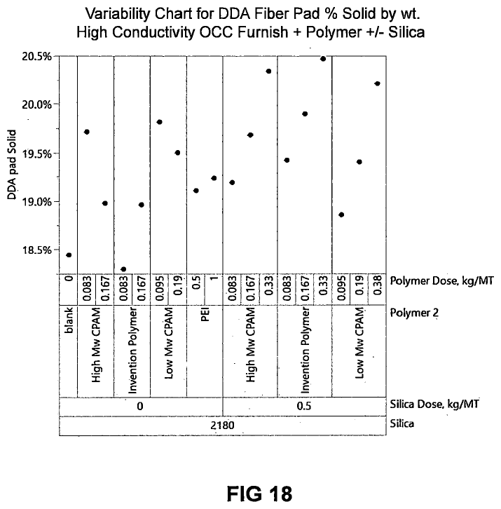

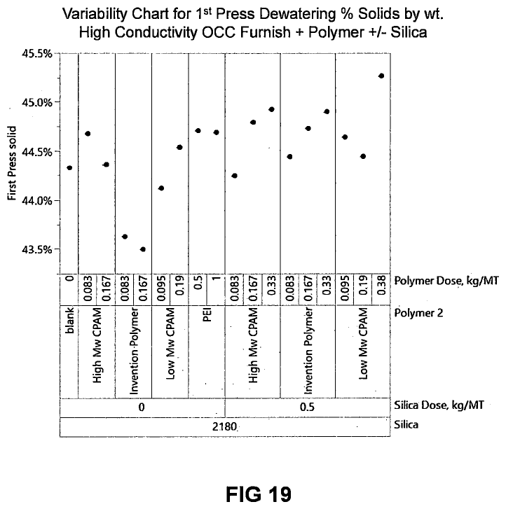

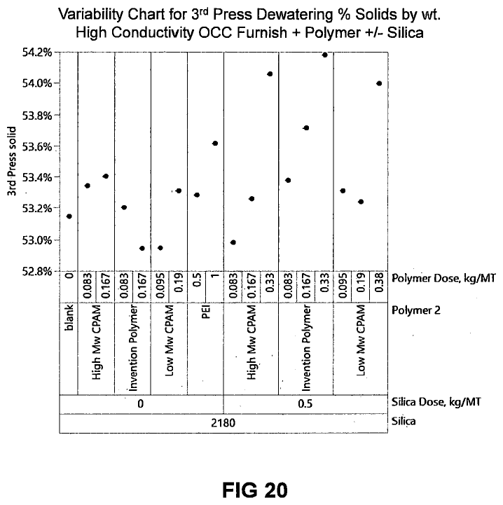

The high conductivity fiber stock was treated with polymers from Table 5 with and without colloidal silica. DDA drainage time, filtrate turbidity, % solids of DDA fiber pads, % solids after 1st and 3rd press dewatering, and DDA fiber pad water retention value (WRV) were determined according to the section entitled TEST PROCEDURES (see Example 14). Additives, dosages, and results are shown in FIGS. 16-20.

### Results and Discussion

Results for DDA drainage time (sec), filtrate turbidity (NTU), % solids of DDA fiber pads, 1st Press Dewatering % solids by wt, and 3rd Press Dewatering % solids by wt are shown in FIGS. 16-20, respectively.

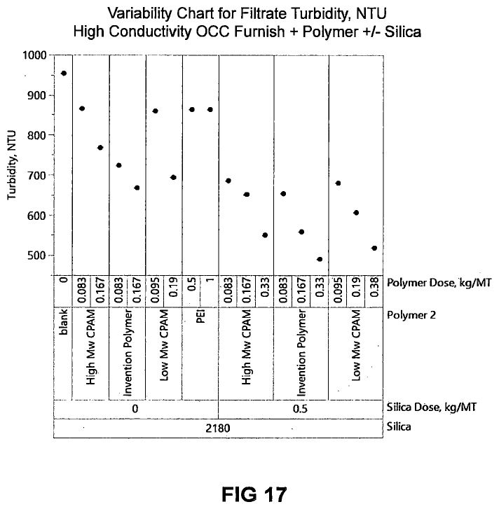

The results of FIG. 17 indicate that the inventive amphoteric emulsion polymer (AmEPAM) significantly improves retention of starch fibers, starch fines, and mineral fines when added to high conductivity fiber stock, compared to conventional CPAMs and PEI. This figure surprisingly indicates that addition of silica provided a synergistic improvement in retention, with the lowest overall filtrate turbidity (NTU) observed for AmEPAM+silica.

The results of FIGS. 16, 18, 19, and 20 indicate that the inventive amphoteric emulsion polymer (AmEPAM) provided the worst results when added to high conductivity fiber stock, compared to conventional CPAMs and PEI. However, these figures surprisingly indicate that addition of AmEPAM+silica provided synergistic improvements in vacuum drainage and press dewatering, with the best overall results for DDA drainage, % solids of DDA fiber pads, and 3rd press dewatering observed for AmEPAM+silica. These results are surprising, in part, because PEI alone is a well-known press dewatering aid. Without silica, PEI provided higher press solids. With silica addition, the inventive AmEPAM provided the highest press solids at ⅓ and ⅙ the AmEPAM dosage (0.167 and 0.33 kg/MT) compared to PEI (1 kg/MT).

These results provide further proof of concept that the inventive retention and drainage aids (e.g., AmEPAM+silica) provide synergistic enhancements in retention, vacuum drainage, and press dewatering, when added to high conductivity fiber stock.

Having described the inventive amphoteric emulsion polymers, compositions containing, methods for making and methods of use thereof have been described in terms of preferred embodiments, the invention is further defined by the claims which follow:

What is claimed is:

1. A water-soluble amphoteric emulsion terpolymer, which comprises:
(a) one or more acrylamide (AM) monomers, one or more anionic monomers comprising acrylic acid (AA), and one or more cationic monomers comprising 2-(acryloyloxy)ethyl]trimethylammonium chloride (Q9);
(b) an acrylamide (AM) or (meth)acrylamide monomer content ranging from 45-99 mol-%;
(c) an acrylic acid (AA) monomer content of ≤5 mol-%, ≤3 mol-%, or preferably ≤2 mol-%;
(d) a Q9 monomer content ranging from ≤12 mol-%, ≤20 mol-%, or ≤50 mol-%;
(e) a polymer standard viscosity (SV) of ≤4.5 cPs, ≤3.5 cPs, or preferably 2.5-3.5 cPs; and
(f) a molecular weight ranging from 1.5-9 million Da, 5-8 million Da, or 3 to 5 million Da.

2. The water-soluble amphoteric emulsion terpolymer of claim 1, wherein:
(a) the acrylamide (AM) or (meth)acrylamide monomer content (i) ranges from 78-92.9 mol-% inclusive, 78-92.5 mol-% inclusive, or 78-92.1 mol-% inclusive, or (ii) ranges from 78-79 mol-%; 79-80 mol-%; −80-81 mol-%; 81-82 mol-%; 82-83 mol-%; 83-84 mol-%; 84-85 mol-%; 85-86 mol-%; 86-87 mol-%; 87-88 mol-%; 88-89 mol-%; 89-90 mol-%; 90-91 mol-%; 91-92 mol-%; or 92-92.9 mol-%;
(b) the acrylic acid (AA) monomer content ranges from 0.1-5 mol-%, 0.5-3 mol-%, 1.2-3 mol-%, 0.5-2.1 mol-%, or 0.5-1.0 mol-%;
(c) the Q9 monomer content ranges from (i) 7-20 mol-%, 7-18 mol-%, 7-16 mol-%, 7-13 mol-%, 7-12 mol-%, 7-10 mol-%, 7-9 mol-%, or (ii) 7-8 mol-%, 8-9 mol-%, 9-10 mol-%, 10-11 mol-%, 11-12 mol-%, 12-13 mol-%, 13-14 mol-%, 14-15 mol-%, 15-16 mol-%, 16-17 mol-%, 17-18 mol-%, 18-19 mol-%, 19-19.5 mol-%, or 19.5-20 mol-%; or
(d) any combination of the foregoing.

3. The water-soluble amphoteric emulsion terpolymer of claim 1 or 2, which is formulated by inverting the water-soluble amphoteric emulsion terpolymer with water and/or a hard water comprising >200 ppm of calcium and/or magnesium ions, thereby forming an inverted aqueous dispersion or an inverted hard water aqueous dispersion,
optionally wherein the inverted aqueous dispersion or the inverted hard water aqueous dispersion:
(a) further comprises a buffer which provides for the pH to be controlled within the range of about 2.5-5.0, or 2.5-3.5; or 2.80-3.5, or 2.7-3.5, or 2.5-3.2; or 2.5-3.0, or 2.7-3.0;
(b) further comprises a citric acid buffer or sodium acetate-acetic acid buffer;
(c) further comprises a sodium acetate-acetic acid buffer;
(d) comprises 1-8 wt % or more typically 3-5 wt % the water-soluble emulsion amphoteric terpolymer;
(e) is stable at least 3-6 months; or
(f) any combination of (a)-(f).

4. The water-soluble amphoteric emulsion terpolymer, the aqueous dispersion, or the hard water aqueous dispersion of any of the foregoing claims, which:
(a) is added to a fluid used in papermaking, wherein an amount of terpolymer is added to obtain a desired stock consistency, e.g., a terpolymer fluid comprising 0.2% terpolymer is dosed at ≈0.6 g/L to 3.75 g/L; or
(b) is added to a composition or machine used in papermaking.

5. A method of making a water-soluble emulsion amphoteric terpolymer according to any of the foregoing claims by conducting an inverse emulsion polymerization process using acrylamide (AM), acrylic acid (AA), and acryloyloxy ethyl trimethylammonium chloride (Q9) monomers, wherein the method provides for a water-soluble emulsion amphoteric terpolymer comprising ≤3 mol-% acrylic acid (AA) monomers or ≤2 mol-% acrylic acid (AA) monomers, up to 20 mol-% Q9 monomers, and at least 78 mol-% acrylamide (AM) monomers.

6. The method of claim 5, wherein the inverse emulsion polymerization process comprises the following steps:
(a) a “monomer phase” which comprises combining acrylamide, acrylic acid and acryloyloxy ethyl trimethylammonium chloride (Q9) monomers and a chain transfer agent while maintaining the pH of this mixture between 2.5-5.0, 2.5-4.5, 2.5-4.0, 2.5-3.5, 2.5-3.0, 2.7-3.0 or 3-3.3; optionally wherein the “monomer phase” comprises any or all of the following steps:
(i) adding to a container acrylamide monomers, cationic Q9 monomers, and citric acid solution or so as to obtain a composition wherein the pH is between 2.5-5.0, 2.5-4.5, 2.5-4.0, 2.5-3.5, 2.5-3.0, 2.7-3.0 or 3-3.3;
(ii) mixing the resultant monomer blend, optionally for at least ~1 minute;
(iii) adding acrylic acid monomers, and a chain transfer agent, optionally sodium hypophosphite (NaHypo) further optionally at 50-70 ppm of total monomer content or isopropyl alcohol, further optionally at a dosage of 8500-12000 ppm of total monomer content, and a chelating agent, optionally diethylene triamine pentaacetic acid (DTPA) and water,
(iv) mixing the resultant mixture, optionally for at least about 1-20 minutes or at least 1-10 minutes;
(v) checking the pH of the monomer phase one or more times and maintaining the pH of the monomer mixture between 2.5-5.0, 2.5-4.5, 2.5-4.0, 2.5-3.5, 2.5-3.0, 2.7-3.0 or 3-3.3, optionally by the addition of ammonium hydroxide;
(vi) maintaining the temperature of the reactants of the monomer phase below 30° C.; and
(vii) determining the initial pH of the monomer phase (before the addition of NH₄OH) and optionally determining the final pH (after optionally adjusting with NH₄OH) and water to obtain the monomer phase;
(b) an “oil phase” which comprises producing a composition comprising an oil, optionally a petroleum solvent, and at least one emulsifying agent or surfactant; optionally wherein the “oil phase” comprises any or all of the following steps:
(i) adding an oil or hydrophobic solvent, optionally a composition comprising an oil, optionally a petroleum solvent, 19-21% range;
(ii) stirring the composition;
(iii) adding a at least one emulsifying agent or surfactant, optionally an ethoxylated alcohol (C12-C16): 2-3% and sorbitan monooleate (SMO); and
(iv) permitting the resultant mixture to mix, optionally for 10 minutes or more;
(c) a “combining phase” which comprises combining the monomer phase and the oil phase; optionally wherein the “combining phase” comprises any or all of the following steps:
(i) adding the monomer phase to the oil phase;
(ii) permitting the mixture to mix optionally for at least ~20 minutes;
(iii) detecting the viscosity of the mixture during and/or after mixing;
(iv) homogenizing the resultant mixture;
(v) determining the viscosity after homogenizing;
(vi) adding the resultant mixture to a polymerization reactor; and
(vii) recording the initial temperature;
(d) a “sparging phase” which comprises sparging the combined phase with a gas, preferably nitrogen while mixing; optionally wherein the “sparging phase” comprises any or all of the following steps:
(i) sparging the contents of the reactor with nitrogen, optionally for at least ~1 hour; and
(ii) continuously stirring the mixture;
(e) a “polymerization phase” which comprises effecting polymerization by the addition of a polymerization initiator, and SO₂ gas while nitrogen is continuously sparged throughout the entire process; optionally wherein the “polymerization phase” comprises any or all of the following steps:
(i) adding a polymerization initiator, optionally tert-butyl hydroperoxide, to the mixture optionally after 1 hour of sparging and allowing the admixture to mix for an adequate time;
(ii) introducing SO₂ gas, optionally 0.4% at 18 Standard cubic centimeters per minute (SCCM);
(iii) monitoring the temperature throughout the reaction;
(iv) controlling the flow rate of SO₂ such that the raise in temperature is gradual, optionally ~1.5° C./minute, more preferably ~1° C./minute;
(v) maintaining the temperature below 50° C. throughout the reaction, optionally by using a water bath and/or by cutting the SO₂ gas flow;
(vi) determining that polymerization is completed, e.g., when no raise in temperature is seen when SO₂ is continuously being fed;
(vii) adjusting the SO₂ flow rate back after polymerization is completed to the initial value and adjusting the reactor temperature to 50° C.;
(viii) maintaining the conditions of (vii) for a prolonged period, optionally for ~1.5 hours; and
(ix) continuously sparging nitrogen throughout the entire polymerization process; and
(f) a “post-polymerization phase” wherein the polymer mixture is optionally treated to eliminate residual monomers and an inverting surfactant is added to the product of the polymerization phase; optionally wherein the “post-polymerization phase” comprises any or all of the following steps:
(i) optionally treating the polymerizate in order to eliminate any residual acrylamide monomers;
(ii) stopping the flow of the SO₂ and nitrogen gases;
(iii) adding an inverting surfactant to the subsurface, optionally a seven-mole ethoxylate of linear, primary 12-14 carbon number alcohol;
(iv) permitting the reactor to cool to <30° C., and
(v) transferring the resultant emulsion polymer to an appropriate container.

7. A water-soluble amphoteric emulsion terpolymer according to any of claims 1-4, produced by a method according to claim 5 or 6.

8. An aqueous composition, optionally a hard water aqueous composition, comprising
(a) a water-soluble amphoteric emulsion terpolymer according to any of claims 1-4, produced by a method according to claim 5 or 6; and
(b) water or hard water; which optionally comprises a pH of 2.5-3.5 or 2.8-3.5 or 2.8-3.2, and/or comprises an acidic buffer, further optionally a citric acid buffer or a sodium acetate-acetic acid buffer.

9. A method of papermaking, which method comprises adding a water-soluble emulsion terpolymer or aqueous composition comprising the water-soluble amphoteric emulsion terpolymer according to any of the previous claims during any phase of a manufacturing process for paper or board, wherein the water-soluble emulsion terpolymer or aqueous composition functions as:
(a) a dry strength agent for paper or board;
(b) an anti-stickie agent;
(c) a fixation and retention/drainage boosting aid, wherein said water-soluble emulsion terpolymer or aqueous composition functions as a fixative for improving retention and/or fixation of dyes, hydrophobics, starch and/or fillers, and/or drainage in manufacture of paper and/or board, optionally wherein said aid does not damage sheet formations even at elevated polymer dosage levels; or
(d) any combination of the foregoing.

10. The method of claim 9, wherein the method further comprises:
(a) adding the water-soluble emulsion terpolymer or aqueous composition to a fiber stock, wherein the fiber stock is used for manufacture of paper or board;
(b) draining the aqueous fiber stock on a wire to form a wet fibrous web; and
(c) further dewatering the wet fibrous web by using vacuum dewatering, wet pressing, and/or drying;
optionally wherein:
(i) the method uses hard water, and/or uses recycled fibers; and/or
(ii) the fiber stock comprises (1) a thin stock comprising recycled fibers; or (2) preferably a thick stock comprising recycled fibers; and/or
(iii) the water-soluble emulsion polymer or composition comprising is prepared on-site; and/or
(iv) the water-soluble emulsion terpolymer is added in an amount ranging from (1) 100-2000 g/ton of produced paper or board, or 300-1500 g/ton of produced paper or board, or 400-900 g/ton of produced paper or board; or (2) 500-5000 g/ton produced paper or board, preferably in the range of 1000-3000 g/ton produced paper or board, more preferably in the range of 1500-2500 g/ton produced paper or board.

11. A method of using a water-soluble amphoteric emulsion terpolymer or aqueous composition comprising the water-soluble amphoteric emulsion terpolymer according to any of the previous claims, wherein the water-soluble amphoteric emulsion terpolymer or aqueous composition functions:
(a) as an internal sizing booster and press aid in papermaking for paper or board;
(b) as a press aid in a papermaking process;
(c) for colloidal particle control, optionally in a papermaking process;
(d) as a drainage aid; optionally in a papermaking process;
(e) for eliminating or controlling deposit formation caused e.g., by hydrophobic substances in manufacture of paper or board;
(f) for improving drainage in manufacture of paper and/or board;
(g) as a pump and go composition for paper or board manufacturing, wherein the pump and go composition is added to a fiber stock, a thick stock, or a coated broke without use of conventional polymer aging tanks;
(h) for improving sizing efficiency in paper or board manufacturing; or
(i) as a flocculant, optionally in water purification or water quality management.

12. A method for manufacture of paper or board, wherein a fiber web is formed from an aqueous suspension of fibers, the method comprising:
(a) providing an aqueous fiber suspension, which comprises recycled fiber material and/or coated broke;
(b) optionally diluting the aqueous fiber suspension;
(c) delivering the aqueous fiber suspension to a headbox, draining the aqueous fiber suspension on a wire screen to form a wet fibrous web; and
(d) pressing and drying the wet fibrous web to obtain a web of paper or board,
wherein the method further comprises adding a water-soluble amphoteric emulsion terpolymer or an aqueous composition comprising the water-soluble amphoteric emulsion terpolymer according to any of the previous claims; and
wherein optionally:
(i) the aqueous fiber suspension comprises at least 50 weight-%, preferably at least 60 weight-%, more preferably at least 70 weight-%, or even more preferably at least 80 weight-% or 100 weight-%, of recycled fiber material and/or coated broke, based on dry paper or board;
(ii) the water-soluble amphoteric emulsion terpolymer or aqueous composition is added to the aqueous fiber suspension, wherein the aqueous fiber suspension comprises a consistency of (1) above 30 g/L, (2) above 20 g/L, or (3) below 20 g/L;
(iii) the water-soluble amphoteric emulsion terpolymer or aqueous composition is added to the aqueous fiber suspension before washing and/or cleaning and/or thickening of the aqueous fiber suspension;
(iv) the water-soluble emulsion polymer or aqueous composition is added to the aqueous fiber suspension in a dosage of 0.9-2.72 kg (as is)/ton or 1.36-2.72 kg (as is)/ton of produced paper or board; or
(v) any combination of (i) to (iv).

13. A method for improving vacuum and press dewatering in manufacturing of paper or board, which method comprises:
(a) providing an aqueous fiber suspension, which optionally comprises recycled fiber material;
(b) delivering the aqueous fiber suspension to a last shear stage and further to a headbox;
(c) draining the aqueous fiber suspension on a wire to form a wet fibrous web; and
(d) further dewatering the wet fibrous web by using vacuum and wet pressing and drying,
characterised in that an amphoteric polymer or a cationic crosslinked polymer is added to the fiber suspension having consistency of <20 g/L before the last shear stage prior to delivering the fiber suspension to a headbox of a paper or board machine,
wherein the amphoteric polymer or cationic crosslinked polymer are obtained by polymerizing at least acrylamide and over 11 mol-% of cationic monomers, and
wherein the amphoteric polymer or cationic crosslinked polymer comprise a standard viscosity of 1.5-4.5 mPas.

14. The method according to claim 13, characterized in that
(a) the amphoteric polymer comprises:
(i) a ratio of anionically charged groups to cationically charged groups ranging from 1:20 to 1:5 (anionic:cationic);
(ii) an anionic monomer content ranging from 0.5-5 mol-%, preferably 1-4 mol-%, more preferably 1.2-3 mol-%; and/or
(iii) a cationic monomer content ranging from 11-38 mol % or 13-30 mol %; and/or
(iv) a net cationic charge ranging from 1.1-3.5 meq/g, preferably 1.5-3 meq/g at pH 7; and/or
(b) the cationic crosslinked polymer:
(i) is polymerized in a presence of 0.5-100 ppm, preferably 1.5-30 ppm, more preferably 2-20 ppm, of crosslinking agent;
(ii) comprises a cationic monomer content ranging from over 20 mol-%, over 25 mol-%, 20-50 mol-%, or preferably 25-38 mol %;
(iii) comprises a net cationic charge ranging from 2.5-5 meq/g, or preferably 3.1-4.5 meq/g, at pH 2.7;
(iv) comprises a standard viscosity preferably in a range of 1.7-4.0 mPas, more preferably 2.5-3.5 mPas;
wherein the cationic monomer is selected from the group consisting of 2-(dimethylamino)ethyl acrylate (ADAM), [2-(acryloyloxy)ethyl]trimethylammonium chloride (ADAM-CI), 2-(dimethylamino)ethylacrylate benzylchloride, 2-(dimethylamino)ethyl acrylate dimethylsulphate, 2-dimethylaminoethyl methacrylate (MADAM), [2-(methacryloyloxy)ethyl]trimethylammonium chloride (MADAM-CI), 2-dimethylaminoethyl methacrylate dimethylsulphate, [3-(acryloylamino) propyl]trimethylammonium chloride (APTAC), [3-(methacryloylamino) propyl]trimethylammonium chloride (MAPTAC), diallyldimethylammonium chloride (DADMAC) and any mixture thereof; preferably cationic monomer being [2-(acryloyloxy)ethyl]trimethylammonium chloride (ADAM-CI),
and wherein the anionic monomer is selected from the group consisting of acrylic acid, methacrylic acid, and alkali metal, alkaline earth metal, or ammonium salts thereof.

15. The method according to claim 13 or 14, characterised in that:
(a) the cationic crosslinked polymer or the amphoteric polymer is added to the fibre suspension:
(i) in an amount of 50-1000 g/t, preferably 150-800 g/t; and/or
(ii) in an amount providing a reduction in a cationic demand of the fibre suspension of 10-300 meq/g, measured with Mutek PCD, calculated from the cationic demand of the fibre suspension before and after the addition of the cationic crosslinked polymer or the amphoteric polymer and/or
(b) the method further comprises an addition of inorganic microparticles after the last shear stage prior to delivering the fibre suspension to the headbox of a paper or board machine;
(c) the method further comprises an addition of cationic polyacrylamide; or
(d) any combination of the foregoing.

16. Use of a method according to any one of claims 13 to 15 in manufacturing of
(a) solid board, kraft paper, liner board, test liner, fluting, sack paper, white lined chipboard, core board, folding boxboard or gypsum board liner; or
(b) solid board, kraft paper, liner board, test liner, fluting, sack paper, white lined chipboard, core board, folding boxboard or gypsum board liner having a grammage of at least 70 g/m², preferably at least 100 g/m² or at least 150 g/m².

17. A method for manufacture of paper or board, wherein a fiber web is formed from an aqueous suspension of fibers, the method comprising:
(a) providing an aqueous fiber suspension, which comprises recycled fiber material and/or coated broke;
(b) optionally diluting the aqueous fiber suspension;
(c) delivering the aqueous fiber suspension to a headbox, draining the aqueous fiber suspension on a wire screen to form a wet fibrous web; and
(d) further dewatering the wet fibrous web by vacuum dewatering, wet pressing, and/or drying the wet fibrous web to obtain a paper or board;
wherein the method further comprises adding to the aqueous fiber suspension a retention and drainage aid comprising (i) a water-soluble amphoteric emulsion terpolymer, and (ii) one or more inorganic colloids; and
wherein (i) and (ii) are premixed prior to addition or added simultaneously or sequentially in any order.

18. The method of claim 17, wherein:
(a) the aqueous fiber suspension comprises:
(i) at least 50 weight-%, preferably at least 60 weight-%, more preferably at least 70 weight-%, or even more preferably at least 80 weight-% or 100 weight-%, of recycled fiber material and/or coated broke, based on dry paper or board;
(ii) water and/or hard water comprising calcium ions; or
(iii) a thick stock comprising recycled fibers or a thin stock comprising recycled fibers;
(iv) a consistency of above 30 g/L or below 20 g/L;
(v) a pH in the range of 6-10, 6-9, 6-8.5, or 6-7; or
(vi) any combination of (i)-(v);
(b) the water-soluble amphoteric emulsion terpolymer:
(i) comprises one or more acrylamide (AM) monomers, one or more anionic monomers comprising acrylic acid (AA), and one or more cationic monomers comprising 2-(acryloyloxy)ethyl]trimethylammonium chloride (Q9);
(ii) comprises an acrylamide (AM) or monomer content ranging from 85.9-99 mol-%, 86-96 mol-%, or 86-92 mol-%;
(iii) comprises an acrylic acid (AA) monomer content of ≤2.1 mol-%, 0.1-2.1 mol-%, or 0.5-2.1 mol-%;
(iv) comprises a Q9 monomer content ranging from ≤12 mol-%, 7-12 mol-%, 8-12 mol-%, or 10-12 mol-%;
(v) comprises a polymer standard viscosity (SV) of ≤4.5 cPs, ≤3.5 cPs, or preferably 2.5-3.5 cPs; and
(vi) comprises a molecular weight ranging from 1.5-9 million Da, 5-8 million Da, or 3 to 5 million Da; and/or
(vii) optionally further comprises a buffer which maintains a pH in the range of 6-9, 6-8.5, or 6-7 after addition to the aqueous fiber suspension;
(viii) is obtained by a method according to claim 5 or 6;
(ix) is obtained by polymerization of acrylamide (AM), acrylic acid (AA), and acryloyloxy ethyl trimethylammonium chloride (Q9) monomers;
(x) is obtained by polymerization in a presence of 0.5-100 ppm, preferably 1.5-30 ppm, more preferably 2-20 ppm, of a crosslinking agent;
(xi) is formulated as a dry polymer, a liquid polymer, or an inverse emulsion polymer; or
(xii) any combination of (i)-(xi);
(c) the one or more inorganic colloids comprise colloidal silica; siliceous nano and/or microparticles; aluminum phyllosilicate mineral particles, including but not limited to bentonite, sodium bentonite, calcium bentonite, and montmorillonite; or combination of the following;
(d) the water-soluble amphoteric emulsion terpolymer is added to the aqueous fiber suspension at a dosage ranging from 0.1-1 kg/MT, 0.15-0.3 g/MT, or 0.4-0.8 kg/MT, wherein MT is metric ton of total fiber solids;
(e) the one or more inorganic colloids is added to the aqueous fiber suspension at a dosage ranging from 0.1-1 kg/MT, 0.15-0.3 g/MT, or 0.4-0.8 kg/MT, wherein MT is metric ton of total fiber solids;
(f) wherein the retention and drainage aid is added to the aqueous fiber suspension prior to or after dilution of the aqueous fiber suspension;
(g) adding the retention and drainage aid to the aqueous fiber suspension provides:
(i) a synergistic improvement in drainage and dewatering of the fibrous web during gravity dewatering, vacuum drainage, and press dewatering;
(ii) a synergistic improvement in water removal efficiency;
(iii) a synergistic improvement in fixation and on-machine retention of starch, fines, fillers, and colloidal particles from the aqueous fiber suspension;
(iv) a synergistic improvement in retention and drainage under alkaline conditions, wherein said water-soluble emulsion terpolymer and inorganic colloid functions as a fixative for improving retention and/or fixation of dyes, hydrophobics, starch and/or fillers, and/or drainage in manufacture of paper and/or board, optionally wherein said aid does not damage sheet formations; or
(v) any combination of (i)-(iv); or
(h) any combination of (a)-(g).

19. An aqueous composition comprising:
(a) an aqueous fiber suspension according to claim 17 or 18; and
(b) a retention and drainage aid comprising (i) a water-soluble amphoteric emulsion terpolymer, and (ii) one or more inorganic colloids according to claim 17 or 18.

20. A paper or board obtained by a method according to any of the preceding claims.
